(19) United States
(12) Patent Application Publication
(10) Pub. No.: US 2005/0115248 A1
(43) Pub. Date: Jun. 2, 2005

(54) Liquefied natural gas structure

(76) Inventors: Gregory John Koehler, Houston, TX (US); Denby Grey Morrison, Houston, TX (US); Keith Bell Walters, The Hague (NL); Harke Jan Meek, Houston, TX (US); Paul Johannes Gerardus Wilhelmus Van Weert, Rotterdam (NL); Steven James Bowring, Houston, TX (US); Robert Forrest Figgers, Houston, TX (US); Kelly George Bowen, Spring, TX (US); WanJun Kim, Houston, TX (US); David Alexander Thomson, Houston, TX (US)

Correspondence Address: Reece A. Scott;Shell Oil Company, Legal - Intellectual Property, P. O. Box 2463, Houston, TX, 77252-2463, US

(21) Appl. No.: 10/975,885

(22) Filed: Oct. 28, 2004

Related U.S. Application Data
(60) Provisional application No. 60/515,541, filed on Oct. 29, 2003.

(51) Int. Cl. F17C 9/02; F17C 1/00; B65B 1/20; B65B 1/28; B65B 3/18; B65B 3/22

(52) U.S. Cl. 62/53.1; 62/50.2; 141/82

(57) ABSTRACT

An offshore liquefied natural gas structure may receive, store, and process liquefied natural gas from carriers. A structure may be a gravity base structure. A structure may include a system of ballast storage areas, transfer equipment to offload liquefied natural gas from a carrier, docking equipment to allow direct mooring with carriers, platforms to elevate equipment, water intake systems to provide water to the structure, wave deflectors, and/or projections extending from a bottom of the structure. A portion of the structure may be composed of lightweight concrete. Pipelines may be coupled to the structure to export processed natural gas onshore. Living quarters, flare towers, and export line metering equipment may be included on the structure.

### CROSS-REFERENCE TO RELATED APPLICATIONS

This application claims the benefit of U.S. Provisional Application No. 60/515,541, filed Oct. 29, 2003 which is incorporated herein by reference.

### BACKGROUND OF THE INVENTION

1. Field of Invention

The invention generally relates to structures configured to store liquefied natural gas and distribute natural gas. More specifically the invention relates to liquefied natural gas processing.

2. Description of Related Art

Natural gas is becoming a fuel of choice for power generation in the U.S. and other countries. Natural gas is an efficient fuel source that produces lower pollutant emissions than many other fuel sources. Additionally, gains in efficiency of power generation using natural gas and the relatively low initial investment costs of building natural gas based power generation facilities, make natural gas an attractive alternative to other fuels.

Distribution and storage of an adequate supply of natural gas are important to the establishment of power generation facilities. Because of the high volumes involved in storing of natural gas, other methods of storing and supplying natural gas have been used. The most common method of storing natural gas is in its liquid state. Liquefied natural gas (“LNG”) is produced when natural gas is cooled to a cold, colorless liquid at −160° C. (−256° F.). Storage of LNG requires much less volume for the same amount of natural gas. A number of storage tanks have been developed to store LNG. In order to use LNG as a power source, the LNG is converted to its gaseous state using a re-vaporization process. The re-vaporized LNG can then be distributed through pipelines to various end users.

One advantage of LNG is that LNG may be transported by ship to markets further than would be practical with pipelines. This technology allows customers who live or operate a long way from gas reserves to enjoy the benefits of natural gas. Importing LNG by ships has led to the establishment of LNG storage and re-vaporization facilities at on-shore locations that are close to shipping lanes. The inherent dangers of handling LNG make such on-shore facilities less desirable to inhabitants who live near the facilities. There is therefore a need to explore other locations for the storage and processing of LNG.

### SUMMARY OF THE INVENTION

In an embodiment, LNG receiving, storage, and processing facilities are positioned in an offshore location. The LNG storage and processing facility, in one embodiment, is a gravity base structure. A gravity base structure is a structure that at least partially rests upon the bottom of a body of water and partially extends out of the body of water. The gravity base structure includes equipment for receiving, storing, and processing LNG.

In one embodiment, an LNG structure includes a body disposed in a body of water. The body at least partially rests upon a bottom of the body of water, while an upper surface of the body extends above the surface of the water. One or more LNG storage tanks are contained within the body. Equipment for transfer and processing of LNG is disposed on the upper surface of the body.

In one embodiment, docking equipment may be disposed on an upper surface of the body. The docking equipment may be configured to couple an LNG carrier to the body. By placing the docking equipment directly on the body, instead of using, for example, separate mooring platforms, the LNG carrier may be coupled closer to the body. Coupling an LNG carrier close to the body may facilitate transfer of LNG from the LNG carrier to the LNG storage tanks. Additionally, the body may also provide some protection from waves while the LNG carrier is docked alongside the body.

Mooring of an LNG carrier with the LNG structure may be accomplished using mooring lines. In an embodiment, docking equipment may be placed at a different elevation than the other LNG processing equipment. The docking equipment may be placed at an elevation to minimize the angles on mooring lines between the docking equipment and a docked LNG carrier. The control of mooring line angles has traditionally been accomplished by the use of separate mooring structures having the appropriate height. By placing and/or modifying the body to have different elevations for the docking equipment and the other LNG processing equipment, the structure may accommodate LNG carriers directly alongside the structure, in some embodiments, without the use of separate mooring structures. Additionally, fenders may be placed at various positions about the body to protect the body from collisions with LNG carriers. In one embodiment, fenders may be placed along a docking side of the structure and at corners of the structure.

The body of the LNG structure at least partially rests on the bottom of a body of water. In one embodiment, projections extend from the bottom of the LNG structure body. The projections may contact the bottom of the body of water, and, in some embodiments, may become at least partially embedded in the bottom of the body of water. The projections may be configured to substantially inhibit movement of the structure due to waves and weather conditions. In addition to projections, a system of ballast storage areas, also referred to as ballast cells, may be disposed throughout the body. In some embodiments, liquid ballast (e.g., water), solid ballast (e.g., sand), or a combination of liquid and solid ballast may be used to fill the ballast storage areas. Ballast may be used to maintain the structure on the bottom of the body of water.

Vaporization equipment may be disposed on the body. Vaporization equipment is used to vaporize LNG to natural gas. In one embodiment, vaporization equipment includes a heat exchange vaporization system. A heat exchange vaporization system may, in some embodiments, use water from the body of water to convert LNG to natural gas. Water from the body of water may be obtained using a variety of water intake systems. The water intake systems may be configured to reduce the amount of sea life and debris that enters the heat exchange vaporization system.

In one embodiment, a water intake system may include a water inlet conduit to deliver water to a water-receiving chamber. The water-receiving end of the conduit may be positioned at a distance from the structure. In one embodiment, the water receiving end of the conduit is positioned at a distance from the structure such that standing waves proximate the structure do not substantially effect the flow of water into the water receiving end. Water entering the water inlet conduit may be transferred to a water-receiving chamber. Filters may be positioned at the water-receiving end of the water inlet. The filters may be configured to inhibit sea life and debris from entering the water inlet conduit.

In some embodiments, a water intake system may be at least partially positioned in the body of the structure. The water intake system may include filters. The filters may be configured to at least partially inhibit sea life and debris from entering the water inlet of the water intake system. Additionally, baffles may be positioned in the water inlet. The baffles may be configured to substantially minimize the effect of standing waves. Standing waves may be created by the impact of waves against the side of the structure.

In certain embodiments, more than one water-receiving chamber may be used to collect water for the water pumps. In one embodiment, a first chamber may collect water from the body of water through a water inlet. A filter may be disposed along a wall of the first chamber. The filter may separate the first chamber from a second chamber. The second chamber may include one or more baffles configured to reduce the effects of standing waves on the intake of water. Water pumps may provide water from the second chamber to one or more heat exchangers.

The various components of LNG transfer, storage, and processing may be disposed on an upper surface of the body. In one embodiment, one or more platforms may be constructed on the upper surface of the body. Various LNG storage, transfer, and processing equipment may be disposed on top of platforms, rather than directly on the upper surface of the LNG structure. In some embodiments, one or more platforms may be at a height of at least about 5 meters above the upper surface of the body. In this manner, the equipment may be protected from water running over the structure during extreme weather conditions. Additionally, wave deflectors may be positioned on at least a portion of the edge of the LNG structure body. Wave deflectors may extend outward from the sidewalls of the structure. In this manner, waves that impact the side of the structure may be inhibited from flowing over an upper surface of the body.

In one embodiment, living quarters, flare towers, and export line metering equipment may be disposed on the body of the structure. By placing these areas directly on the body, the use of auxiliary platforms to hold these structures may be avoided, therefore reducing construction costs.

Typical LNG carriers have a net LNG capacity ranging from 125,000 cubic meters to about 165,000 cubic meters. Additionally, it is expected that LNG carriers of up to about 200,000 cubic meters in net storage capacity may be available in the future. To be able to accommodate a wide variety of LNG carriers, the LNG capacity of the LNG structure may be optimized based on a number of factors. Some of the factors for determining the optimal storage capacity include the LNG capacity of one or more predetermined LNG carriers, the desired peak capacity of the structure for converting LNG to natural gas, the rate at which LNG from an LNG carrier is transferred to one or more LNG storage tanks, and the cost associated with operating the structure. Based on the known size of currently used LNG carriers and an expected peak natural gas production rate of at least 1 billion cubic feet per day (1,960 m³/h LNG), it is estimated that an optimal net storage capacity of the LNG structure may be about 180,000 cubic meters.

LNG structures may be constructed on-shore. After an LNG structure has been constructed, the structure may be towed to an appropriate site and positioned on the bottom of a body of water. The process of building on-shore involves excavating a hole for construction of the LNG structure. After the structure is completed, the structure may be towed to an offshore site. To ensure that the structure may be towed through relatively shallow harbors and channels, a number of features may be incorporated into the LNG structure to reduce the weight of the structure. In certain embodiments, at least a portion of the structure may be composed of a structural-grade lightweight concrete. In an embodiment, a series of projections may be built extending from the bottom of the structure. The projections may be arranged such that one or more compartments are formed on the bottom of the body. During floatation of the structure, at least a portion of the compartments may temporarily trap air between the body and the water. Trapping air underneath the structure may improve the buoyancy of the structure. A combination of structural-grade lightweight concrete and air compartments may also be used to improve the buoyancy of the structure.

In one embodiment, multiple pipelines may be coupled to the LNG structure. Each of the pipelines may connect the LNG structure to different natural gas pipeline systems. Because of the expected high output of natural gas, multiple pipelines may be used to export the produced natural gas on-shore. In addition, pipeline and plant problems may cause a slow down of the exportation of natural gas. The bottlenecks and outages may exist for as little as a few hours. Natural gas may be diverted from one pipeline with bottlenecking or an outage to another pipeline that may accommodate additional flow.

Economic dispatching may drive the gas flow to utilize one pipeline to a greater extent than the next pipeline and so forth until all of the gas is sold for the day. In general, the gas market is not static. Prices move up or down continuously. On a daily basis, the use of multiple pipelines may allow the structure to send additional gas (if capacity is available) to a new market, if prices run up, and conversely pull gas out of a market if the price is falling and a better market is available on another pipeline.

### BRIEF DESCRIPTION OF THE DRAWINGS

Advantages of the present invention will become apparent to those skilled in the art with the benefit of the following detailed description of embodiments and upon reference to the accompanying drawings, in which:

FIG. 1 depicts a top view of an embodiment of the structure;

FIG. 2 depicts a cross-sectional view of a storage tank and ballast storage areas in a structure;

FIG. 3 depicts an embodiment of a gabion mattress as scour protection;

FIG. 4A depicts a top view of embodiments of the structure and water inlets and outlets;

FIG. 4B depicts a side view of an embodiment of a water outlet;

FIG. 4C depicts a side view of an embodiment of a water inlet;

FIG. 4D depicts a side view of an embodiment of a water inlet;

FIG. 5 depicts a top view of an embodiment of an arrangement of water inlets;

FIG. 6 depicts a cross-sectional view of a water inlet positioned on a structure;

FIG. 7 depicts a cross-sectional view of an embodiment of screens in a water inlet;

FIG. 8 depicts an embodiment of a system to clean screens;

FIG. 9 depicts a cross-sectional view of water inlets positioned on platforms;

FIG. 10 depicts a representation of an embodiment of the vaporization process;

FIG. 11 depicts a cross-sectional view of an embodiment of a structure;

FIG. 12 depicts a top view of an embodiment of a structure being towed from dry dock;

FIG. 13 depicts a cross-sectional view of an embodiment of an air cushion below a structure;

FIG. 14 depicts a top view of an embodiment of a structure being towed;

FIG. 15 depicts a cross-sectional view of an embodiment of a deflated air cushion below a structure;

FIG. 16 depicts a cross-sectional view of an embodiment of liquid ballasting;

FIG. 17 depicts an embodiment of docking equipment;

FIG. 18 depicts a top view of an embodiment of the structure;

FIG. 19 depicts a top view of an embodiment of an arrangement of water inlets; and

FIG. 20 depicts a cross-sectional view of a water inlet positioned on a structure.

While the invention is susceptible to various modifications and alternative forms, specific embodiments thereof are shown by way of example in the drawings and will herein be described in detail. It should be understood that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE INVENTION

An offshore liquefied natural gas (“LNG”) receiving and storage structure may allow LNG carriers to berth directly alongside the structure and unload LNG. The LNG structure may include one or more tanks capable of storing LNG. The LNG structure may transfer LNG from the tanks to an LNG vaporization plant disposed on the structure. The vaporized LNG may then be distributed among commercially available pipelines.

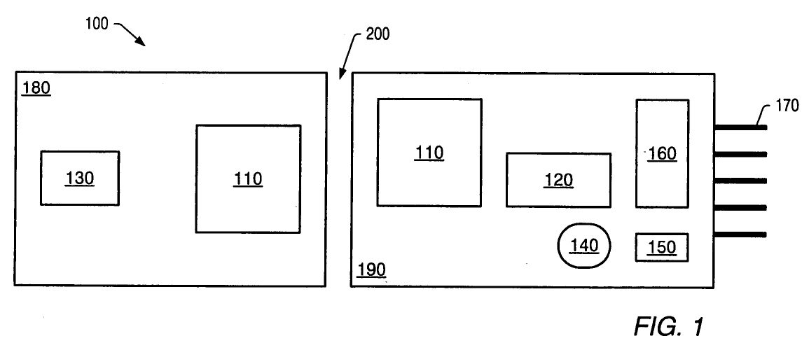

FIG. 1 depicts an embodiment of an LNG structure. An LNG structure 100 may have a layout that includes LNG tanks 110 on the structure with vaporization process equipment 120 and utilities, docking equipment, living quarters 130, flares 140, vents 150, metering equipment 160, and pipelines 170 for exporting natural gas. The living quarters 130, vaporization plant 120, and/or other process equipment may be positioned on an upper surface of the structure 100, such as on an upper surface of unit 180 and/or unit 190. The layout may be designed according to Fire/Explosion Risk assessment guidelines. In an embodiment, the layout of the structure may be designed to maximize safety of the living quarters.

In some embodiments, living quarters may be positioned on the structure. The living quarters may be positioned proximate an opposite end from the flare and/or vent. The living quarters may not be positioned proximate the heat exchangers and/or recondensers. In certain embodiments, living quarters on the structure may be positioned to be proximate living quarters on an LNG carrier during unloading. Aligning living quarters on the structure with living quarters on the carrier may maximize safety. The living quarters may be substantially resistant to fire, blast, smoke, etc. The living quarters may be reinforced to substantially withstand explosion overpressure. In an embodiment, the living quarters may be designed to inhibit the ingress of gas and smoke.

In an embodiment, the living quarters may be positioned on a separate platform in the body of water. The platform may be coupled to the structure by a connecting bridge. Overall there may be little or no difference between the risks to living quarters on the structure and living quarters on a separate platform. In an embodiment, living quarters on the structure are at least partially protected from waves by the structure.

The body of the LNG structure may include one or more units. In some embodiments, the units may be, for example, but not limited to, steel-reinforced concrete units, steel jackets, and the like and combinations thereof. The one or more units may be square, rectangular, partially spherical, and the like and combinations thereof. The structure may include only one unit. In an embodiment, the structure may include two units. The one or more units may be coupled together. The units may be substantially similarly sized. More than one unit may be used because of ease of construction, soil conditions, restricted space available in existing graving docks, and/or difficulties with tow out and installation. The units may be built onshore, towed to the site, and set down at a desired location using well-proven construction methods and technology as known to one skilled in the art. In an embodiment, the units may be separately towed to an offshore site. The units may be towed together to a site.

In certain embodiments, the LNG structure may be composed of two or more units, each unit including one or more LNG storage tanks. The units may be placed end to end to form the structure. A bridge structure may couple units together. LNG storage tanks 110 in each unit 180, 190 may be coupled together. See FIG. 1. The two or more units may be coupled together. A gap 200 between units 180, 190 may be closed off to prevent erosion of the seabed between the units. Each unit 180, 190 may contain different equipment, living quarters 130, and/or liquefied natural gas tanks 110. In certain embodiments, living quarters 130 may be on one unit 180 and a vaporization plant 120 and other process equipment may be on a different unit 190. The docking equipment may be distributed on one or more units, such as on unit 180 and/or unit 190.

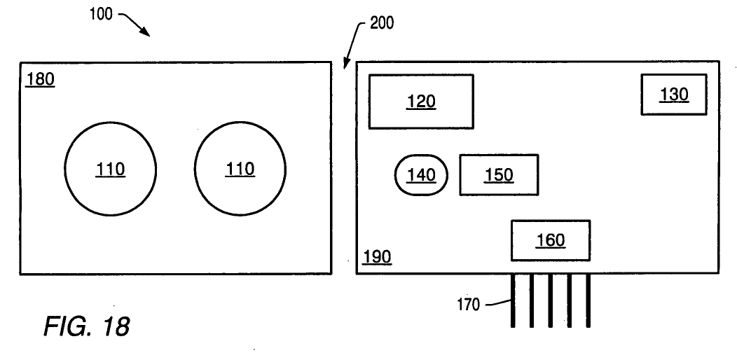

FIG. 18 depicts another embodiment of an LNG structure of the present invention. An LNG structure 100 may have a layout that includes LNG tanks 110 on a unit 180 of the structure. While the tanks in FIG. 18 are depicted as cylindrical tanks, the tanks may be, for example, but not limited to, cylindrical, square, rectangular, partially spherical, irregularly shaped, and the like and combinations thereof. The vaporization process equipment 120 and utilities, docking equipment, living quarters 130, flares 140, vents 150, metering equipment 160 and pipelines 170 for exporting natural gas are on a unit 190 of the structure. The living quarters 130, vaporization plant 120, and/or other process equipment may be positioned on an upper surface of the structure 100, such as on an upper surface of unit 190. The units may be, for example, but not limited to, concrete units, also referred to as concrete caissons, steel jackets, and the like and combinations thereof. The units may be, for example, but not limited to, square, rectangular, partially spherical, and the like and combinations thereof. The units may be coupled together. The docking equipment may be distributed on one or more units, such as on unit 180 and/or unit 190. The units may be placed end to end to form the structure. A bridge structure may couple units together. LNG storage tanks 110 in unit 180 may be coupled together. See FIG. 18. The units may be coupled together. A gap 200 between units 180 and 190 may be closed off to prevent erosion of the seabed between the units.

In some embodiments, the LNG structure may be composed of more than one unit, such as two units, comprising concrete units, steel jackets, and the like and combinations thereof. The units may be square, rectangular, partially spherical, and the like and combinations thereof. In some embodiments, one of the units may be square or rectangular and comprise one or more tanks that can be, for example, but not limited to, cylindrical, rectangular, partially spherical, irregularly shaped, and the like and combinations thereof. For example, in some embodiments comprising two units, one of the two units may be a concrete square or rectangle comprising two cylindrical tanks. The other unit may be a concrete square or rectangle and comprise the vaporization process equipment and utilities, living quarters, flares, vents, metering equipment, and pipelines. Docking equipment may be on one or more of the units. The units may be coupled together.

In some embodiments, an LNG structure of the present invention may be composed of more than one unit, such as three units, where the units may be, for example, but not limited to, concrete units, also referred to as concrete caissons, steel jackets, and the like and combinations thereof. The units may be, for example, but not limited to, square, rectangular, partially spherical, and the like and combinations thereof. The units may be coupled together. In some embodiments, the LNG structure may be comprised of three units where all three units are concrete units or caissons with two of the concrete units or caissons comprising one or more LNG tanks, and the third concrete unit or caisson comprising the vaporization process equipment and utilities, living quarters, flares, vents, metering equipment and pipelines. Docking equipment may be on one or more of the units. Such an embodiment may allow for the two units comprising the one or more LNG tanks to be reduced in length and the unit comprising the utilities may be smaller as well compared to a structure comprising two units. In some embodiments, non-cryogenic LNG components may be placed on the third unit. The concrete units may be, for example, but not limited to, square, rectangular, partially spherical, and the like and combinations thereof. The units may be coupled together.

In some embodiments, an LNG structure of the present invention may be composed of more than one unit, such as two units, where one unit comprises a concrete unit or caisson and the other unit comprises a steel jacket. The concrete unit may be, for example, but not limited to, square, rectangular, partially spherical, and the like and combinations thereof, and comprise one or more tanks that can be, for example, but not limited to, cylindrical, rectangular, partially spherical, irregularly shaped, and the like and combinations thereof. The steel jacket unit may be, for example, but not limited to, square, rectangular, partially spherical, and the like and combinations thereof. For example, one of the two units can be a concrete square or rectangle comprising two round tanks. The other unit may be a steel jacket unit and comprise the vaporization process equipment and utilities, living quarters, flares, vents, metering equipment and pipelines. Docking equipment may be on one or more of the units. The units may be coupled together. In some embodiments, one or more steel jackets may be utilized to provide additional units that provide, for example, but not limited to, a separate unit for vaporization process equipment and utilities, flares and vents, a separate unit for metering equipment and pipelines, and a separate unit for living quarters. Docking equipment may be on one or more of the units. The units may be coupled together.

The phrase “steel jacket” or “steel jacket unit” referred to herein means any steel jacket that can be utilized according to an embodiment of an LNG structure disclosed herein. Steel jacket refers to any steel template, space-frame support apparatus, platform and/or structure utilized to support various processing equipment typically utilized for off-shore production of hydrocarbons, LNG, and the like and combinations thereof. Examples of companies that may be able to provide steel jackets suitable for use in an embodiment of an LNG structure disclosed herein include, but are not limited to, J. Ray McDermott, Inc. (New Orleans, La. or Morgan City, La.) and Kiewit Offshore Constructors, Ingleside (Corpus Christi, Tex.).

Each unit may include one or more LNG storage tanks. Insulation in the tanks may be designed to limit LNG boil-off to approximately 0.1% of the contained LNG volume per day. The capacity of a tank may be up to approximately 566,000 bbl (90,000 m³) of LNG. In some embodiments, the structure may include less than about 250,000 cubic meters of net LNG storage. In certain embodiments, the structure may include greater than about 50,000 cubic meters of net LNG storage. In certain embodiments, the structure may include greater than about 100,000 cubic meters of net LNG storage. The LNG capacity of a structure may be optimized based on a number of factors including LNG capacity of one or more LNG carriers, desired peak regasification capacity of the structure for converting LNG to natural gas, the rate at which LNG from an LNG carrier is transferred from a carrier to one or more LNG storage tanks, and/or costs associated with operating the structure. Currently, carriers have a capacity of about 125,000 cubic meters to about 200,000 cubic meters. Peak natural gas production may be at least about 1 billion cubic feet per day (1,960 m³/h LNG). In certain embodiments, an optimal storage capacity of the structure may be about 180,000 cubic meters.

In some embodiments, the LNG structure has a storage capacity of less than about 200,000 cubic meters of LNG. In some embodiments, the structure is configured to produce natural gas at a peak capacity of greater than about 1.2 billion cubic feet per day (2,400 m³/h LNG). In some embodiments, the LNG structure is configured to offload LNG from carriers having a storage capacity of greater than about 100,000 cubic meters. In some embodiments, the body of the structure has a length that is at least equal to a length required to provide sufficient berthing alongside the body for an LNG carrier having an LNG capacity of greater than about 100,000 cubic meters.

LNG tanks may substantially store vapor and liquefied natural gas. LNG tanks may be double containment systems. LNG storage tanks may include a liquid and gas tight primary tank constructed in a concrete interior of the structure. The primary tank may be formed from, for example, stainless steel, aluminum, and/or 9%-nickel steel. The LNG containment system may be, for example, a SPB (Self-supporting Prismatic shape IMO Type “B”) rectangular tank system, a 9% nickel-steel cylindrical tank system, and/or a membrane tank system. LNG tanks may be freestanding tanks and/or self-supporting tanks. In an embodiment, each unit of the structure contains at least one steel membrane type LNG containment tank. The LNG tank may be cylindrical, rectangular, partially spherical, or irregularly shaped.

In some embodiments, design of tank walls and a slab surrounding the tank may incorporate applicable codes and standards (e.g., Norwegian). Since inspection after installation may be difficult, Serviceability Limit State (SLS) design conditions to check water tightness may be more stringent. Wave actions in the operational condition for the liquid tightness verifications may be set to 1.0 times the 100-year design wave.

In some embodiments, a structure may include one or more concrete LNG storage tanks. High strength concrete structural tanks may have advantages to steel tanks in a marine environment. Concrete structures may be robust. Concrete tanks may include inherent safety features with regards to accidental events such as cold spill, fire (including jet fire), and/or explosions. Concrete may be designed to remain in service for more than 100 years. Concrete may require little maintenance provided that original specification and construction are according to appropriate procedures. Concrete may not be sensitive to fatigue loading such as wave loads. Steel structures may be sensitive to fatigue loading. A concrete tank may be rigid, giving minimum stress to equipment on board and to the storage tank membrane system. The utilization of high strength concrete for LNG storage may be suitable since concrete exhibits desired strength and containment qualities.

Post-tensioning may be arranged in most of the structural reinforced concrete elements in the structure. Post-tensioning density, arrangement, and/or layout may be calibrated and adjusted during the design phase to conform to tightness requirements in applicable concrete structures design codes.

High performance concrete may have excellent properties regarding water tightness. The structure may be designed to substantially inhibit any crossing cracks that might develop in the concrete tank elements. Tank walls may remain substantially under compression. The structure may be substantially robust under wave loading conditions. Water migration through cracks or capillary channels may not be significant. Migration through the whole width of the material may be inhibited in some embodiments.

In some embodiments, the structural layout of the structure may be a repetitive grid of plane walls and slabs. A repetitive grid may simplify and/or improve construction efficiency. Repetitive design may be adapted for tri-dimensional prestressing via post-tensioned cables. Prestressed concrete may perform well in LNG applications. Prestressed concrete may be more water tight than other materials of construction. In certain embodiments, the concrete slab and walls surrounding the LNG storage tank may be designed such that liquid tightness is assured during the operational lifetime of the structure.

In an embodiment, prestressed concrete may provide structural support to the tank. Pressure within a tank may not substantially affect the prestressed concrete. The concrete structure walls and tank slab may be designed to sustain the LNG hydrostatic and operating gas pressure loads. The design of the tank may take into account the full effect of the 100-year design storm condition. Prestressed concrete may be an excellent material for the outer containment tank of cryogenic liquids.

Concrete may have protective functions such as impact resistance and fire resistance. Another advantage of concrete is that it may be designed to last for more than 100 years with little maintenance, when workmanship and the fabrication are done correctly. In some embodiments, a structure may include, for example, grade C65 (compressive cylinder strength at 28 days=54 MPa) concrete; steel for reinforcement: E500 (fy=500 MPa); and/or Freyssinet or VSL prestressing wires.

Entraining air into the concrete mix at the time of placing may enhance concrete durability and permeability. Air entrainment may ease pouring in the formwork. Air entrainment may counteract and/or reduce corrosion. In addition to silica fume, for a typical concrete mix having water/cement ratios lower than 0.35, about 5% to about 7% of air entrainment may be added to the mixer. Air entrainment may cause a lower permeability than the maximum required by the code and a special macroscopic closed void structure (similar to the microscopic capillary structure of conventional concrete). Water migration through the capillary network may be prevented. In certain embodiments, the concrete may be permitted to breath under the thermal load cycles.

The structure may be subject to different load conditions during its life, from the early construction in the dock to the re-float and removal at the time of decommissioning. The longest and the most critical phase during the life of the structure may be the operating phase. In the operating phase, the structural integrity and water tightness are important features for safely operating the structure.

Safety and the reliability of the concrete design may be improved by 3D prestressing in the structural reinforced concrete elements of the structure and/or the storage tanks. Tank walls may be longitudinally and/or transversely prestressed. Prestress density, arrangement, and/or layout may be calibrated and adjusted during the design phase to maintain a minimum residual average membrane compressive stress (e.g., 0.5 MPa or larger). The design of the structure may improve combined axial/bending capacity of the structural elements and/or inhibit through section cracking that might develop in concrete tank elements. Cracking may result in water moisture or water ingress through the thickness of the concrete elements from the surrounding water ballast towards the storage tank.

In an embodiment, migration of water within the concrete may be inhibited from reaching the inside of the tank using vapor barriers. Vapor barriers may be fitted on the internal faces of the tank. Structural elements, including containment walls and slabs, may be designed to meet the ULS (Ultimate Limit State) criteria. Some exposed structural elements may be designed for fatigue and/or for accidental loads, such as boat impacts.

In some embodiments, the tank may be a membrane tank. Membrane tanks may be commercially available from, for example, Technigaz, Mitsubishi Heavy Industries, Inc., and Kawasaki Heavy Industries, Inc. In certain embodiments, tanks may be SPB (Self-supporting Prismatic shape IMO Type “B”) tanks commercially available from Ishikawajima-Harima Heavy Industries Co., Ltd. (IHI) (Japan). The tank may be a commercially available 9% nickel cylindrical tank.

In some embodiments, LNG storage tanks may be double containment tanks. Double containment tanks may be desirable in LNG applications to prevent freezing of water proximate to the tank walls. In certain embodiments, double containment membrane tanks include a primary and a secondary barrier. The secondary barrier may ensure LNG containment in the event of a leak in the primary barrier. The design of a secondary barrier may conform to GRGSC recommendations. The insulation space between the primary and secondary barrier may be continuously monitored. A temperature of the structural concrete of the structure may be monitored.

Water ingress through the concrete tank walls may cause freezing of the entrained water. Frozen water proximate the tanks may damage the containment system. Water ingress may cause damage to the polyurethane foam (PUF) insulation panels. Installation of an extensive heating system (e.g., electric) in the tank walls and slab may decrease the likelihood of freezing water proximate the tank. A temperature of concrete surfaces may be regulated to substantially inhibit icing on the surfaces of the concrete. A heating system may be provided on the walls and bottom to maintain a temperature of at least about 5° C., In some embodiments, a heating system is configured to maintain a temperature of the outer wall at or above about 5° C. Prestressing concrete walls may ensure water tightness of the concrete walls of the tank. A watertight coating on tank walls may inhibit water ingress. In certain embodiments, solid ballasting material may be maintained proximate the tank to avoid water proximate tank walls.

In certain embodiments, factors in determining the internal concrete height of a tank may include, but are not limited to, Net Positive Suction Head (NPSH); design minimum liquid level required for intake pumps; tilt to allow for potential tilting of the structure; bottom safety margin; timely withdrawal of LNG with intake pumps; top safety margin, timely preventing LNG from contacting a ceiling of the tank; design margin; minimum distance between Design Maximum Liquid Level (DMLL) and lower face suspended deck; suspended deck structure, height required for the suspended deck; and roof beams.

In some embodiments of the structure, an applicable design code may not exist for membrane containment systems. The tanks in the structure may be designed to conform to European design codes. In an embodiment, drafts of European codes, such as PrEN 265002, may be used to design the membrane tank. In some embodiments, regulatory authorities may require inspection of the tanks. One or more spare tanks may be installed so that a tank may be offline and the structure may remain operational.

The American liquid natural gas terminal code, the NFPA59a, does not cover the membrane containment tank concept. The American code for refrigerated liquid natural gas storage, the API620—“Design and Construction of Large, Welded, Low-pressure Storage Tanks”, is only applicable for liquid natural gas tanks using free self-standing inner tanks. In absence of relevant US codes for membrane containment, reference is made to the EN 1473 standard—“Installation and equipment for liquefied natural gas—Design of onshore installations” for a general description of the membrane tank concept. Reference is made to the draft European code, PrEN 265002—“Specification for the design, construction and installation of site built, vertical, cylindrical, flat-bottomed steel tanks for the storage of refrigerated, liquefied gases with operating temperatures between −5° C. and −165° C.”, for the design of membrane liquid natural gas tanks. All of these codes are incorporated herein by reference.

In certain embodiments, an LNG storage tank may include pre-tensioned concrete. The concrete tank may provide structural resistance to inner LNG and gas pressure loads and to outer hazards. The tank may include a primary barrier. The primary barrier may be a stainless steel corrugated membrane. The stainless steel membrane may constitute a liquid and vapor tight inner containment. The tank may include a secondary barrier positioned between the primary barrier and the concrete. In an embodiment, PERMAGLASS™ may form the secondary barrier. PERMAGLASS™ may be a polyester/glass cloth composite. The secondary barrier may be incorporated in the insulating panels under the primary barrier. The secondary barrier may be incorporated in the insulation between the concrete structure and the primary barrier. The secondary barrier may retain liquid and vapor in case of a leakage of the primary barrier. The secondary liner may be applied on the entire bottom and wall surfaces of the tank.

The continuity of the secondary liner between two panels may be ensured by aluminum foil between two glass cloth layers (e.g., Triplex). Triplex is a secondary liner material in a MARK III insulation system installed in the tanks of LNG carriers. The primary and secondary barrier may function to inhibit the concrete structure from contacting LNG in the tank. Since the tank functions to isolate the concrete walls from the LNG, concrete parts are supplied with standard carbon steel rebar.

In some embodiments, insulation may be positioned between the primary barrier, such as the membrane, and the concrete wall. Insulation may be formed of polyurethane foam (PUF). Insulation may keep the concrete tank walls at an acceptable temperature. A predetermined acceptable boil off rate may determine the insulation thickness. In certain embodiments, the insulation may be load bearing. The insulation may transmit the inner LNG loads from the membrane containment system to the concrete tank walls by means of an epoxy mastic.

In some embodiments, the LNG storage tanks may not need to be inspected during the operational life of the LNG structure. The containment tanks may not need to be maintained or may require little maintenance during the operational life of the structure.

In an embodiment, the LNG tanks may be in service in all normal conditions during the operational life of the structure. Backup storage tanks may not be provided. In some embodiments, carriers may act as backup storage. If LNG storage tanks are incapable of receiving more LNG (e.g., full tanks, failure of tanks, failure of unloading arms, etc.), an LNG carrier may store LNG until tanks are capable of receiving additional LNG. In an embodiment, if two carriers arrive at the structure at substantially the same time, LNG may be stored on one of the carriers until the structure is capable of receiving additional LNG from the carrier.

The design of the containment tanks may inhibit LNG from contacting the roof of the tank. In an embodiment, the tank roof may not be in contact with LNG under any preconceived design circumstances. The tank roof design may be substantially different from the design of the bottom slab and walls.

In some embodiments, the main containment tank components may include, from the inside to the outside of the tank, the primary barrier, the secondary barrier, the insulating structure, the vapor barrier, and the concrete. The primary barrier may be the first line of protection against LNG leaks. In an embodiment, the primary barrier may be a corrugated membrane. The membrane may be stainless steel. An ammonia leak detection test may be performed on the membrane after it is erected. The secondary barrier may be Permaglass™. In an embodiment, the insulating structure may be positioned outside the secondary barrier. The insulting structure may be coupled to the concrete walls and bottom. The insulated structure may be coupled with bonding mastic and/or studs. The vapor barrier may be applied to one or more faces of the concrete to mitigate water ingress. The concrete may form the outermost layer of the tank.

The primary barrier may contain, or provide containment of, LNG and boil-off gas. In an embodiment, the primary barrier may be a membrane of stainless steel. The membrane may incorporate a double network of orthogonal corrugations acting like bellows. The membrane may allow free contraction and/or expansion under thermal expansion and/or contraction. Corrugations in the membrane may be formed by a cold folding process that does not reduce the thickness of the sheets of metal. The membrane sheets may be welded according to the GTAW (Gas Tungsten Arc Welding) process without filler material. The membrane sheets may be coupled to the insulation panels. In some embodiments, stainless steel anchoring pieces may weld the membrane on the insulation panels. The membrane sheets may be lap welded together.

In some embodiments, the secondary barrier may function to retain liquid and/or vapor in the event of leakage of the primary barrier. The secondary barrier may be located on top of the insulating structure. In an embodiment, the secondary barrier may be a coating applied to the insulating structure. The secondary barrier may be made of PERMAGLASS™ (trademark of a material developed by PERMALI) or a similar material. The secondary barrier may be coupled to the insulating structure. For example, the secondary barrier may be bonded on the plywood of the insulating panels. Installing triplex between panels may ensure the continuity of this secondary liner. The secondary barrier should be insulated from the concrete support structure. The insulating structure may comprise the secondary barrier. The insulating structure may comprise insulating material.

Further details regarding construction of LNG storage tanks are described in U.S. Pat. No. 6,378,722 entitled “Watertight and Thermally Insulating Tank with Improved Longitudinal Solid Angles of Intersection” to Dhellemmes, which is incorporated by reference as if fully set forth herein.

The insulation system may be similar for the insulating structure and the suspended deck. The insulation system may provide thermal insulation. In an embodiment, the insulating system may transmit the LNG pressure load to the concrete. The insulation system material may have low thermal conductivity, predictable behavior at LNG temperature, and/or good compressive properties. The insulation system may be load bearing. Epoxy mastic may be applied on the lower face of an insulating panel. The epoxy mastic may transfer loads to the concrete.

In certain embodiments, the insulation system may be made of a rigid cellular material. The insulation system may be made of PUF with >94% closed cell content. The insulation may have a sandwich like construction, where rigid polyurethane foam may be inserted between two plywood facings. The plywood facings may be bonded to the foam.

The insulation thickness required for tank walls, slab, and roof may be selected to limit the boil off gas rate due to heat ingress. The configuration of the insulation system may have a modular design. Insulation system may include standard panels, 2020 mm×1340 mm×263 mm thick; standard panels without openings for installation; dihedral panels; trihedral panels; and/or panels specially designed for pipe tower guiding, pump wells, etc. The roof may provide openings for pipe penetrations necessary for tank operation (e.g., LNG processes, instrumentation, nitrogen network, monitoring, etc.) Penetrations may run through the suspended deck.

In some embodiments, a suspended deck may provide insulation on top of the tank. The suspended deck may consist of a deck made of aluminum plates hanging from the concrete roof by means of aluminum hangers. The roof insulation may be placed on top of the suspended deck. The length of the aluminum deck hangers may be selected such that the hangers do not act as cold bridges to the concrete roof. The suspended deck may include open vents to ensure equilibrium of gas pressure on both sides of the suspended deck. The insulation used on the suspended deck may be lower in weight than the insulating panels on tank walls and slab.

The insulation system may minimize the amount of boil off. The insulation may keep the concrete structure within a desired temperature range. The suspended deck may be lined with one or more layers of mineral wool. The insulation may be glass fiber blankets. The suspended deck may be installed on an aluminum structure and suspended to upper beams of the tank with hangers.

A level of LNG in the tank may be regulated below an inner top surface of the tank. In an embodiment, the LNG may not contact the roof of a tank. The roof may not be liquid proof. In an embodiment, the ingress of water vapor through the concrete outer tank and egress of product vapor through the concrete outer tank roof may be inhibited by the application of a suitable system on the interior surface of the concrete tank.

In certain embodiments, a vapor barrier may be applied to the walls and/or slab of the concrete. The vapor barrier may be designed to limit ingress of water vapor through and/or from the concrete. The vapor barrier may bridge small cracks that appear in the concrete. In some embodiments, the vapor barrier may be a two compound, solvent free, epoxy resin combined with reinforcement (e.g., fiberglass). The vapor barrier may be applied by means of spraying machine on clean concrete, after application of a primer. The reinforcement may be applied by hand between two layers of epoxy. In an embodiment, a spraying machine may apply the epoxy and reinforcement simultaneously.

In some embodiments, a vapor barrier material may be applied to the roof of a tank. The roof vapor barrier may be carbon-manganese steel. The vapor barrier may be lap welded. The roof vapor barrier may function to tolerate creep of the concrete roof without buckling of the roof liner. The carbon steel liner on the roof may extend on the vertical walls down to a level where the membrane and the secondary liner may be connected. A horizontal insert may be embedded in a tank wall and connected to the carbon steel liner. The membrane upper sheet may be welded on this insert to close the insulation space.

In some embodiments, drainage systems, pressure monitors and regulators, nitrogen purge systems, and/or temperature monitoring systems may be positioned between tank components. The structure may include back-up monitors and regulators for temperature and/or pressure. The concrete may be equipped with a heating system to maintain a temperature of inner surfaces of concrete walls and slab. The temperature may be maintained such that water does not freeze proximate tank components. An Emergency Diesel Generator may be used to maintain a temperature of tank walls. In an embodiment, drainage systems remove water ingress. A piping network may be installed proximate the insulated space. The piping system may monitor and/or regulate conditions in the tank.

In some embodiments, tanks may be equipped with pump wells, suitable for send-out pumps. The pump wells may be supported from the structure roof. The brackets may be thermally isolated from the concrete structures. A filter box may be made around the bottom guide to prevent debris from entering the pump wells. The filter box may be removable. Pump pits may be provided on the bottom slab to achieve sufficient net positive suction head (NPSH) of the pumps without affecting overall tank height. Each pump well may have provisions for safe pump withdrawal/installation when the tank is in service, including a foot valve and nitrogen piping connection. In certain embodiments, LNG storage tanks may include pressure safety valves, vacuum relief valves, tank gauging, over-fill protection, roll-over prevention, leak detection, flammable gas detection, heat detection, settlement measurement systems, bottom slab and wall heating systems, cool-down sensors, temperature sensors for bottom and wall heating system, and/or lightning protection.

When the concrete tank is fully completed, the erection of the membrane containment system may start. The insulation system erection may start immediately after the vapor barrier has been applied. The temperature and humidity conditions inside the tank may be monitored to enable the erection procedures to proceed under specified conditions.

In some embodiments, the tank may be inspected. Membrane welds may be visually inspected. Dye penetrant inspection tests may be performed each day on at least a portion of that day's welds production. Prior to completion of the membrane erection, the supports for thermal sensors may be welded and inspected. Reference test leaks may be used to check the distribution of NH₃/N₂ mixture during the membrane tightness test. Reference test leaks (calibrated leaks) may be scattered at different locations on the wall and bottom membrane. Liquid penetrant examination of the membrane may be carried out in accordance with ASTM E165 or EN 571.

The carbon steel roof liner may be inspected to ensure that it is gas tight. Prior to pouring the concrete roof, the tightness of the welds of the liner may be checked by vacuum box testing and/or Dye Penetrant Testing (DPT). Vacuum box testing of the roof liner may be performed in accordance with BS 7777.

In certain embodiments, the global tightness of the primary barrier may be checked with an ammonia and/or helium test. A mixture of nitrogen and ammonia (e.g., ammonia with about 20% by volume of nitrogen at mixing point) may be introduced into the insulation space. A partial vacuum may have been previously been created in the insulation space. The mixture may flow through possible leaks in the membrane welds. Leaks may be detected when the mixture reacts with a sensitive paint applied on welds and possible leak points. The reaction may cause a detectable color change in the paint (e.g., from yellow to blue).

In some embodiments, purge/vent systems may be installed. The purge/vent system may be positioned in the insulation space in the tank. The piping of this system may be located behind the membrane. The piping may be positioned in the corrugations and in front of the secondary PERMAGLASS™ liner. The system may be designed such that it may be also be used for ammonia leak tests, space gas sampling of the insulation space by sampling the nitrogen circulation, regulation of absolute pressure in the insulation space, and/or nitrogen sweeping of the insulation space in case LNG vapor is detected.

A purge/vent system may be positioned between the secondary liner and the concrete hull of the structure. The purge/vent system may include a nitrogen injection network that allows sweeping and purging of the secondary insulation space, as needed. In an embodiment, the primary and secondary insulation space may communicate at the top of the tank to maintain pressure equilibrium. A purge/vent pipe with outlet and a nozzle may be installed on the tank roof. Installation of the pipe and nozzle may allow complete purging of the inner tank and dome space. In some embodiments, a purge system may be positioned between the primary barrier and the secondary barrier where the purge system is configured to remove natural gas leaking through the primary barrier.

Tank inspection after a period of operation may not be technically feasible and/or practical due to extensive decommissioning and the risk of actually introducing defects to the tanks during the inspection process. Water tightness of the concrete tank walls may be substantially ensured by means of bi-directional pre-stressing. Instrumentation and monitoring systems may be provided for leak detection.

Water ingress through the vapor barrier may deteriorate membrane tank insulation blocks. Measures to ensure liquid tightness of tank walls and slab may be employed. In an embodiment, liquid tightness may be partially tested with loads smaller than the operational differential heads. For instance apply 3-4 m of water on the base slab to test the base slab and the junctions of the slab with the tank walls. Areas above the hydraulic testing level may be tested by filling the tank space with pressurized air (e.g., approximately 2 barg). The liquid tightness testing methods used may be similar to concrete containment testing in nuclear reactors.

Despite the risk reducing measures as described above, it should be noted that during water ballasting the water level in the external storage areas may be similar to still water level (e.g., LNG tank walls and slab are subject to approx. 9 m water head). Water in the ballast storage areas may be temporary and too short a period for water to penetrate through 600 mm thick concrete elements. In an embodiment, construction of the structure may be performed in accordance with the National Codes and Standards (NCS) and the required quality control.

In some embodiments, LNG tanks may be equipped with automatic continuous tank level gauging, density monitoring, and density measuring. Each level indicator may have high and low alarms and will automatically stop in-tank pumps or unloading operations, as required. A temperature measurement system may be installed in the LNG tanks at various levels. Temperature of tank walls and/or slabs may be regulated to substantially prevent freezing in the event of any moisture ingress. Pressure transmitters may be provided in each tank to control the boil-off gas compressor, the vent system, alarms and to actuate the emergency shutdown system. Each tank may be protected against overpressure by safety valves. The tank pressure relief valves may release to atmosphere via a vent system. Natural gas from the pressure relief valves may be routed to the flare tower.

Cryogenic submerged pumps inside the tanks may transfer LNG from the storage tanks, via the re-condenser, to the suction of the LNG high-pressure send-out pumps. The LNG in-tank pumps may be high-volume, low-pressure pumps, and may provide sufficient net positive suction head (NPSH) for the deck mounted, high-pressure LNG pumps.

Between LNG storage tanks and the outer walls and bottom of the structure, a grid of ballast storage areas may be used for ballasting. In some embodiments, ballast storage areas, also referred to as ballast cells, may be disposed throughout the structure. Ballast storage areas may be used to facilitate transportation to the site, and to ground and secure the structure to the seafloor. Ballast storage areas may be used to obtain sufficient on bottom weight. One or more ballast storage areas may be incorporated into the structure or body of the structure.

Ballast storage areas may be at least partially filled with solid and/or liquid ballast material. In some embodiments, water is used as a liquid ballast material. Sand may be used as solid ballast material. In some embodiments, a heavier material than sand may be used as solid ballasting material. Iron ore may be used as a solid ballasting material. Assuming a water-saturated density of solid ballast material is 3.0 t/m³, 78,400 m³ of sand ballast may be replaced with approximately 40,000 m³ of iron ore ballast. Water drainage and/or monitoring systems may be installed to monitor and regulate water ingress through the external walls of the ballast storage areas.

In some embodiments, construction errors may lead to water penetration during the design life of the terminal. In certain embodiments, to inhibit water penetration, ballast storage areas filled with solid ballast material or “dry ballast” are positioned next to the LNG storage tank. In an embodiment, sand may be placed in ballast storage areas next to tanks in order to achieve sufficient on-bottom weight for the structure. Solid ballast material in ballast storage areas may maintain a dry condition to avoid water ingress into tank walls.

Dredging of a bottom of the body of water and placing the dredged material into the solid ballast tanks may supply solid ballast. Alternatively, offshore dredging may not be required for solid ballasting. Trailing suction hopper dredgers and floating pipelines may supply material for solid ballasting. Iron ore carriers may have conveyor belt systems on board to assist in solid ballasting. The solid ballast material may be mechanically placed in ballast storage areas. Solid ballast material may be pumped into ballast storage areas as a slurry.

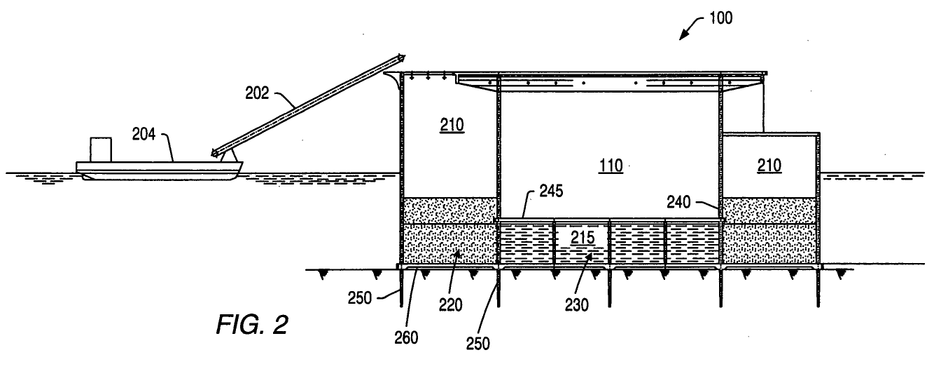

An embodiment of ballasting is depicted in FIG. 2. In some embodiments, side ballast storage areas 210, also referred to as outer ballast storage areas, and bottom ballast storage areas 215 may surround LNG tanks 110. Ballast storage areas 210 and 215 may provide additional on-bottom weight. Ballast storage areas 210 and 215 may increase a stability of the structure 100. In an embodiment, ballast storage areas 210 and 215 surrounding the tank 110 may be at least partially filled with a solid ballast material 220. Solid ballast material may be sand. In an embodiment, solid ballast material may be iron oxide. In an embodiment, bottom ballast storage areas 215 positioned below a tank 110 may be filled with liquid ballast material 230 instead of solid ballast material 220. Liquid ballast material may include water. Using liquid ballast material may facilitate decommissioning. In some embodiments, ballast storage areas 210 and 215 may be filled with liquid ballast material. Since access to bottom ballast storage areas 215 may be difficult, utilizing liquid ballast material may be more desired than utilizing solid ballast material. Since access to side ballast storage areas 210 may not be as difficult, utilizing solid ballast material may be more desired than utilizing liquid ballast material.

The concrete slab and walls surrounding LNG storage tanks may be designed to substantially assure liquid tightness during the operational lifetime of the structure. Inspection of the inside of a concrete hull where an LNG storage tank, such as, but not limited to, a membrane tank, is located may not be feasible after installation of the tank. In certain embodiments, water levels in the ballast storage areas below a tank are maintained below the bottom of the tank slab. A water level in a ballast storage area positioned below a tank may be maintained at a height below the ceiling of the ballast storage area, such that the freezing of water in the ballast does not occur proximate the tank. A drainage system may be installed. A water level monitoring system may be installed in the structure to maintain the water level.

In some embodiments, ballast storage areas are filled with water to provide a desired on bottom weight. After completion of water ballasting, dry ballasting may occur. In dry ballasting, the outer ballast storage areas are filled with sand ballast material, such that the apparent on bottom weight provides adequate foundation stability during the operational lifetime of the structure. In certain embodiments, solid-ballasting operations may be carried out using a crane and conveyor system 202 mounted on a barge 204 moored alongside the structure (as depicted in FIG. 2). Sand may be obtained from the shore by shuttle barges. Alternatively, the bottom of a body of water may be dredged for solid ballast material.

After completion of the solid ballast operation, a permanent pump and drainage system may ensure that water levels in the solid ballast storage areas and/or in the water ballast storage areas underneath the LNG storage tank remain sufficiently low. Water in ballast storage areas may be maintained at levels such that the water does not freeze proximate a tank wall and/or slab. A water level of at least about 0.5 m below the exterior of the tank slab may be tolerated. Water levels may be monitored and/or regulated to substantially inhibit water contact with the LNG tank walls and/or slab during the lifetime of a structure. Maintaining the water level in ballast storage areas below the bottom of the tank may substantially inhibit long-term water ingress into the concrete tank walls and slab. Filling ballast storage areas below the LNG membrane tank and the peripheral ballast storage areas with water and then adding solid ballast material into the peripheral ballast storage areas may accomplish water tightness and durability.

In some embodiments, the bottom part of tank walls 240 may be in contact with solid ballast material 220 instead of liquid ballast material 230. See FIG. 2. In an embodiment, solid ballast material may be placed in most ballast storage areas. Special drainage systems may be engineered to position dry solid ballast in most ballast storage areas. The floor 245 of the tank may be coated with a water barrier to protect the floor.

In some embodiments, the structure includes projections, also referred to as skirts, on a bottom surface of the body. The projections may at least partially project into a bottom of a body of water. Ballast storage areas may be filled such that the weight of the structure at least partially embeds at least a portion of the projections in the bottom of a body of water.

In some embodiments, projections 250 may at least partially form the foundation for the structure 100. See FIG. 2. The projections may provide at least some structural stability to the structure. Projections 250 may be positioned on a bottom surface 260 of the structure 100. The projections may be arranged in a repetitive grid of plane walls and slabs. Longitudinal and transverse projections located underneath the bottom surface of the structure may extend below the mudline in order to substantially achieve stability and/or inhibit the structure from sliding and overturning. The spacing and positioning of the projections may be such that the structure may be at least partially supported on the projections or skirts. Furthermore, the projections may be arranged to inhibit bowing of the structure while resting on the bottom of the body of water. In some embodiments, at least some of the projections are arranged in a grid pattern.

In some embodiments, the foundation may include ribs on a gravel berm. The foundation may be an excavated “sub-cut” of the order of about 5 m to about 7 m deep, with an about 2 m to about 3 m high berm consisting of crushed rock and gravel. Installation of a berm may require large quantities of dredging and/or disposal to replace softer topsoils. Benefits of a gravel berm are reduced width of the graving dock and possible integration of the scour protection and the berm materials. In certain embodiments, berm foundations may be used to reduce the size of the structure and/or increase under keel clearance. In an embodiment, a selection between projection foundations and berm foundations may depend on the site selected for the structure. In some embodiments, cost savings may be realized with gravel berms. Environmental issues around dredging and/or disposal may affect whether the sub-cut foundation may be used.

In an embodiment, in order to allow projections to at least partially penetrate into a bottom of a body of water, water is placed in ballast storage areas positioned in the structure. Water may be placed in ballast storage areas proximate an LNG storage tank temporarily. The low risk of water penetration into the LNG tank during the short period of time may be considered acceptable.

The foundation of the structure may be designed in accordance with applicable codes. The structural design of the structure may be in accordance with DNV (Det Norske Veritas) rules for Classification of Fixed Offshore Installations; DNV rules for the design and inspection of offshore structures—1995 edition; NS 3473 E, 4^{th} edition; DNV Technical Note TNA-101 “Design Against Accidental Loads”, October 1981; DNV Technical Note TNA-202 “Impact loads from boats”, May 1981; and/or CIRIA report (Department of Energy) N^{o}17 OTH 87240 “The assessment of impact damage caused by dropped objects on concrete offshore structures”, February 1989. The design of the structure may assume the following material properties: normal density reinforced concrete grade C60; reinforcement grade E500; and prestressing unit types VSL T15 class 1860 or similar.

In some embodiments, no under base grouting may be required after full penetration of the projections. In an embodiment, no specific seabed preparation may be required other than normal offshore hazard surveys and detailed bathymetrical survey work prior to installation.

Geotechnical data and soil profile may be considered in determining whether underbase grouting may be desirable. Properties of soil in an upper section of a bottom of a body of water may affect prestressing design. Vertical and horizontal pre-stressing levels in the structure may be determined based on the results from a global Finite Element structural analysis and/or applicable design codes and principles. The current project stage and/or reinforcement quantities acceptable for construction of the structure may be considered in determining prestressing levels. In some embodiments, reinforcement quantities may be determined based on experience and/or requirements from applicable codes and standards.

In some embodiments, the foundation of the structure may include a rectangular base. The foundation may be equipped with a plurality of projections arranged as concrete projections in combination with ribs. The projections may be 6.5 m deep, 0.30 m wide at their tip, with a wedge angle lower than 1°, and/or connected to the structure bottom through ribs. A projection length may be designed based on the required penetration depth for different environmental loading, clay strength, structure orientation, and/or structure weight. A factor in structure stability under such environmental conditions is the horizontal “direct simple” shear strength of the underlying clays in the upper 10 meters of a bottom of a body of water. Shear strength may be measured directly in the laboratory by cycling a shear load across clay samples at vertical pressures equivalent to the in-situ condition and assessing the “cyclic” strength of the clays. The testing aims to replicate the 100-year design storm passing across the structure causing a sliding of the whole structure at the projection tips.

In an embodiment, the arrangement of the projections may be five rows of projections parallel to the longitudinal direction of the structure, at spacings varying from 17.5 to 20 m, with six rows of projections parallel to the transversal direction of the structure, at spacings varying from 27 to 40 m. The projections may be aligned with internal ballast cell walls.

The structure design may be at least partially based on no uplift weight requirement, bearing and sliding capacities, projection resistance to penetration, soil-structure interaction, and/or immediate and consolidation settlements. The ultimate foundation capacity with respect to bearing and sliding capacity may be carried out in accordance with DNV Rules. Projection penetration during structure installation may be checked using conventional DNV rules.

If the maximum apparent weight of the structure during installation is not large enough to enable a desired penetration of the projections into a bottom of a body of water, suction may be used to achieve the required penetration depth. Air trapped in the compartments of the projections may provide some buoyancy to the structure. At least a portion of the trapped air may be suctioned out of the compartments. Removal of at least a portion of the air may cause the projections to penetrate or further penetrate the bottom of a body of water. Suction may occur by means of the piping system installed for air cushions used during installation of the structure at a site. In some embodiments, at least some of the projections are oriented such that one or more compartments are formed on the bottom of the body of the structure. In some embodiments, at least a portion of the compartments are configured to entrap air between the body and the water surface. In some embodiments trapping air in at least a portion of the compartments increases the buoyancy of the body.

The projection dimensions may be selected to enable penetration into competent soil layers. The length of the projections may be selected such that failure occurs due to horizontal sliding of the structure along a plane at the projection tips. Uppermost soils may have insufficient shear strength and so the projections must at least partially penetrate adequately into the overconsolidated clay. In some embodiments, at least a portion of the projections are at least partially embedded in the bottom of the body of water. In some embodiments, at least some of the projections inhibit lateral movement of the structure.

The projection foundation design may provide adequate foundation stability for 100-year design conditions. 10,000 yr hurricane conditions may be considered an accidental load for which load factors are reduced. The projection foundation may be capable of substantially withstanding loads from waves. In some embodiments, the LNG structure may be designed such that environmental loads including wind, wave, and/or currents in an average 100-year period may not substantially damage the structure. The structure may be designed to substantially withstand accidental loads such as, ship impacts and/or dropped objects.

In some embodiments, under keel clearance may affect the design of the LNG structure. For example, an available channel depth may be about 13.7 m. The structure may be designed to maintain a specific under keel clearance in a predetermined channel. Channel depth may also affect draft of the structure. Lightweight concrete, semi-lightweight concrete, buoyancy caissons, and/or widening the structure base may be used to increase under keel clearance.

The decision to use lightweight concrete or the partial use of lightweight concrete for the construction of offshore structures has implications for the design and construction of the structure. Lightweight concrete may have a density of less than about 2000 kg/m³. Liapor, Lytag and/or Solite, commercially available lightweight concrete aggregates, may be used in certain embodiments.

Lightweight concrete may have reduced shear and bond strength in comparison with normal density concrete. The result may be potentially larger section sizes and/or higher reinforcement quantities. The higher reinforcement quantities must be detailed particularly carefully if normal productivity levels are to be achieved during construction. Using the lower density of the lightweight concrete may offer an opportunity to reduce the draft of a structure by around 1.5 m.

The permeability of lightweight concrete over normal concrete may not pose a problem for the structure. Permeability of concrete is a function of the cracks and voids available for water ingress into and/or out of the material. Generally, permeability is controlled by water/cement ratio, content of cementitious materials, effectiveness of compaction methods, and/or curing. Lightweight aggregates are usually associated with high void volume and higher permeability. However, high quality structural lightweight aggregate may have well separated voids. The cement paste covering each aggregate particle in lightweight aggregate may contribute to the water-tightness of the concrete. The lightweight aggregate and the hardened cement paste matrix may develop a better bond than the corresponding normal weight aggregate.

Since the two phases in lightweight concrete are highly compatible in their elastic and thermal properties, microcracking and debonding do not occur to the same extent as in normal weight aggregate concrete. Under mechanical and/or thermal loads, hardened cement paste matrix and the lightweight aggregate may strain in a similar elastic manner. The manner of the strain may be close to that of the reinforcing steel. In an embodiment, lightweight concrete may be less permeable than normal weight aggregate concrete despite being more porous.

The use of pozzolans may further improve the internal structure of lightweight concrete. Pozzolans may make lightweight concrete less permeable. Pozzolans are silicious or silicious and aluminous compounds which in themselves posses little or no cementitious properties. In the presence of moisture, pozzolans react with calcium hydroxide to form compounds with cementitous properties. Mineral admixtures (e.g., silica fume and/or fly-ash) may enhance the impermeability and/or improve resistance to water. Laboratory permeability tests may do injustice to the lightweight concrete since they test the concrete under unloaded static conditions. Loading may change the permeability of a material. As explained before, micro-cracking caused by elastic incompatibility of the concrete components may cause progressive debonding over the life of the structure. Lightweight concrete may exhibit less debonding than normal weight concrete.

Lightweight concrete may provide sufficient structural strength for the structure. It may be possible to produce 50 MPa characteristic cube strength (6500 psi cylinder strength) lightweight concrete provided suitable materials and good quality production facilities are available. The required materials may include strong lightweight coarse aggregate, high strength grade cement (or lower strength cement with an admixture such as silica fume), chemical admixtures (e.g., medium or high range water-reducers), and/or pumping aids. In certain embodiments, the cementitious content of the lightweight concrete mix may be higher than that required for normal weight concrete of a similar strength. In an embodiment, lightweight concrete of strength grade C60 (8000 psi cylinder strength) (55 MPa) may be possible with some types of lightweight aggregate (e.g., Liapor and/or Lytag) and/or very high quality production equipment and control.

Lightweight concrete may be batched, mixed, transported, and/or placed in much the same way and using the same equipment as normal weight concrete. The lightweight nature of the lightweight aggregates may necessitate precautions to substantially inhibit segregation and/or bleeding. Segregation may occur in lightweight concrete due to the tendency of lightweight aggregate to float in the heavier matrix. The porous nature of lightweight concrete may cause water absorption. Water absorption by lightweight concrete may result in rapid loss of workability if the water content of the aggregates is too low. Water absorption may occur if the concrete is pumped.

The seven-day strength of high strength lightweight concrete may be about 86% to about 92% of the 28 day strength, compared with about 75% to about 80% for normal weight aggregate concrete. Little strength gain may be observed after 28 days if using a standard lightweight concrete, such as Portland cement, despite the perception that moisture in aggregate promotes continued hydration.

Controlling the float-out draft of a structure may be desirable. Controlling the concrete density for concrete offshore structures may aid controlling draft. It may be more difficult to predict and control density in lightweight concrete versus normal weight concrete. In an embodiment, a saturated density from about 2000 kg/m³ may be achieved for lightweight concrete.

Lightweight aggregates may be controlled by standards, such as ASTM 330. In certain embodiments, higher strength lightweight concrete includes normal weight sand. Air entrainment may help workability of the mix. Air entrainment may reduce flotation of the lightweight particles. In certain embodiments, air entrainment in the region of about 3% to about 5% total air content by volume of fresh concrete may be used. In an embodiment, air entrainment may have a negative impact on overall strength. The effect on strength may be less for lightweight concrete than for normal weight concrete. The effect may be of the order of 1 MPa per unit percent of entrained air.

In some embodiments, a high strength matrix may be required to obtain a desired compressive strength in the concrete. In an embodiment, lightweight concrete may include commercially available, high strength, Portland cement; medium or high-range water-reducing admixtures; and/or silica fume.

Using ground granulated blast-furnace slag, fly ash, and/or silica fume may improve cohesion and/or reduce segregation. In some embodiments, these materials may also be used as pumping aids. Special admixtures also may be used. Plasticizers and/or other admixtures may be useful for pumping lightweight concrete over long distances and/or large heights. Concrete may be proportioned to ensure required workability at the point of placement. The workability of the concrete at the plant may be increased to account for any workability loss during transportation.

In an embodiment, specially formulated lightweight concrete pumping admixtures may reduce segregation. Admixtures may compensate for imperfect pre-soaking of aggregates. Admixtures may compensate for the large pump pressures needed to pump concrete up to large heights. Trial mixes may be used to determine an optimum mixture. The cement content of lightweight concrete is generally higher than normal weight concrete and for high strength lightweight concrete will typically include about 400 kg/m³ to about 600 kg/m³ of cement.

Transportation of lightweight concrete may be substantially similar to the standard procedure for normal weight concrete works. High-pressure pumping of lightweight concrete with non-highly saturated aggregates may cause the absorption of water into the aggregate. Absorption of the water in the aggregate reduces workability and/or increases difficulties involved in pumping. In an embodiment, water to aid pumping is added under strictly controlled conditions. A concrete mix may be proportioned and mixed such that it has the required workability at the point of placement. Lightweight aggregate manufacturers may have information to facilitate consistent pumping, such as minimum levels of aggregate absorption, minimum slump prior to addition of superplasticisers, and about using other admixtures. Information from aggregate manufacturers may influence lightweight concrete specifications.

In some embodiments, in order to reduce overall concrete quantities, steel beams may replace one or more of the concrete beams. For example, but not limited to, steel supporting beams may replace one or more concrete supporting beams. This may reduce concrete quantities of the tank walls and/or the structure. Replacing one or more of the concrete beams with steel beams may aid in floating the structure and/or body of the structure during transportation and/or decreasing the overall weight of the structure and/or body of the structure.

The elevation of the tank slab may also be reduced. The top elevation of a structure and/or body of a structure of the present invention may also be reduced or minimized. Reducing or minimizing the top elevation of the structure and/or body of the structure may reduce the quantity of concrete utilized and the overall weight of the structure and/or body of the structure may be reduced as well. Understanding the run-up and over-topping of hurricane wave conditions provides for an optimization of the top elevation of the structure and/or body of the structure. In some embodiments, minimizing or reducing the height of the structure and/or body of the structure underneath the one or more LNG storage tanks (see bottom of tank 245 and bottom ballast storage area 215 in FIG. 2), in other words, minimizing or reducing the height from a bottom of the structure and/or body of the structure that rests on the bottom of a body of water up to the bottom of the one or more LNG tanks, may provide for a minimizing and/or optimizing of the quantity of concrete utilized and may also provide for a minimizing and/or optimizing of the overall weight of the structure and/or body of the structure.

In some embodiments, the design of the structure may be based on the applicable and/or available codes. In an embodiment, current Norwegian codes and standards are used in the design of the structure. Most recent gravity base structures have adopted the Det Norske Veritas (DnV) Classification Notes 30.4 method for foundation design. The DnV rules may be the most appropriate standard. There may be no suitable alternatives available within USA practice at this time. The American standard for reinforced concrete design, American Concrete Institute (ACI) 318-02, covers general building and civil engineering applications. Specific guidance on its use in a marine environment is given in ACI 357R-84 (re-approved 1997) entitled “Guide for the Design and Construction of Fixed Offshore Concrete Structures”. ACI 357.2R-88 (re-approved 1997) entitled “State-of-the-Art Report on Barge-Like Concrete Structures” contains other general observations on gravity base structures. The above codes and standards have been used for the design of the numerous small gravity structures located in shallow waters offshore in the Gulf of Mexico. However, as noted above, there is no recent experience of using ACI 318 on major structures. ACI 318 is a limit state code. ACI 318 adopts strength reduction factors rather than the philosophy of European limit state codes, which apply partial safety factors to material strengths that vary with the particular limit state under consideration (e.g., serviceability, ultimate, progressive collapse).

Soil erosion of a bottom of the body of water may be a concern. In an embodiment, the gap between both units of the structure may be substantially reduced after offshore installation to prevent substantial erosion of the bottom of a body of water between the units. Reducing the size of a gap between the two units of the structure may occur after the ballast operations of both units have been completed. In an embodiment, each unit is simultaneously ballasted and scour protection is installed around the structure.

In some embodiments, scour protection may be installed to inhibit erosion of a bottom of a body of water proximate the structure. Erosion proximate the foundation of the structure may affect stability. Scour protection may be positioned around the structure. In an embodiment, scour protection may be installed proximate portions of the foundation that at least partially extend into a bottom of a body of water.

Scour protection may be used proximate tie-in locations for exporting pipelines. The scour protection along the structure may be extended beyond the location of pipeline tie-ins to minimize the development of holes and imposed deformations on the pipeline. The pipeline tie-ins may be positioned at least partially above the scour protection. Scour protection may be used to minimize damage from LNG carrier thrusters and/or propeller impacts. Scour protection may be configured to inhibit soil erosion about a base of the structure. Scour protection may at least partially circumscribe the structure.

Scour protection may substantially inhibit undermining the stability of the structure. Scour protection may be designed to substantially inhibit erosion of the bottom of a body of water. The sizing of the scour protection may be selected based upon hydrodynamic conditions (e.g., waves, currents, and LNG carrier propeller jet streams), subsoil data, the geometry of the structure, and/or water depth. Scour protection may be installed based on design code recommendations. In an embodiment, scour protection may substantially affect foundation integrity and/or projection design. The projection design selected may be dependent on the scour protection used in the structure.

The scour protection may be governed by the depth of the granular material in the top layers of the seabed. The granular material depth may anticipate the depth of possible scour holes and consequently the required width of the required scour protection. In an embodiment, the anticipated depth of scour is related to the scour protection width installed proximate the structure. A stiff clay layer below the bottom of a body of water may be resistant to scour. A slope, developed by a geotechnical failure caused by scouring, may be substantially covered by scour protection to stabilize the bottom of the structure.

The type and thickness of the scour protection may depend on the velocities at various spots around the structure. In some embodiments, the scour protection may be substantially cubic. Scour protection may have a substantially square, substantially circular, substantially oval, substantially rectangular, and/or substantially irregular cross-section. Scour protection may be concrete- or sand-filled mattresses and/or heavy concrete elements. Scour protection may include a gabion type solution. A rock filled gabion-type scour protection mattress may substantially prevent undermining the foundation integrity and/or stability.

Gabion mattresses consist of steel wire boxes filled with relatively small rocks. The gabion mattresses may be installed in sections after the installation of the structure. The gabion mattresses may be attached to the structure with chains to avoid leakage of small rocks and/or sand. The gabion mattress may be attached to the structure such that the mattress may follow a developing scour hole.

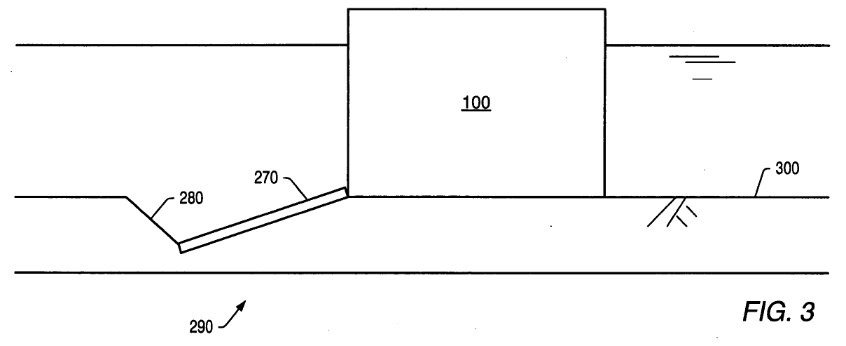

In FIG. 3, an embodiment of the falling apron principle of scour protection of structure 100 is depicted. The gabion mattress 270 may allow a mattress to self heal scour holes 280. A scour hole 280 may extend to a layer of stiff clay 290 in the bottom 300 of the body of water. The gabion mattress 270 may fall into the scour hole 280 and at least partially protect the bottom 300 of the body of water from further erosion.

Different hydrodynamic phenomena occur at the “long straight” sides of the structure than at the corners and short straight sides. The thickness and rock fill of the scour protection may differ in different areas of the structure. The required thickness of the mattress may be less at the long straight sides than at the corners/short straight sides. A rock class of 10 kg to 60 kg, and 60 kg to 300 kg, respectively, may be used for the long straight sides and the corners/short straight sides.

Below a gabion mattress, a suitable filter layer/material may be applied to prevent washout through transitions and voids in the rock fill of the mattress. The filter material may be a filter of geotextile. The filter material may be attached to the bottom of the gabions before placement. The filter material may include a granular filter, such as gravel.

An offshore LNG storage and receiving structure may be designed to receive liquefied natural gas from carriers and transfer the LNG to one or more LNG storage tanks. The LNG may then be vaporized in a heat exchange vaporization system. The vaporized natural gas may be sent out among several pipelines that distribute natural gas to other facilities for further processing and/or distribution.

The LNG storage tanks may contain vapor and liquefied natural gas. Natural gas vapor may form due to heat ingress into the storage tank. Heat may be introduced to the tank during ship unloading. Heat may enter the storage tanks from the LNG recirculation lines and by changes in the fluid composition when LNG is unloaded into the storage tanks. This vaporized LNG is typically referred to as boil-off gas (“BOG”). The normal BOG rate may be about 0.1% per day of the total storage volume.

In some embodiments, BOG may be used to regulate the pressure in the LNG carrier while unloading. BOG may be used to regulate a pressure in LNG tanks. In certain embodiments, BOG may be compressed by a BOG compressor and routed to a recondenser, also referred to as a condenser, that recondenses BOG. In an embodiment, compressors may be centrifugal compressors. The recondensed BOG may mix with LNG inside the recondenser. The mixture may be routed to the gasification trains. The recondenser may be designed to process all BOG generated in the structure. The recondenser may be designed to process vapor from unloading carriers. In some embodiments, one or more recondensers may be coupled to one or more LNG storage tanks. The recondensers may be configured to convert natural gas to LNG.

A pressure in the LNG tanks may be regulated by the operation of one or more BOG compressors. Vapor in the LNG tank may be pumped to a BOG compressor and returned to the LNG storage tanks. The compressed BOG may maintain a pressure in a tank. BOG compressors may operate to inhibit flaring during compressor maintenance. Vapor may be routed through a BOG header to the compressors.

BOG compressors may be designed to accommodate BOG from a carrier unloading during minimum send-out rate conditions. A vapor generation rate may not substantially increase during the life of the structure. As a rate of LNG send-out increases, the greater the structure may accommodate boil-off gas. At peak send-out rates, send-out gas may be recycled to tanks to maintain tank pressures. In certain embodiments, unloading may be delayed when a send-out rate is approximately zero. In an embodiment, LP (low pressure) pumps may pull a vacuum when send-out rates are high without recycling at least a part of send-out gas. In some embodiments, the use of a separate high-pressure reciprocating compressor to export boil-off gas directly to a pipeline during hurricanes is not justified when compared to the cost of flaring the limited amount of boil-off vapor expected during such a scenario. A compressor may be used to direct boil-off gas during severe weather to pipelines. Spare boil-off gas compressors may be installed. In some embodiments, one or more boil-off gas compressors may be coupled to one or more LNG storage tanks. The one or more boil-off gas compressors may be configured to provide a source of compressed natural gas to the structure.

During hurricanes, the terminal may be abandoned and gas send-out will cease. All non-critical operations may be shut down and excess BOG may be flared rather than reprocessed. The recondenser may recondense at least a part of the BOG and provide sufficient pressure and surge volume at the suction of the high-pressure LNG send-out pumps. The main flow of LNG from the in-tank pumps may be routed directly to the recondenser. BOG may be recondensed by mixing it with a portion of cold LNG from the storage tanks.

In some embodiments, a recondenser may process BOG not returned to the LNG carrier. In an embodiment, the recondenser may be stainless steel. The internal vessel of the recondenser may not be inspected. In an embodiment, the recondenser vessel may be externally inspected.

In some embodiments, the recondenser may use subcooled LNG to condense BOG. The recondenser may be designed to at least partially recondense all BOG expected at maximum vapor generation rate, to provide adequate net positive suction head (“NPSH”) to the pumps, to prevent cavitation and possible pump damage, and/or to provide sufficient residence time at peak LNG throughputs to control the recondenser. In certain embodiments, normal minimum sendout may be determined as the lowest total gas sendout (LNG+BOG) required to recondense all BOG during ship unloading. In an embodiment, a recondenser bypass may be used to accommodate higher than expected LNG sendout rates. The bypass may send BOG to flare or vent systems.

In some embodiments, the recondenser may not be regulated. Subcooled LNG from the in-tank pumps may enter the recondenser at one or more locations. LNG for condensation may enter at the top of the recondenser. Then LNG may pass through a distributor and into a packed bed section. The LNG may cause condensation of BOG in the packed bed section. A second LNG stream may bypass the packing and enter the recondenser proximate the bottom of the vessel. The second stream may mix with the condensing BOG to produce a subcooled liquid stream. LNG may exit the recondenser through anti-vortex arrangements from the bottom of the vessel before passing to the pumps.

The control system of the recondenser may maintain a sufficient liquid level in the recondenser to protect the NPSH requirements and/or ensure efficient recondensation of BOG. The magnitude of the gas flow to the recondenser may be determined by the amount of BOG. The volumetric gas flow entering the recondenser may be measured and compensated for temperature and pressure. An operator set pre-determined ratio may determine the amount of fresh LNG required to condense BOG.

In some embodiments, incomplete condensation of BOG may increase the pressure of the vapor space in the recondenser. The liquid level may then decrease and more contact area for condensation may be created (and vice versa). If the pressure in the vapor space is too high (e.g., a blocked recondenser outlet causes pressure build up), a pressure controller may open a control valve to bleed excess gas to the flare. When incoming BOG flow to the recondenser is interrupted (e.g., low LNG tank pressure stops the compressor), the output signal from the ratio controller may be zero. When the output signal is zero, the packing area may be completely bypassed. To prevent the recondenser from becoming completely liquid-full (e.g., from continued condensation of the remaining BOG in the recondenser), the level controller may open the level control valve to inject ‘padding’ gas from the natural gas send-out line. Natural gas from the send-out line may compensate for restricted BOG flow. Failure of the bottom pressure control loop or a blocked recondenser outlet may cause a high liquid level in the LNG storage tank and a high pressure in the vapor space. To inhibit an excessive increase of the vapor space pressure, a pressure controller may override the output of the level controller and vent or flare excess vapor.

During the production of natural gas, high-pressure pumps may transfer LNG from the tanks to one or more heat exchangers, also referred to as heaters or vaporizers. LNG may be vaporized at high pressures in the heat exchangers. In one embodiment, the heat exchanger is an open rack vaporizer. In another embodiment, the heat exchanger is a submerged combustion vaporizer. LNG may be fed through aluminum tubes. A heating medium may flow from the top of the vaporizers over the tubes, whereby vaporization occurs. The temperature drop across the heat exchanger of the heating medium may be less than or equal to about 10° C. (18° F.).

Seawater may be used as the heating medium for one or more heat exchangers. The heat exchangers may use water from the body of water the structure is positioned in to vaporize LNG in a once-through configuration. Water lift pumps may deliver water to the heat exchangers from a water intake system. Intake screens, velocity, location, and/or orientation may be selected to minimize marine life entrainment and impingement. The water may be treated to minimize marine growth within the water intake system. The water intake system may discharge water at an outlet structure. A water intake and outlet system may be installed to circulate the required volume of water from the body of water, through the facilities on the structure deck, and back to the body of water.

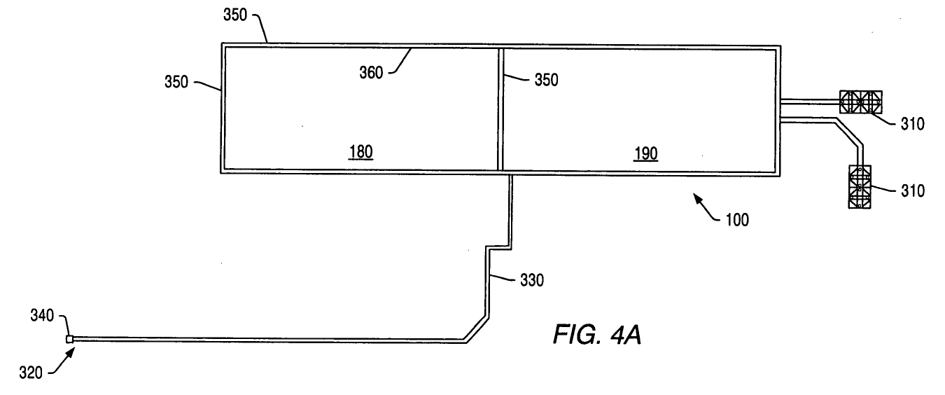

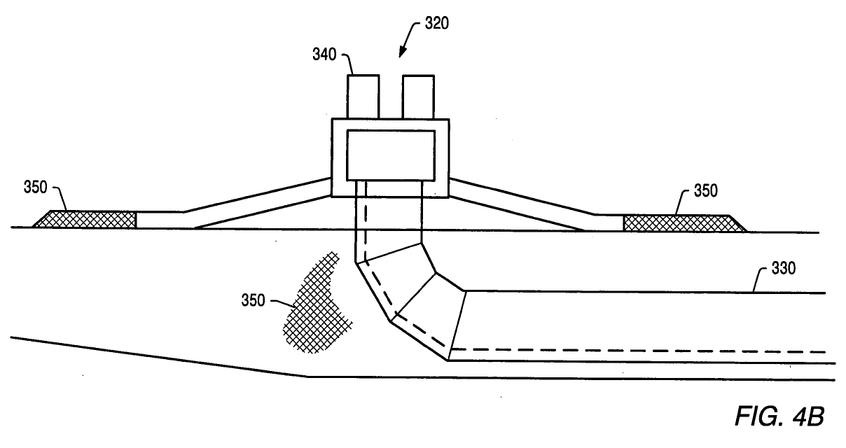

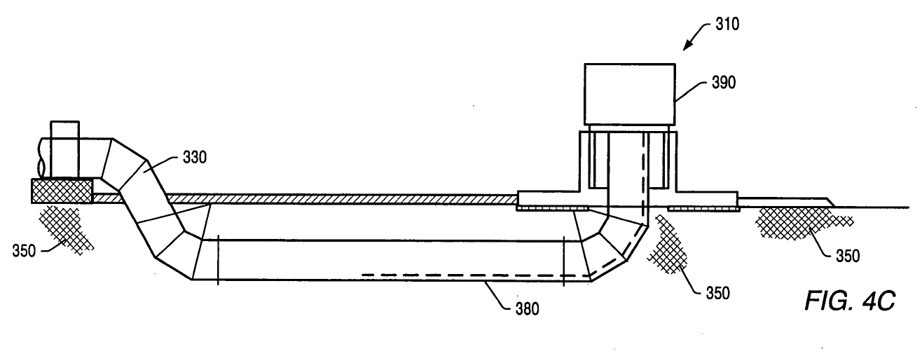

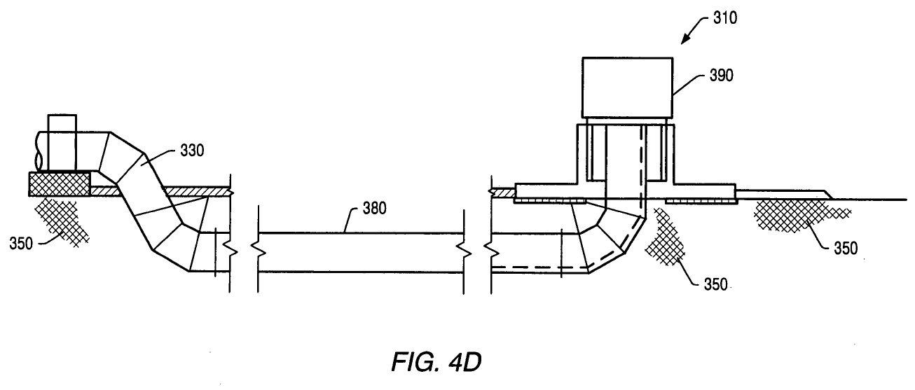

FIG. 4A depicts an embodiment of a water intake system. The water intake 310 and outlet 320 structures may be at least partially positioned on a bottom of a body of water. The inlet structures 310 may be positioned relatively close to the structure 100 and outside strong concentrations of currents and waves. One or more outlets 320 of the water intake system may extend from the structure 100. The outlets 320 may not be located proximate the structure 100.

An embodiment of an outlet of a water intake system is depicted in FIGS. 4A-4B. An outlet conduit 330 may extend from the structure 100 and release water away from water inlet 310. The outlet 320 may include vertical diffusers 340. The flow rate at the outlet may be relatively low. Scour protection 350 may be positioned proximate outlet bends and/or connections to the bottom of a body of water.

Scour protection 350 may be positioned proximate the inlets 310, the outlets 320, the structure 100, and/or between the units 180, 190 to inhibit erosion. Scour protection along the structure may extend beyond the location of the outlet pipeline to minimize the development of holes and/or imposed deformations.

FIG. 4C depicts an embodiment of an inlet structure of a water intake system. Additional bends in the inlet 310 and/or outlet line may be included at the interface of a buried section of the inlet/outlet and a section running over the scour protection 350 to accommodate differential settlement. In an embodiment, concrete ballast mattresses may couple the water intake conduit to the sea floor. Scour protection may be applied proximate the concrete mattress to inhibit erosion of the ballast mattress.

FIG. 4D depicts an embodiment of an inlet structure of a water intake system. The break in water conduit 380 is to indicate, though not shown, that water conduit 380 may be routed to the vaporization equipment located on an upper surface of the structure and then routed from the vaporization equipment to the water outlet.

In some embodiments, the same scour protection 350 may be used for the long sides 360 of the structure 100 and the inlet structures 310. In an embodiment, a gabion mattress is not installed at the outlets. A standard scour protection may be applied at the one or more outlets. In an embodiment, standard scour protection may include 60-300 kg rocks (0.5 m thick) upon a filter layer of either geotextile or gravel.

The water intake system may include equipment (e.g., pumps) that provides water to the heat exchangers; fixed hardware that channels water from the body of water, through the vaporization system, and back to the body of water, such as the ocean, again; pump chambers, from which water may be pumped to heat exchangers; and water inlets and outlets off the structure. The water intake system may be designed to have redundancy. In an embodiment, two or more water inlets may be used. In this manner if one inlet is offline, another inlet may provide water to the structure. In an embodiment, the outlet system may include only one outlet. Water may flow over a side of the deck if the outlet is offline. The water inlet may comprise a water inlet conduit comprising a water receiving end and a water dispensing end.

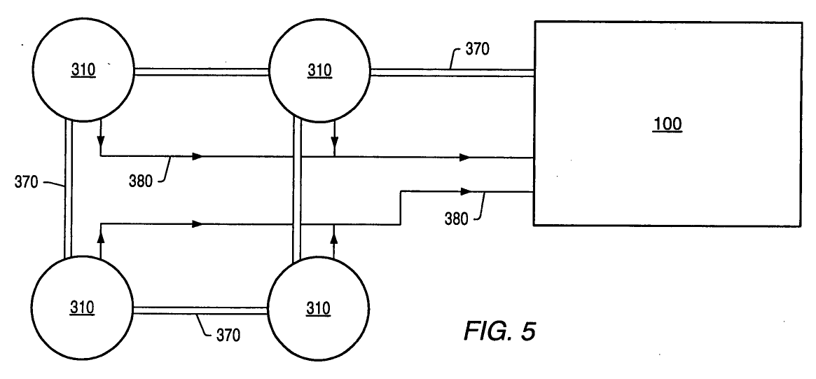

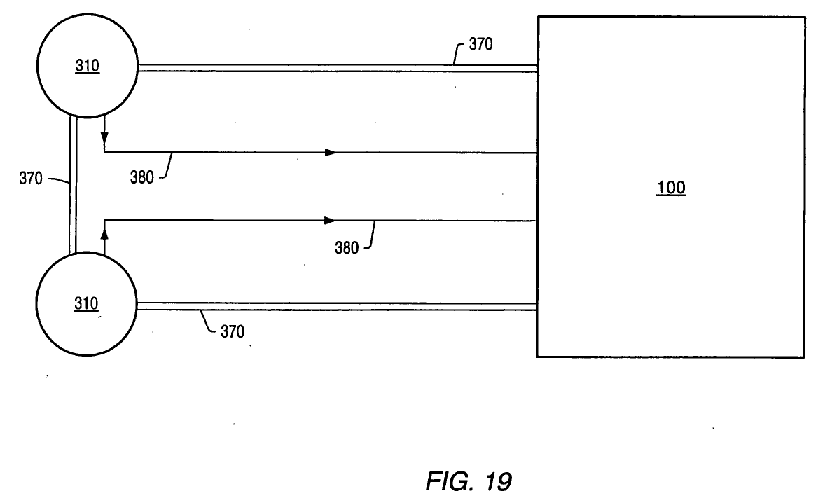

FIG. 5 and FIG. 19 depict embodiments of water inlets. The water intake system may include one or more inlets 310. In some embodiments, identical independent water intake systems may be installed on the structure to have redundancy. Environmental and/or permitting issues may complicate the introduction of additional intake lines at later stages. In an embodiment, only a single intake line may be installed.

The water inlet 310 structures may be coupled to each other and/or the structure 100 via bridge structures 370. Water inlets 310 may be coupled via water conduits 380. Water may enter an opening in the water-receiving end 390 (see FIGS. 4C and 4D) of the inlet 310. The water-receiving end 390 may be positioned at a distance from the structure 100. In one embodiment, the water-receiving end 390 of the water intake conduit 380 may be positioned at a distance from the structure 100 such that standing waves created proximate the structure do not substantially affect the flow of water into the water-receiving end. Screens may be positioned at the water-receiving end of the water inlet to inhibit sea life and debris from entering the water inlet conduit. Water may flow from inlets 310 via one or more water inlet conduits 380 to one or more water receiving chambers in the structure 100.

Water from the water intake line may flow into an intake collection header. Water may flow from the collection header to a single intake conduit. Water may flow from the single water intake conduit into a water-receiving chamber in the structure. In an embodiment, water may be filtered in the structure. Screens may be positioned in the water-receiving chamber. Pumps may transfer water from the chamber to heat exchangers and/or other locations. The water inlet conduit may be a cement-lined carbon steel pipeline. One or more of the water-receiving ends may be positioned within a water intake cage. The water intake cage may comprise an intake header. The intake header may be supported above the bottom of the body of water by a support structure. One or more water receiving ends of the inlet conduit may be positioned in the intake header. The water intake cage may surround the water inlet. The water intake cage may be larger than the water inlet. The water intake cage may reduce the velocity of water entering the water inlet.

Scour protection may at least partially circumscribe the water intake cage. The water intake cage may comprise a grating coupled to the intake header. The grating may be configured to inhibit debris from entering the intake header. The water intake cage may comprise one or more water filters disposed within the intake header. The one or more water filters may be configured to inhibit debris from entering one or more of the inlet conduits. The filters may be for example, but not limited to, screen filters, wrapped wire filters, and the like and combinations thereof. In some embodiments, a water inlet may be positioned above the bottom of the body of water such that sediment at the bottom of the body of water is inhibited from entering the water receiving end during use. The water inlet may comprise an intake header supported above the bottom of the body of water by a support structure and a grating coupled to the intake header. The grating may be configured to inhibit debris from entering the intake header.

Baffles that reduce the effects of standing waves on water levels in water receiving chambers and/or flow in the water intake system may be positioned in water receiving ends, water inlet conduits, inlets, and/or water receiving chambers. Orifices positioned in the inlet may substantially equalize flow among the inlets. In an embodiment, pressure drops across screens may be smaller than pressure drops across the collection header.

Water intake systems may be positioned at a distance from the structure such that rapid water level variations do not substantially affect the flow of water in the intake system. In some embodiments, the distance of the inlet from the structure may be more than about 0.25 times the wavelength of water. The distance an inlet is positioned away from the structure may be selected to have marginal wave reflection. In an embodiment, the water intake structure may be located at a distance of at least about 50 m from the structure wall.

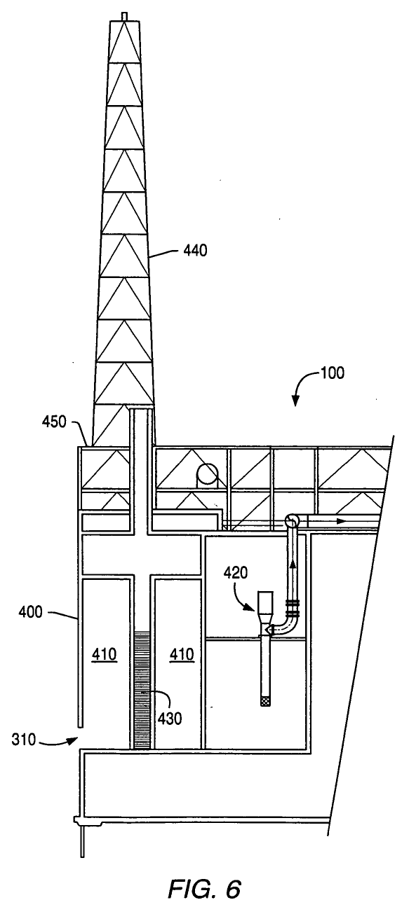

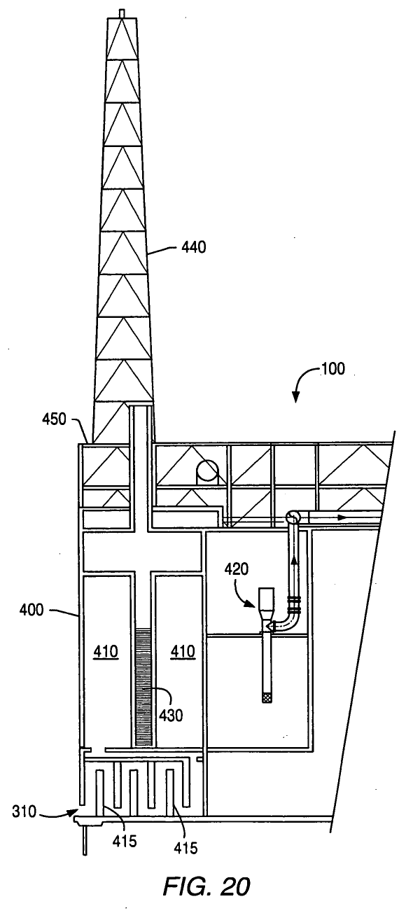

FIG. 6 and FIG. 20 depict embodiments of a water inlet 310 positioned on a vertical wall 400 of the structure 100. Water inlets may be positioned directly on the surface of the structure. A water inlet 310 may be positioned on a surface of the structure 100 below a water level of a body of water. In some embodiments, a water inlet 310 may be designed such that reflections of waves impacting the structure (e.g., standing waves) do not substantially affect the flow of water in the intake system. A water inlet 310 may reduce the effect of standing waves on a water level in one or more containment regions 410, also referred to as water-receiving chambers.

Baffles may be positioned in openings in the inlet 310 and/or water receiving chambers. In some embodiments, baffles may reduce the effect of wave reflections against the structure and/or on water levels in containment regions and/or the flow in water intake systems. FIG. 20 depicts an embodiment of baffles 415 in an area below water receiving chamber 410. Baffles may reduce the risk of pumps cavitating when a standing wave pulls water from a chamber. In an embodiment, baffles may separate a first water-receiving chamber from a second water-receiving chamber. The level in the second water-receiving chamber may not rapidly change due to the baffles. Maintaining water in the second water-receiving chamber may prevent pump cavitation. Pumps 420 may transfer water from a water-receiving chamber 410 to a heat exchanger or other process equipment. In some embodiments, one or more baffles may be coupled to one or more water inlets. The one or more baffles may reduce the effects of waves on the water entering the one or more water inlets. In some embodiments, one or more baffles may be coupled to a second water-receiving chamber. The one or more baffles may reduce the effects of waves on the water entering the second water-receiving chamber.

In an embodiment, screens 430 may be positioned in inlet 310 and/or water receiving chamber 410 to inhibit impingement or ingress of marine life. A crane 440 positioned on the structure 100 may facilitate maintenance of the water intake system (e.g., removing screens and/or baffles for maintenance or repair). In an embodiment, the crane 440 may be positioned on an elevated top surface 450 of the structure 100.

In some embodiments, the inlet may have dimensions of about 5 m (length) by about 5 m (width) by about 3.5 m (height). The intake velocity may be no more than about 0.15 meters per second (m/s). The intake velocity may be about 0.5 meters per second. The water intake velocity may depend on the diameter of the one or more water inlets. In an embodiment, the inlet velocity may be prescribed by the environmental agencies (e.g., Environmental Protection Agency). In certain embodiments, the center of the inlet may be located at a height of ⅓ of the depth of a body of water above the bottom of the body of water. The height of the inlet above the bottom of the body of water may be selected to reduce the amount of sand ingress into the water intake system. The height of the inlet may be selected to substantially reduce the impact of the water intake system on marine species. In some embodiments, the height of the water inlet may be positioned at a distance of greater than about 5 meters from the bottom of the body of water. For example, in some embodiments, a water-receiving end of at least one water inlet conduit may be positioned at a distance of greater than about 5 meters from the bottom of the body of water.

The one or more water inlets may be at different heights and locations. In some embodiments, the height and location of the one or more water inlets may be variable by utilizing, for example, but not limited to, one or more flange connections. Providing for a variable or flexible system for the one or more water inlets may help minimize the impact on marine life including, but not limited to, eggs, larvae, plankton, fisheries, and the like and combinations thereof. In some embodiments, the variable or flexible system for the one or more water inlets may be located on the structure and/or body of the structure, such as, but not limited to, when the one or more water inlets are located on the structure and/or body of the structure.

One or more screens may be positioned in water intake system. Screens may inhibit debris and/or marine life from entering inlet systems. In some embodiments, the mechanical effects of pump impellers in the water intake system may inhibit marine life from entering the system. The screens may be of different sizes and shapes.

Openings of inlets and/or outlets may be barred to prevent entry of large debris. The bars may have a cage configuration. Screens may include a wire mesh. The screen selected may comply with National Oceanic and Atmospheric Administration recommendations. In an embodiment, screens may prevent an ingress of marine life such as fish. In an embodiment, the screen may be environmentally sensitive. Screens may be designed to comply with environmental regulations. Screens may prevent marine life and/or sand from falling into the inlet or outlet.

Screens may be aquatic filter barriers as described in U.S. patent application Ser. No. 10/153,295, published as US 2003/0010704 A1, entitled “COOLING MAKEUP WATER INTAKE CARTRIDGE FILTER FOR INDUSTRY” to Claypoole et al., which is incorporated by reference as if fully set forth herein. Aquatic filter barriers may include sheets of fine polyethylene/polypropylene mesh fabric.

In some embodiments, wedge wire screens commercially available from Johnson Screens may be used. Wedge wire screens may be cylindrical filters made by winding wire around cylindrical support rods and forming a series of gaps between the wires.

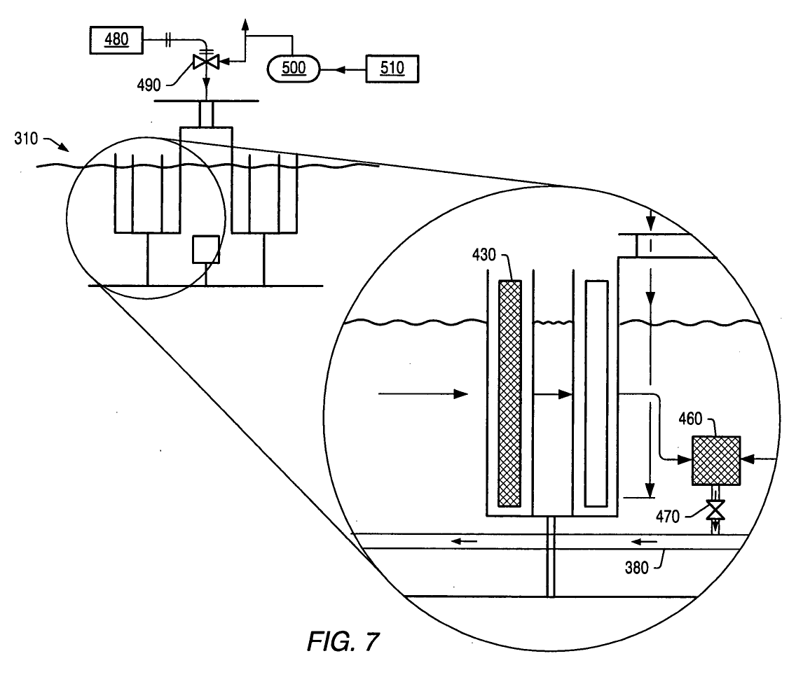

Screens may be a system of one or more vertical screens positioned around inlets and/or outlets. An embodiment of a water intake system with multiple screens is depicted in FIG. 7. One or more screens may be positioned horizontally, vertically, or at an angle in inlets of a water intake system. Water may flow through the screens 430 and into an inlet chamber 460. In an embodiment, all water processed by the screens 430 may flow into a common inlet chamber 460. Water may exit the inlet chamber 460 via a water conduit 380. The inlet may be positioned at a distance above a bottom of a body of water.

Screen systems may be periodically cleaned. Screens 430 may be cleaned in place. Valves 470 may isolate a water inlet 310 and screens may be cleaned. Cleaning may include compressed air dislodging debris from the screens. In an embodiment, inlet controller 480 may open an air valve 490 to release compressed air. Compressed air may enter the water inlet 310 and free debris and/or trapped marine life from the screens 430. A compressor 500 may be connected to the air valve 490 to provide compressed air. Air 510 may enter the compressor 500 and be compressed to a desired pressure. In an embodiment, compressed air may be provided from a pressurized canister. A similar system may be used to clean outlets.

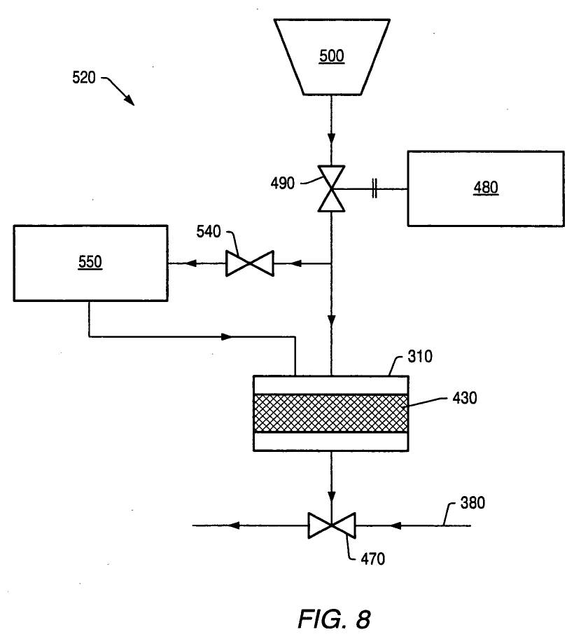

FIG. 8 depicts an embodiment of a pressurized screen cleaning system. Prior to activating a pressurized cleaning system 520, the inlet may be isolated. An inlet valve 470 may isolate the inlet 310 from the water inlet conduit 380. An inlet controller 480 may activate the pressurized screen cleaning system 520 and/or open the air valve 490. The pressurized screen cleaning system 520 may include cleaning the screens 430 with compressed air. Air may be pressurized by a compressor 500. The compressed air may flow into the water inlet 310 via the air valve 490. Pressurized air in the inlet may blast debris and/or marine life from the screens 430. In an embodiment, pressurized air may be stored in an air container. Compressed air may flow from the air container to the air valve, as needed.

In an embodiment, the pressurized cleaning system 520 may include cleaning screens 430 with pressurized water. The inlet controller 480 may open a hydroburst valve 540. Compressed air may flow through the air valve 490 and the hydroburst valve 540 to a water pressurizer 550. Pressurized water may enter the inlet 310 and loosen debris and marine life from screens 430. In an embodiment, an orifice and/or valve may pressurize water instead of compressed air. The pressurized cleaning system may also be used in outlets.

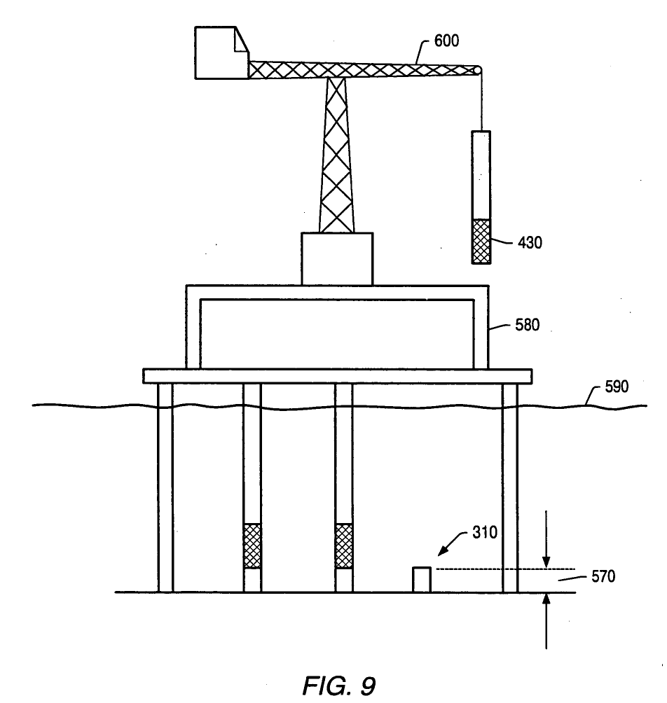

In some embodiments, screens may be removed from the intake or outlet system prior to cleaning as depicted, for example in FIG. 9. In an embodiment, openings in water inlet 310 may be positioned at a height 570 above a bottom of the body of water. Screens 430 may be positioned in the openings. A platform 580 above water inlets 310 and/or outlets may allow screens 430 to be lifted above water level 590 for maintenance. In some embodiments, one or more cranes 600 may be positioned above inlets 310 and/or outlets. The one or more cranes 600 may remove and/or position one or more screens 430 from the inlets and/or outlets. The cranes may facilitate cleaning and/or replacing screens. In some embodiments, the water intake system may comprise a compressed air source that may be coupled to one or more water intake cages. The compressed air source may be configured to supply compressed air to one or more water intake cages to clean filters disposed in the one or more water intake cages during use. In some embodiments, a crane may be coupled to one or more water intake cages. The crane may be configured to remove filters disposed in the one or more water intake cages for cleaning during use.

Water from the water intake systems may flow to a heat exchanger vaporization system. Heat exchangers may be used to vaporize LNG received from LNG carriers. In some embodiments, LNG from one or more storage tanks may flow to one or more heat exchangers, also referred to as heaters or vaporizers. The vaporized natural gas may be provided to one or more commercially available pipelines coupled to the LNG structure.

In certain embodiments, open rack vaporizers vaporize LNG. In some embodiments, submerged combustion vaporizers vaporize LNG. LNG may be pumped upwards through a parallel set of tubes, for example, a parallel, horizontal set of tubes, while water runs downward through the exterior of the tubes by gravity. The heat from the water may regassify the LNG. Heat transfer efficiency may be improved using fins. Fins may be positioned on the outer surfaces of the tubes, the inner surfaces of the tubes, and/or the inner surfaces of the outer shell. Water may be sprayed and/or cascaded on the tubes. Using a short inner tube at the LNG inlet of the tube bank to extend the initial heat transfer rate over a greater length of the tube, may reduce the chance of ice formation at the point where LNG enters the heat exchanger. In an embodiment, the operating pressure of the heat exchanger may rise and fall according to the pump curve of the HP(high pressure) pump.

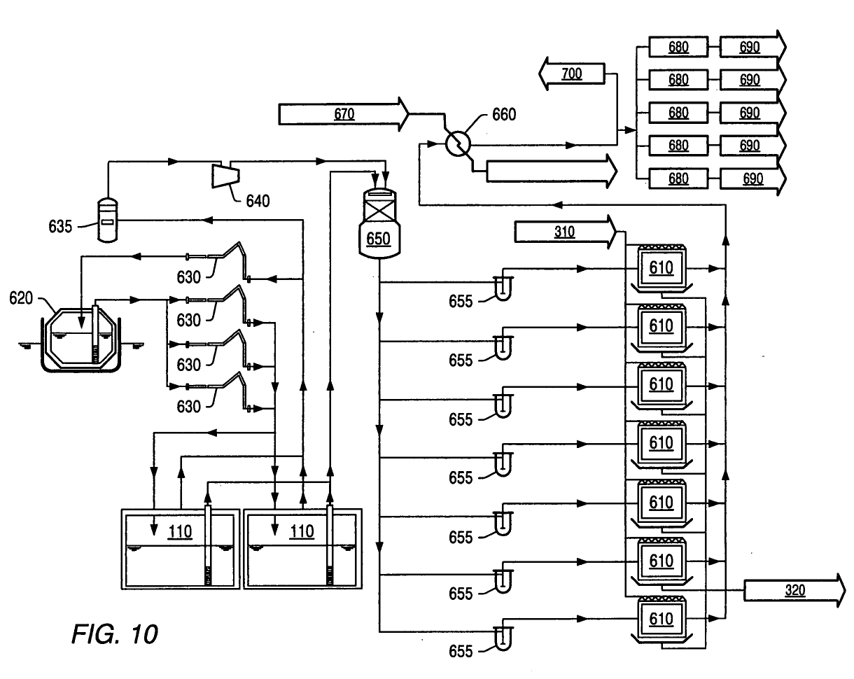

In some embodiments, LNG may be vaporized as schematically illustrated in FIG. 10. Heat exchangers 610 may be open rack vaporizers. Heat exchangers 610 may be submerged combustion vaporizers. In an embodiment, open rack vaporizers may be a cost-effective heat exchanger option. Water may be transferred from the water inlet 310 to the heat exchangers 610 to vaporize LNG. Water may then be released back into the body of water through the water outlet 320. LNG from a carrier 620 may be transferred to one or more storage tanks 110 via unloading arms 630. Some LNG may vaporize during unloading from a carrier 620. Some LNG may vaporize in the storage tanks 110. The vaporized LNG may be called boil-off gas (“BOG”).

Some BOG may be returned to the carrier 620 through one or more unloading arms 630. Returning BOG to the carrier 620 may be part of a vapor balance system. In addition to, or in lieu of, passing BOG to the carrier 620, BOG may also be compressed in a BOG compressor 640. The BOG may pass through a BOG compressor scrubber 635 before transfer to the BOG compressor 640. The BOG may pass through a BOG desuperheater (not shown) before entering the BOG compressor scrubber 635. Compressed BOG may be recondensed in a recondenser 650 and returned (not shown) to storage tanks 110 and/or transferred to heat exchangers 610. While not shown, in some embodiments compressed BOG and/or recondensed BOG, from the BOG desuperheater, BOG compressor scrubber 635, BOG compressor 640 and/or recondenser 650, may be transferred back to storage tanks 110 through separate drain lines and/or though valving and flow control of existing lines.

LNG may be pumped from storage tanks 110 to heat exchangers 610 to be vaporized. In some embodiments, LNG may be pumped, utilizing low pressure pumps (not shown) that may be in storage tanks 110, to recondenser 650 and then, utilizing pumps 655, preferably high pressure pumps, the LNG may be pumped to heat exchangers 610.

Vaporized LNG may be warmed in a heater 660 to inhibit hydrate formation. The heater 660 may use waste heat 670 to warm natural gas. Natural gas may enter export metering lines 680. Natural gas may be distributed from the export metering lines 680 to commercially available pipelines 690 coupled to the structure. Some natural gas may be used as fuel 700 on the structure. In some embodiments, vaporization equipment may be coupled to an upper surface of the body. The vaporization equipment may be configured to vaporize the LNG to natural gas during use. A water intake system may be configured to draw water from a body of water and supply water to the vaporization equipment.

In some embodiments, heat exchangers may be designed based on regasifying LNG at peak send-out rates and minimum heat transfer rates. The heat exchanger may inhibit no more than a predetermined change in temperature of the water. In an embodiment, a heat exchanger may allow at most a 10° C. drop in the temperature of water across the heat exchanger. The temperature drop of the water across the heat exchanger may be at least partially controlled by applicable codes. Environmental codes may regulate the temperature at which water may be released into a marine environment.

The amount of water flow required in the heat exchanger is related to the selected temperature drop across the heat exchanger. The amount of cold energy or cold thermal inertia returned to the sea may be the same if a smaller amount of water is returned at a lower temperature or a higher flow rate is returned at a slightly warmer temperature. In some embodiments, a larger temperature drop across the heat exchanger may cause ice formation in the water intake system. Smaller temperature drops across the heat exchanger for the water may be possible. In certain embodiments, warmer sea temperatures may permit a higher temperature drop across the heat exchanger and reduce the water flow rate.

The water intake system may ensure that water returned to the body of water from the heat exchanger does not exceed a desired lower temperature limit. In certain embodiments, the design of the water outlets may ensure that the temperature 100 m from the structure does not decrease by more than 3° C., as per World Bank Standards. The design of the water intake system may minimize cold-water recirculation between the outlets and the inlets. Water may be heated prior to re-release through the outlet system.

In some embodiments, the water intake system may release water from the structure to the body of water through one or more outlets. In an embodiment, a single point outlet system may be used. A diffuser with multiple outlets over a distance may also be used as an outlet system. A single point diffuser with vertical outlet openings may be utilized because of simplicity and cost. Screens may be positioned in the outlets. In an embodiment, bars across an opening may inhibit debris and/or large objects from entering the outlet system.

In an embodiment, an outlet may be a concrete box with vertical openings. The outlet may be approximately 4 m by about 4 m in horizontal plane and about 3 m high. The outlet opening may be substantially circular. Diameters of openings in the outlets may be selected based on the amount of mixing necessary. Environmental guidelines may regulate the amount of mixing required at outlets. Discharge velocity may also control the diameter of an opening in the outlet. The outlet may be coupled to the structure by an outlet conduit. The outlet conduit may be a Glass fiber Reinforced Plastic (GRP). Concrete and/or steel outlet conduits may also connect outlets with the structure.

An outlet may be positioned at least approximately 500 meters from an inlet. In certain embodiments, outlets and inlets may be separated such that cold water from the outlets does not substantially mix with ambient water proximate the inlets. Outlets may be positioned at a distance from the structure to accommodate a working boat and/or platform alongside the structure. In some embodiments, an end of at least one water outlet conduit may be positioned at a distance from the water intake system such that water exiting the water outlet conduit does not substantially effect the temperature of water entering the water intake system.

In some embodiments, no spare water outlet system may be constructed. A spare outlet system may not be required. If the water outlet system breaks down, water may be temporarily run directly over an edge of the structure. In an embodiment, a sluice gate may be opened below water level to release water from the structure if the water outlet system is offline.

In certain embodiments, flow controllers may regulate the natural gas send-out flow rates from the heat exchangers. Flow controllers may include a flow transmitter on the heat exchanger outlet and a control valve on the vaporizer inlet. If the gas outlet temperature or seawater exit temperature becomes excessively cold, the flow controller may be overridden. Regasification and send-out equipment may be designed for an average throughput of natural gas. In an-embodiment, regasification and send-out equipment may be designed for an average throughput of about 7.7 million ton per annum (mtpa) and a peak factor of about 1.2 billion cubic feet per day (2,400 m³/h LNG).

The LNG structure may be designed to permit a rapid start-up of the heat exchangers. Maintaining a small flow of LNG through a heat exchanger on standby may permit rapid start-ups. The use of thermal expansion joints that allow rapid cool down of the LNG inlet line may permit rapid start-ups. In an embodiment, a structure may have one or more spare heat exchangers, such that spare heat exchangers may be used during maintenance and/or repair of other heat exchangers.

In some embodiments, the structure may be designed to vaporize LNG delivered by LNG carriers and export natural gas into the existing pipeline network. The structure may have a capacity to offload and regassify at a peak export rate of about 1.2 bscf/day (2,400 m³/h LNG) to the gas network. The structure may be designed to have a nominal regassification rate of about 1.0 bscf/day (1,960 m³/h LNG). In an embodiment, the structure may be designed such that the peak regassification rate is expandable. The structure may have a peak sendout rate of about 1.8 bscf/day (3,600 m³/h LNG).

The structure may allow offloading from a range of LNG carrier sizes. The carriers may unload their cargo at cryogenic temperatures into the storage tanks contained within the structure. The structure may be designed to process a range of LNG compositions ranging from Nigeria High composition (Rich) and Venezuela composition (Lean). Custody transfer metering may occur on the structure prior to export into the pipeline network.

Natural gas exiting the heat exchangers may be metered into pipelines and flow to tie-in locations onshore. The reduction in pressure along the pipelines may produce a cooling effect. The cooling effect may only be partly compensated by heat ingress from the surrounding seawater. The send-out gas may be heated in order to mitigate the possibility of hydrate formation in the takeaway pipelines. In certain embodiments, as the gas enters the existing wet associated gas pipelines, it must be above about 21.1° C. (70° F.) to avoid hydrate formation. A spare sales gas heater may be installed to heat the send out gas. In an embodiment, demineralized hot water may heat send-out gas. The natural gas stream may be divided between the pipelines connected to the structure. In an embodiment, each pipeline may have its own pressure reduction station and two or more 10-inch ultrasonic custody transfer meters to accommodate the export flow rate.

In some embodiments, the structure may comprise an export metering system disposed on the body of the structure and coupled to the vaporization equipment. The export metering system may be configured to monitor the flow of produced natural gas from the structure to an on-shore location. In some embodiments, the structure may comprise a plurality of natural gas transfer pipelines coupled to the vaporization equipment. Each of the pipelines may be coupled to a separate on-shore natural gas pipeline system. Control of the transfer of natural gas through each of the pipelines may be performed using one or more controllers on the structure.

The gas from all the heat exchangers may be combined in one or more common sales gas headers. The natural gas exiting the heat exchangers may vary in temperature according to the LNG throughput and the seawater temperature. In an embodiment, the send-out gas exit temperature from the heat exchangers may be about 1° C. to about 22° C. The sendout gas from the structure must be in excess of about 35° C. (at the maximum pressure of 86 bar (gauge) upstream of the flow control valves) to prevent hydrate formation where the natural gas export lines tie into the wet associated gas pipelines. In an embodiment a maximum gas export temperature may be about 49° C. Gas export temperatures may be regulated by applicable codes. Gas temperature may be controlled using a hot water bypass control loop.

In some embodiments, the gas may be routed from the sales gas header to one or more superheaters. A spare superheater may be installed on the structure. In an embodiment, the superheaters may be of printed circuit type (PCHE). PCHE superheaters may be compact and/or stacked, as required. The superheaters may use tempered water from waste heat recovery units to warm natural gas. The superheaters may direct warm natural gas into one or more common sendout headers. The warmed send-out gas may then be metered to subsea export pipelines. The send-out gas may experience a pressure drop across the metering lines.

In some embodiments, natural gas may be heated by a tempered water system. Waste heat from a gas turbine power plant on the structure may be utilized as the primary heating source for the tempered water system. The waste heat recovery system may be able to discharge a surplus of waste heat as well as additionally heating within its operation window. A configuration using gas turbines with waste heat recovery units, equipped with a controlled flue gas by-pass system may assist the waste heat recovery system meet its output requirements. With this system the heat added to the tempered water system may be controlled by partial by-pass of the gas turbine flue gasses directly to the stack. In an embodiment, a tempered water system may be equipped with a gas fired auxiliary boiler to add heat to the system in case waste heat capacity of the power plant(s) is not sufficient.

In some embodiments, a structure may include a common header arrangement, also referred to as a common gas header arrangement. A common header arrangement may allow greater operational flexibility for send-out gas than using dedicated sendout trains for the export pipelines. While operational costs associated with providing dedicated sendout trains may be lower than with a common header configuration, the former configuration may necessitate a number of spare units to send-out availability. The common header arrangement may also permit greater opportunities for future expansion. Pipelines may be coupled to the structure, as needed. The use of a common header design may allow gas to be distributed among several pipelines. The gas may be distributed according to a price of natural gas in the region served by the pipeline. The pipeline capacities may be designed such that gas may be distributed among the pipelines in equal, nonequal, or proportional amounts. In some embodiments, the amount of natural gas passing through each pipeline may be varied based on the price of natural gas paid by an on-shore natural gas pipeline system.

Natural gas may be exported from the structure to markets for sale and/or further processing. The export gas may be distributed among the one or more pipelines in varying quantities. In an embodiment, at least five pipelines may be coupled to the structure. The structure may be configured such that additional pipelines may be coupled to the structure at a later date. Flow controllers may operate each send-out pipeline. Each pipeline may be coupled to a metering station consisting of two or more metering runs. Metering units may be 10″ ultrasonic custody transfer type. In an embodiment, one common spare metering unit may be available for calibration purposes. The number of metering runs required for each station may be determined by the maximum required export rate and the maximum permitted flow velocity through the metering run (e.g., 18.3 m/s or 60 ft/s). GC online analysis of the exported gas may be undertaken at the sales gas header.

In some embodiments, the structure may include facilities for on-site generation of sodium hypochlorite from seawater via electrolysis. The unit may be designed to allow continuous shock dosing by adding sodium hypochlorite into the system. The structure may include hydrogen degassing tanks, air blowers to vent hydrogen gas to a safe location, storage facilities, and/or sodium hypochlorite injection pumps. In an embodiment, the structure may produce nitrogen on board.

Fresh water may be needed on the structure. The structure may have water inlet lift pumps that supply seawater for the fresh and potable water systems. The seawater may enter the lift pumps through water intake system. Seawater may be strained through self-cleaning strainers. The pumps may feed the electro-chlorination unit and a desalination package. The desalination unit may include reverse osmosis units to produce fresh water from seawater. Fresh water may be stored in fresh water storage tanks. Potable water may be made from fresh water by a remineralization package. Potable water may be stored in potable water tanks. The potable water may be distributed on demand. Potable water systems may at least meet the World Health Organization's standard for potable water. The system may be designed to prevent contamination of the potable water system by using a break tank to prevent contamination of the potable water system from non-sterilized sources. Water in the line may be replenished with newly sterilized water by flushing connections and/or long runs of piping.

In some embodiments, a structure may include a relief system. The relief system may include relief headers, lit flare headers, and/or emergency vent headers (low pressure and high pressure vents). Flare headers connected to the tank vapor space, balance line, and/or depressuring lines may operate during tank cool down, overpressure scenarios, and/or in hurricane situations where the structure will be de-manned and the vaporization process stopped. In an embodiment, a self-igniting flare may be provided to safely dispose of emergency hydrocarbon releases. A majority of the process relief valves may be routed to the flare. The flare system may detect a release of emissions and self-ignite when required. The ignitable flare concept may minimize the overall greenhouse gas emissions to the atmosphere by the flare. In an embodiment, under normal operating conditions, the flare system may rarely flare. BOG may be recondensed to LNG and routed to high-pressure LNG pumps. The vent stack may be located on the structure. Vents may be connected to the atmosphere. An emergency vent header may include tank pressure relief valves. The vent stack may be designed to accommodate all relief loads from the tank and/or may be used during flare maintenance.

In certain embodiments, a flare system may be used to limit pressure within the tanks. The low-pressure BOG header may be connected to the flare system via a pressure control valve to relieve excessive pressures. A flare header may collect vapors from most of the process equipment relief valves and depressuring valves via a high-pressure system. The flare may be retractable. A retractable flare may allow dismantling of the stack for flare tip maintenance. Hydrocarbon emissions may be temporarily directed to the vent stack during flare maintenance, severe tank rollover, and/or if the flare is offline. In an embodiment, hydrocarbon relief is normally routed to a closed relief system for disposal to a self-igniting flare. The vent and flare stacks may be located proximate each other. The flare may be located proximate a corner of the structure. In an embodiment, the vent and flare stacks may have similar heights to prevent damage from accidental ignition.

The flare may be self-igniting type and may automatically ignite the pilot when gas flow is detected. Opening of the BOG header pressure control valve may also ignite the pilot. The use of self-igniting pilots may minimize atmospheric emissions by eliminating a continuous fuel gas flow. Self-igniting pilots may allow ignition of large hydrocarbon emissions, if they occur. The flare may be used for LNG tank commissioning to eliminate the emission of hydrocarbon vapor to atmosphere.

In some embodiments, a vent system may be used as a discharge for the storage tank pressure sensitive valves. Due to the nature of the structure, and the confined environment, the tank pressure sensitive valves may be sized to accommodate various foreseen relief loads (e.g., rollover) from the storage tanks. The pressure sensitive valves may discharge into the vent header to permit dispersion.

Thermal safety valves may flow to the vapor balance header in order to minimize the fugitive emissions from the structure. The flow rate of the thermally safety valves may be small enough to be accommodated by the storage tank and BOG compressor systems.

During severe weather, the terminal may be abandoned and LNG unloading and regasification operations may cease. The pressure within the storage tanks may increase and BOG may need to be flared in the event of a prolonged shutdown. The tank overpressure relief valves may discharge directly to the vent stack. The vent stack may be designed to accommodate all expected relief loads from the storage tanks, including rollover.

The relief valves from the heat exchangers may be collected into a common high-pressure relief header for further direction to a relief system. Thermal relief valves may relieve back to the vapor balance line. Pressure safety valves may be connected to the flare relief header. Vaporizer pressure relief valves may discharge directly into the atmosphere.

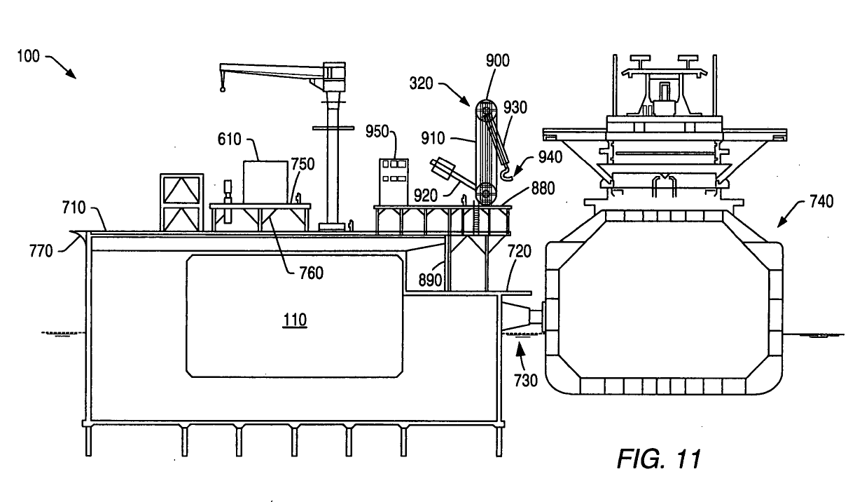

An offshore LNG receiving and storage structure may accommodate LNG storage tanks, allow LNG vaporization plant and other process equipment and utilities to be positioned on the upper surface of the structure, and safely enable LNG carriers to berth directly alongside the structure. An embodiment of the LNG structure is depicted in FIG. 11. The structure 100 may include a first upper surface 710 with LNG transfer equipment 320. The structure 100 may also include a second upper surface 720 below the first upper surface 710. The second upper surface 720 may include docking equipment 730. Docking equipment 730 may couple a liquefied natural gas carrier 740 with the structure 100. The structure 100 may allow a carrier 740 to dock on one or more sides of the structure. In an embodiment, docking equipment 730 may be positioned on both lateral sides of the structure 100, in an embodiment. A “buffer belt” around a periphery of a LNG tank may provide protection for the tank against carrier impact.

The top slab level of the structure 100 may be determined by structural stiffness requirements and consideration of the LNG tank 110 dimensions. Topsides 750 of the structure 100 may be constructed and/or integrated in a dry dock prior to positioning the structure in a body of water. In an embodiment, the structure topsides 750 may be elevated on about 5 m high steel module support frames 760. Structure topsides 750 may be elevated for ease of construction. Elevating the topsides 750 of the structure 100 may also allow water to run over the deck 710 under severe weather conditions without substantially submerging equipment, such as heat exchangers 610 and LNG transfer equipment 320, on the topsides. Structure topsides may be elevated for ease of construction.

The structure may be designed to accommodate severe weather conditions such as hurricanes, tropical depressions, tsunamis, tidal waves, and/or electrical storms. During severe weather conditions, large waves may impact the structure and green water may flow over a deck of the structure. At least about one meter of water present on a horizontal face of the structure may be classified as “green water.” In certain embodiments, the degree a wave overtops a surface of the structure may be substantially reduced. Raising the structure deck level 710, constructing a wave wall, constructing a wave deflector 770, and/or raising topsides 750 on steel modules 760 above green water may decrease the risk of damage to the structure 100 by overtopping waves.

When sea waves hit the vertical walls of the structure, a standing wave may be formed in front of the structure due to wave energy reflection. Non-linear effects such as wave breaking and interaction of incoming and reflected waves may result in a large vertical jet being formed in front of the structure. The topsides of the structure may be at risk to the standing waves. The structure design may be influenced by the possibility of greenwater traveling at a high velocity over the deck. During hurricane conditions with strong winds, most of the water in the vertical water jet may blow over the deck. A wave deflector on the structure may be effective in reducing the amount of overtopping water. The higher the deflector is located above the water level, the more effective it is in deflecting only the vertical jet, as opposed to the entire incoming wave.

Wave deflectors may have a flat vertical face. In some embodiments, wave deflectors have a substantially curved face. A curved steel wave deflector about 2.5 wide and about 3.5 m high may be installed. The wave deflector may have an indented or notched shape. The wave deflector may be installed over a full length of the structure. The wave deflector may only be installed only on the side of the structure most likely impacted by waves. In an embodiment, the structure may include wave deflectors on the exposed sides of the structure.

The structures may additionally include steel modules that raise the topsides equipment above the deck level. Modules may be positioned at a height above the deck to reduce damage from overtopping waves and/or green: water. Excessive wave run-up and passage of green water onto the terminal deck during hurricane conditions may be minimized by the installation of a curved steel wave deflector along one or more exposed sides of the structure.

In some embodiments, the structure may include docking, also referred to as mooring, equipment on one or more sides of the structure. The structure may include one dock. Berthing facilities, dolphins, fenders, and/or cryogenic unloading arms may allow bi-directional berthing of carriers directly alongside the structure. Approximately 15% of the time, the predominant current switches directions (e.g., a southwest current may switch to a northeast current). Allowing a structure to berth in either direction (i.e., bi-directional berthing) may increase the efficiency of the structure.

In some embodiments, the structure may be positioned substantially parallel to the direction of the predominant current. Ship-shore interfaces may be such that carriers can berth and offload directly alongside the structure. In an embodiment, docking directly on the structure may avoid the construction of separate berthing and offloading structures. A structure may be configured to allow a carrier to approach the structure without substantially damaging the structure. An LNG carrier may approach the structure with the help of one or more tugboats.

In an embodiment, an LNG carrier may dock such that the structure substantially protects the carrier from waves. The structure may be configured to provide a breakwater length for a carrier. When a carrier docks directly on the structure, the carrier may be at least partially protected from waves that impact the structure rather than the carrier. In certain embodiments, units may be positioned in order to provide adequate breakwater length for LNG carriers.

In some embodiments, the structure may be constructed in a graving dock location prior to towing and/or floating the structure to a desired location for operation. A purpose-built graving dock may be created to build the structure. In some embodiments, the units may be constructed in parallel in a purpose-built dry dock. After construction, the structure may be towed out of the graving yard and positioned in the body of water.

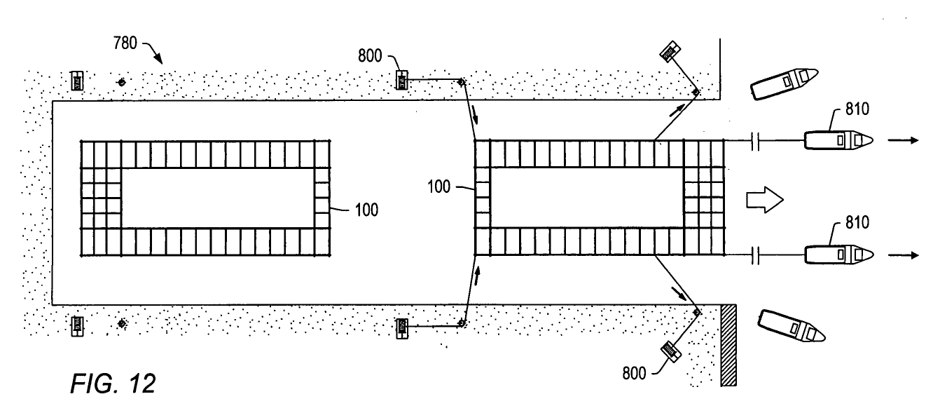

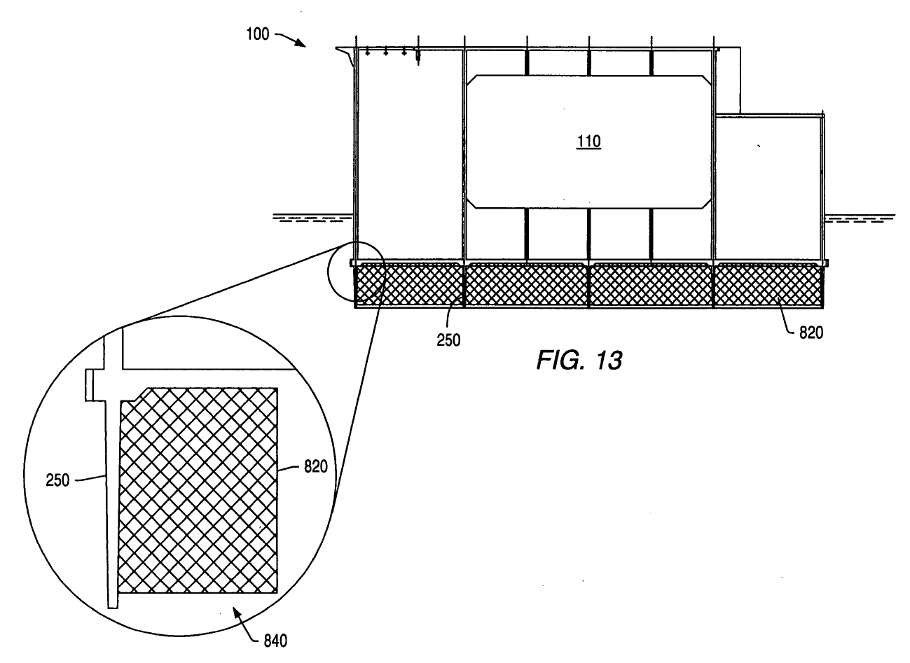

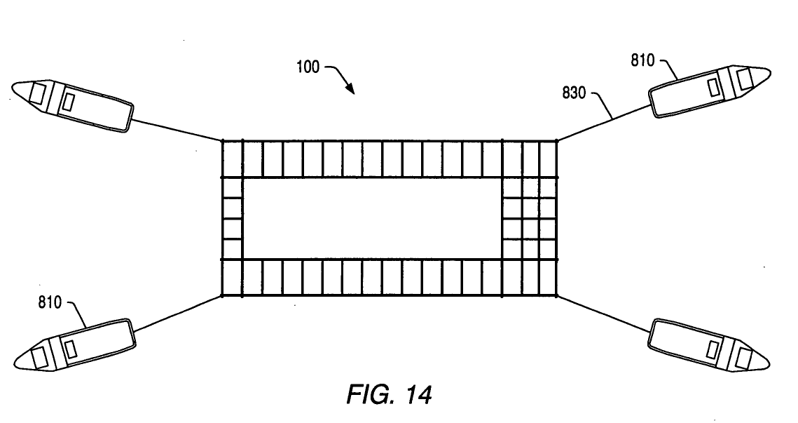

FIGS. 12-16 depict embodiments of an offshore LNG structure installation. Prior to installation of the structure 100, the graving dock location 780 may be flooded. Upon flooding the graving dry dock 780, the structure 100 may float above a bottom of a body of water. In an embodiment, an air cushion 820 may be used to float the structure 100 as depicted in FIG. 13. Alignment markers 800 may facilitate positioning the structure 100 in the graving dock 780. One or more tugboats 810 may tow the structure out of the graving dock as depicted in FIG. 12. Air may be injected below the projections 250 of the structure 100 to at least partially facilitate floating of the structure. The structure 100 may be moved away from dry dock by means of fixed winches, hauling lines 830, and/or one or more tug boats 810, as depicted in FIG. 14. The tugboats may be bollard pull tugs. In order to reduce the draft, the structure may be towed with an air cushion.

An air cushion 820 may include a water seal 840 for out of dock operations until the structure 100 has arrived at the holding area outside the dock, as depicted in FIG. 13. An air cushion may be configured to increase the under keel clearance of the structure to facilitate floating. In certain embodiments, offshore tow may start when the water depth is sufficient to deflate the air cushion while maintaining the ability of the structure to float. The height of the air cushion may be selected to achieve a desired average water seal within the projection compartments.

In some embodiments, tugboats may tow the structure across a harbor. The tugboats may pull the structure across a channel into an open body of water. In an embodiment, about 1.8 m to about 2 m under keel clearance is maintained below the structure. To maintain a sufficient under keel clearance, an air cushion with an average water seal of about 0.5 m may remain under the structure. Using an air cushion may reduce the structure draft to about 11.7 m.

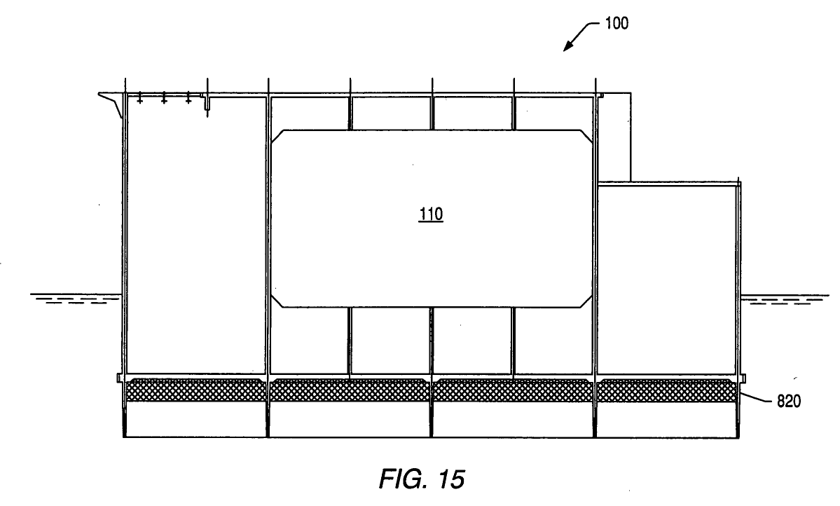

Towing the structure to an offshore location may require four or more tug boats. In some embodiments, the air cushion 820 below the structure 100 is gradually released as soon as the water depth is sufficient, as depicted in FIG. 15.

Upon arrival of the structure 100 at the desired site, the air cushion 820 may be at least partly re-installed. The air cushion may be approximately 1 m thick or greater to achieve sufficient under keel clearance for final positioning.

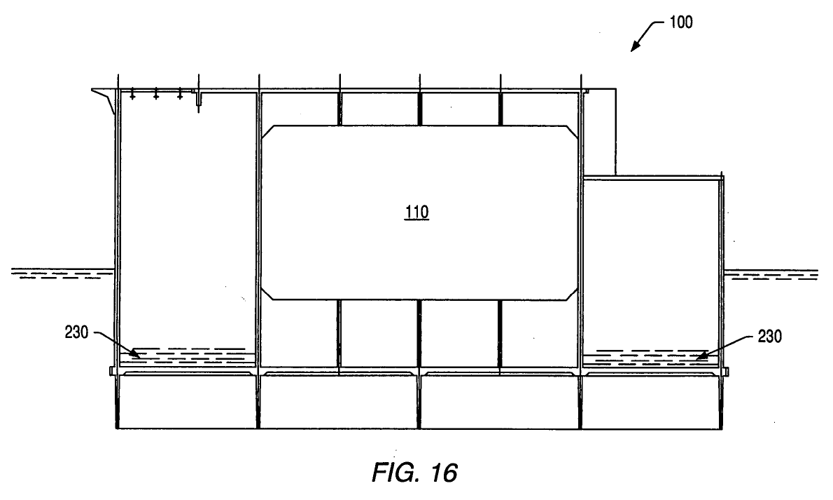

While keeping the structure at approximately its final location, the structure 100 may be lowered using water ballasting 230 as depicted in FIG. 16. In some embodiments, after the structure contacts a bottom of the body of water, the air cushion is deflated. In an embodiment, liquid, such as water, is placed in ballasts until the structure at least partially contacts the bottom of the body of water. In some embodiments, liquid-, such as water-, ballasting operations may continue until at least a selected penetration depth is achieved. In some embodiments, the structure may be considered ‘storm-safe’ for the design hurricane after liquid, such as water, ballasting. The amount of ballast material added to ballast storage areas may be sufficient to overcome the average expected penetration resistance.

If penetration to the extent desired has not been achieved upon completion of liquid, such as water, ballasting, suction in the projection compartments may be used. Air trapped in projection compartments may be removed and the projections may further penetrate a bottom of a body of water. Suction in projection compartments may take place via piping installed for use with the air cushions. The air cushion may facilitate projection penetration.

In certain embodiments, it may be desirable to decommission an LNG structure. In an embodiment, a structure may be reused. At the end of an operating life of a structure, the structure may be removed from the site to be reused or completely decommissioned. The equipment on the structure may be decommissioned prior to removal of the structure. The structure may be refloated at the end of its operational life. Upon refloating, the structure may be towed to a desired onshore location. In an embodiment, the structure may be refloated to a different offshore location.

In some embodiments, decommissioning may include performing the marine installation in reverse. Refloating the structure may be a part of decommissioning the structure. First a weight of a structure may be reduced by deballasting ballast storage areas filled with ballast material. Deballasting may only occur to the extent necessary to achieve buoyancy for towing. The structure may be lifted off a bottom of a body of water by injecting water below the bottom slab. Decommissioning a structure may require extraction of projections from a bottom of a body of water. A body of water may be surveyed after towing the structure from the site. The bottom of a body of water may be cleaned after removal of the structure from the site.

In some embodiments, worldwide guidelines may at least partially govern under keel clearance and air cushion design. In some embodiments, under keel clearance in the dry dock may be greater than 0.5 m, after corrections of possible deflections of the structure, tow-line pull, wind heeling, squat effects, and/or variations in seawater density. An under keel clearance less than about 0.5 m may not be desirable during dry dock. During a design phase of the structure, an under keel clearance of at least about 1 m may be recommended. In areas outside the dock, the structure may require a greater under keel clearance. In an embodiment, under keel clearance when the structure is in an area outside the dock may not be less than the lesser of about 2 m or about 10% of the maximum draft. In an embodiment, for offshore tow, a minimum under keel clearance of about 5 m may be required.

Steel caissons may be used to provide temporary buoyancy during transportation and installation. Temporary buoyancy may be conventionally used in relatively benign inshore and nearshore conditions. Steel caissons may be coupled to the structure and used to increase the buoyancy of the structure.

An LNG carrier may be berthed directly on the structure. The structure may be oriented in the substantially same direction as the predominant current. In some embodiments, the berthing may occur some distance from the structure using berthing dolphins. The structure may be configured to have a breakwater function for carriers docked directly on the structure. In certain embodiments, the structure may include docking equipment configured to allow carriers to dock directly on the structure. The structure 100 may include a first surface 710 where process equipment 610 is located, as depicted in FIG. 11. The structure 100 may have a second surface 720, below the first surface 710, configured to ease docking with a carrier 740. The second surface 720 may be at a height similar to the carrier 740. Docking equipment may be positioned on the second surface 720.

The structure may be configured to allow carriers with capacities greater than approximately 125,000 cubic meters to dock. Docking equipment may be approximately 8 m from the structure wall. In some embodiments, no purpose built mooring dolphins and/or breasting dolphins may be required. Navigation beacons may be positioned on the structure. Mooring dolphins to facilitate docking larger carriers or to allow bi-directional docking of carrier may be positioned proximate to the structure. Corner protection piles may be also be installed proximate the structure.

In some embodiments, the first and second upper surfaces are above the surface of a body of water. The height of the second upper surface above the surface of the body of water may be such that an angle of mooring lines extending from the docking equipment to the liquefied natural gas carrier coupled to the body is less than about 30 degrees. In some embodiments, one or more fenders may be positioned about a perimeter of the body. The one or more fenders may be configured to absorb a substantial portion of a load from an LNG carrier colliding with the one or more fenders. In some embodiments, the structure may be positioned in a body of water such that the longitudinal axis of the structure is substantially aligned with the predominant current direction. In some embodiments, the body has a length that is at least equal to a length required to provide sufficient berthing alongside the body for a liquefied natural gas carrier having a liquefied natural gas capacity of greater than about 100,000 cubic meters.

In some embodiments, one or more docking platforms may be positioned in the body of water proximate to the body. The one or more docking platforms may comprise docking equipment. The one or more docking platforms may be positioned in the body of water such that liquefied natural gas carriers can dock with the body in different orientations. In some embodiments, the docking equipment may be positioned on the body such that an angle of mooring lines extending from the docking equipment to the liquefied natural gas carrier coupled to the body is less than about 30 degrees.

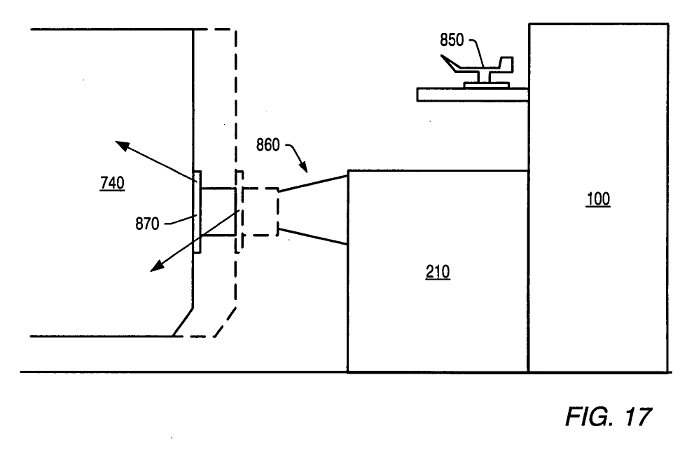

Mooring lines may lead directly from the carrier fairleads to the mooring hooks 850 on the structure 100, as depicted in FIG. 17. Mooring lines may be designed to comply with OCIMF guidelines. In an embodiment, mooring line load forces may be kept below 55% of the Minimum Breaking Load. Increasing mooring line length by leading lines through fairleads on the structure to remote Quick Release Hooks (QRH) may cause chafing. In some embodiments, mooring line flexibility is in the nylon tail pennant. Increasing a length of the mooring line may not have a substantial impact on a moored ship's operability. Lengthening mooring lines may only improve mooring operability by about 10%.

Monitoring systems may be in place at the berth to detect vessel speed of approach carriers; mooring line loads through strain gauges on QRHs; and/or pressure monitoring system in air block fenders. Data from the monitoring systems may be centrally collected and displayed in a control room.

The centerline of the unloading arms may be positioned to create a maximum degree of protection for all types of common LNG carriers. In an embodiment, the unloading arms may be positioned such that additional dolphins and/or jackets next to the structure are not necessary for docking.

When berthed alongside a structure, the stern of some LNG carriers may extend beyond an end of the structure. Additional mooring dolphins may be positioned proximate an end of the structure to protect a portion of the LNG carrier that extends beyond the structure. “Overhang” may depend on the manifold eccentricity of the various LNG carrier designs. Overhang of the ship's stern beyond the structure may also expose the ship to the environmental conditions.

A mooring line length of at least about 15 meters between the outermost compressed fender line and the QRH may ensure the nylon pennant and joining shackle are clear of the ship's fairlead and not subjected to chafing. In an embodiment, the minimum safe working load of each mooring hook may be more than the minimum-breaking load of the strongest mooring line anticipated. In some embodiments, the operational mooring line may not exceed the greater of 2.5 times the winch brake holding capacity or 2500 KN. The extreme mooring load may not exceed the greater of 2.5 times the minimum breaking load line or 3125 KN. The capstan barrel may be at a suitable height to permit safe handling of messenger lines. The QRH-assembly may be electrically isolated from the platform decks. The isolation may provide an electrical resistance of at least about 1 mega-Ohm.

QRHs may be positioned on the structure. QRHs 850 may be located on concrete platforms, as depicted in FIG. 17. The concrete platforms may be attached to a wall of a tank or the structure. In addition to, or in lieu of, concrete platforms, support structures, also referred to as mooring substructures, may be located or positioned directly on the structure or body of the structure for supporting docking or mooring equipment such as QRHs. In some embodiments, the concrete platforms and/or mooring substructures may be located on an upper surface of the structure and/or body of the structure. In some embodiments, the concrete platforms and/or mooring substructures may be located on a second upper surface where the upper surface of the structure and/or body of the structure comprises a first upper surface above a second upper surface. One or more mooring points may be positioned on a dolphin. In some embodiments, substantially all of the mooring points may be positioned on the structure.

The mooring lines may lead directly from the vessel fairleads to the QRHs on the structure. The optimum height of the QRHs may be about 13.0 m above the deck. Platforms may be located on ballast tanks. Each platform may be equipped with a triple quick release hook to receive the breast, stern and/or headlines. QRHs may be located on the platform so that the mooring lines may not coincide with the concrete structure. Decks may have rounded edges in front of the mooring hooks to prevent chafing of the mooring lines. The platforms may be accessible from both the top of the structure and the roof of the ballast tanks by means of caged ladders. The caged ladders may be positioned on the rear side of the QRH assembly to prevent stumbling in the vicinity of moored lines.

In some embodiments, one mooring point may be positioned on a separate mooring dolphin off the structure. The QRH may be mounted on a pedestal of the mooring dolphin. In some embodiments, one or more mooring points may be positioned on separate mooring dolphins off the structure. One or more QRHs may be mounted on the pedestals of the mooring dolphins. The main structure of the mooring dolphin may consist of two vertical steel piles spaced 10 m center-to-center and interconnected by means of a horizontal steel beam. A mooring dolphin may be located at least about 20 meters from the structure. A catwalk may connect the structure and the mooring dolphin.

The distance between tank wall and berthing line may be selected to insure a sufficient mooring line length. Fender support structures 860 may be used between ballast storage areas 210 and fenders 870 to ensure a sufficient mooring line length, as depicted in FIG. 17, between the structure 100 and the LNG carrier 740. The dotted lines in FIG. 17 indicate a compression of fender 870. The face of fender 870 may be compressed by the mass of the LNG carrier 740. Insufficient mooring line length may cause large variations in horizontal line angles for the various vessels. A relatively large number of QRH assemblies may be required to minimize angle variations. Insufficient mooring line length may cause large variations in vertical plane. Although tidal variations, draft variations, and “manifold above waterline variations” are relatively small, insufficient length distance may trigger difficulties in designing acceptable mooring line geometry. QRH levels for the ship's forward mooring lines may be different than the stern mooring lines, due to height difference among LNG carriers. In an embodiment, all QRH assemblies are at the same level. A larger gap between the QRH and outer fender line increases line length and may be favorable. In an embodiment, fender support structures may not be necessary to increase mooring line length.

In some embodiments, docking equipment may include breasting lines and/or spring line mooring points to facilitate docking. The mooring points may include QRHs. Berthing may require specific angles between the mooring points and the carriers. Breasting line mooring points may be positioned predominantly on the structure. Spring line mooring points may be located on the fender support structures. Spring line mooring points may be substantially parallel to the berthing line. In an embodiment, spring line mooring points may be positioned on the roofs of ballast tanks.

Fenders may be placed on a 5 meter wide support structure to ensure sufficient distance between the berthing line and the QRHs on the structure. In some embodiments, at least six fenders may be used on the structure. In some embodiments, the number of fenders used on a structure may be the number sufficient to substantially avoid contact between the carrier and the structure. The fender support structure may be constructed from concrete and/or steel. In some embodiments, fender support may be a steel conical type structure. The fender support may be connected to the structure by welding it to steel plates that are pre-cast in the structure concrete outer wall. In some embodiments, one or more fenders may be positioned about a perimeter of the body. In some embodiments, one or more fenders may be configured to absorb a substantial portion of a load from a carrier colliding with the fender.

The fender may have a substantially round, substantially oval, substantially square, substantially rectangular, or substantially irregular cross-section. The fender may be an air block fender. The air block fender may be made of rubber. The type of fender used may be based on the absolute energy absorption capacity, reaction force, and material stiffness. In an embodiment, the fender may be a floating pneumatic Yokohama fender. A softer fender may increase the flexibility of the mooring system. A soft fender system may reduce the resultant line forces significantly and may have an effect on the operability of the moored ship. The fender may be able to transfer a friction force of not less than the product of the catalogued fender reaction force at ultimate deflection and a specified design friction coefficient.

Corner protection on the structure may be used to avoid substantial damage from ship impact. During a final approach and berthing operations, the carrier may be guided by tugboats. In order to reduce the risk of damage to the structure, two corner protection devices may be used. The corner protection system may be an integrated system in the structure. In an embodiment, the corner protection system may be freestanding. The corner protection system may be freestanding flexible steel dolphins. If a freestanding pile is hit, there may be no impact on the structure. Piles may be easy to replace and/or repair without interfering with the structure. Additional piles may be more cost effective than constructing a steel space framework. Steel corner protection piles may absorb the accidental impact energy of a typical LNG carrier sailing at about 2 knots, substantially parallel to the berthing line. The piles may be capable of plastic deformation. The piles may be located at least about 7 meters off the structure.

Structure 100 may include an unloading platform 880, depicted in FIG. 11. The unloading platform 880 elevation may be at a predetermined height 890 above a top surface of the body of water. The unloading platform may be made of concrete. An edge of the platform may protrude over the side of the structure. The unloading platform 880 may support LNG transfer equipment 320. The LNG transfer equipment 320 may offload LNG from an LNG carrier 740.

The LNG transfer equipment 320 may include unloading arms 900, also referred to as loading arms. Unloading arms may be Chiksan unloading arms available from FMC Energy Systems. The LNG transfer equipment may include power packs, controls, piping and piping manifolds, protection for the piping from mechanical damage, ship/shore access gangway with an operation cubicle, gas detection, fire detection, telecommunications capabilities, space for maintenance, Emergency Release Systems (ERS), Quick Connect/Disconnect Couplers (QCDC), monitoring systems, and/or drainage systems.

In some embodiments, LNG may be transferred from an LNG carrier to the LNG storage tanks by means of one or more unloading arms, for example, but not limited to, swivel joint unloading arms. The unloading arms may be used for unloading the LNG. One or more unloading arms may be used for returning vapor displaced in the storage tanks back to an LNG carrier. In an embodiment, unloading arms may be used for either liquid or vapor service, as required, allowing maintenance of any of the unloading arms. Between unloading operations, the unloading system may be kept cold by re-circulation of a small quantity of LNG.

The LNG unloading arms 900, depicted in FIG. 11, may include a fixed vertical riser 910 and two mobile sections, the inboard arm 920 and the outboard arm 930. A flange 940 for connection to a carrier 740 may be positioned proximate an end of the outboard arm 930. Swivel joints may enable the arms and the connecting flange to move freely in all directions. The length of the unloading arm may be designed to accommodate different LNG carrier sizes. Unloading arm length may accommodate the elevation change between a fully laden and an empty LNG carrier, the movement of the ship due to tides and longitudinal and transfer drift, and the elevation of the structure. In an embodiment, the design of an unloading arm may be optimized. A length of an unloading arm may be optimized. Unloading arms may be located proximate a center of the structure. In some embodiments, there may be one or more fixed vertical risers and mobile sections depending on the number of LNG unloading arms.

Unloading arms may be equipped with an emergency release system. When the connecting flange reaches the limit of its operating envelope, an alarm may sound, the cargo pumps may shut down, and the unloading arm valves may close. Automatic disconnection of the unloading arms from the ship manifold may then occur. The arms will normally be operated from a control panel in a cabinet or control room located on the structure (see 950 in FIG. 11) proximate the arms.

Commonly available, traditional, hard unloading arms may be used. The maximum allowable pressure drop and the liquid velocity restrictions related to unloading arm vibration and cavitation may determine a minimum unloading arm diameter. The number of unloading arms positioned on the structure may be the number necessary to provide a desired maximum liquid loading rate. A vapor return unloading arm may be used to return BOG to the carrier during unloading. An extra unloading arm may be positioned on the structure for use as an unloading arm or a vapor return for ease of maintenance and/or repair. In an embodiment, an unloading rate may be reduced to approximately 50% to 60% of the design capacity when one or more unloading arms are being repaired or replaced. In some embodiments, the LNG may be recirculated through unloading arms to regulate temperature when the unloading arms are not in operation. When unloading is substantially complete, nitrogen gas may be used to force LNG from the unloading arms back into the carrier and into the storage tanks via drain lines. In an embodiment, a piping layout may be sloped to allow LNG to drain into the storage tanks without the use of a drain drum.

Although a three-unloading arm concept may be technically acceptable, a four-unloading arm concept may have more redundancy. Redundancy may increase the integrity and/or reliability level. The spare unloading arm may be used on a day-to-day basis. This may safeguard the proper functioning of the equipment. Therefore, the installation of one or more spare unloading arms may increase the normal overall LNG loading capacity.

The design of the structure may account for severe weather conditions. To decrease the environmental impact on the slender and flexible unloading arms, the unloading arms may be put in “hurricane resting position” when hurricane conditions are expected. In hurricane resting position, the unloading arm riser may remain vertical but the inner and outer arm will be tied-back horizontally. In some embodiments, a support frame may be positioned behind unloading arms, to secure the horizontal part of the unloading arm by an extra fixation point. In some embodiments, at least a portion of the unloading arms may be positioned in a substantially horizontal position during storage of the unloading arms.

In some embodiments, LNG may be unloaded through an unloading line and recirculation line. Once the unloading arms have been sufficiently cooled, an LNG pumping rate may be gradually increased until the design flow is attained. A high unloading rate may facilitate a quick turnaround time of the LNG carriers and provide operational flexibility. The unloading arm package may consist of three reduced-bore liquid unloading arms and one vapor return arm. One of the liquid arms may be a hybrid design to allow vapor return, in the event of vapor arm maintenance. In an embodiment, during the periods between offloading LNG carriers, a small side-stream of LNG may be recirculated through the recirculation line to the unloading manifold to maintain cryogenic pipework temperatures. Regulating a temperature of the unloading arm may reduce the time required for pipework cooldown during unloading.

The tank operating pressure during the unloading operation may rise to minimize vapor generation due to heat ingress. The vapor displaced during the unloading process may be returned to the LNG carrier using the pressure differential between the storage tanks and the carrier. A return gas blower may not be required due to the short tank to carrier distance, in some embodiments.

The unloading pipework may slope continuously down to the tanks. In an embodiment, the unloading piping system may continuously slope down to at least one tank. Sloping the pipelines towards the tanks may eliminate a need for a ‘Jetty’ drain drum and associated lines. Pressure control may be used to maintain the LNG unloading line under pressure and to control the unloading flow. Regulation of the pressure may be necessary to prevent tank overpressure and/or vibration within the unloading line.

In some embodiments, a significant topside inventory of LNG on the structure may be held in the recondenser vessel and pump suction header. The recondenser and HP pump suction header may remain liquid-full during normal plant operation. In the event of zero sendout from the structure (e.g. hurricane scenario), the recondenser vessel and the header may remain liquid full to allow the line to remain at cryogenic temperatures. In the event of an emergency situation, (e.g. direct hurricane impact on structure or fire on the structure), an emergency function to drain the recondenser and suction line may be provided. Drainage of the system may be by gravity flow back into the tank underneath the recondenser. Residual pressure within the system may at least partially assist the gravity flow back to the tanks. After drainage, the remaining LNG inventory within the process equipment may be insignificant.

The structure may include one or more emergency safety systems. In an embodiment, emergency safety systems may be designed to comply with acceptable industry codes. During operation of the emergency system, several structure operations may be shut down. The LNG unloading operation may cease in a quick, safe, and controlled manner by closing the isolation valves on the unloading and tank fill lines and stopping the cargo pumps of the LNG carrier. The emergency operations may be controlled on the LNG carrier or from the structure via a ship-to-shore interface. Emergency controls may be manual (e.g., buttons in strategic locations), automatically (via the appropriate alarms signals received from the transfer facilities), or by rupture of the ship-to-shore link. Emergency systems may be designed to allow LNG transfer to be restarted with minimum delay after corrective action has been taken.

The second stage emergency shutdown system may activate the unloading arm emergency release system (ERS) and cause the unloading arms to disconnect from the ship. “Dry break” uncoupling may be achieved by ensuring the closure of two isolation valves, one directly upstream and one directly downstream of the emergency release coupler prior to the uncoupling action. In some embodiments, unloading arm uncoupling may occur as quickly as possible. As the piping systems for the LNG carrier and the structure are relatively short, loading arm ERS valve closure times of 5 seconds may not give rise to surge pressures exceeding the design pressure of the piping systems.

The export shutdown may be activated by manual initiation. The emergency system may stop and isolate all pumps and compressors, isolate the heat exchangers and superheaters, and/or close various valves. Activation of the export shutdown, ERS, may stop and isolate the gas export equipment in a safe, sequential manner. The emergency system may initiate draining of the LP pump send-out header, recondenser, and HP pump suction header back into the storage tanks to minimize the inventory of LNG above deck level.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A liquefied natural gas storage structure positioned in a body of water comprising:
a body;
a liquefied natural gas storage tank contained within the body;
wherein at least a portion of a bottom surface of the body rests upon a portion of a bottom of the body of water.

2. The structure of claim 1, further comprising docking equipment, wherein the docking equipment is configured to couple a liquefied natural gas carrier to the body.

3. The structure of claim 1, further comprising liquefied natural gas transfer equipment, wherein the liquefied natural gas transfer equipment is configured to transfer liquefied natural gas from a liquefied natural gas carrier to the liquefied natural gas storage tank.

4. The structure of claim 1, further comprising vaporization equipment, wherein the vaporization equipment is configured to vaporize liquefied natural gas to natural gas.

5. The structure of claim 1, wherein the body comprises a first upper surface and a second upper surface, the first upper surface having an elevation that is different from the elevation of the second upper surface, and wherein the structure further comprises docking equipment disposed on the second upper surface, wherein the docking equipment is configured to couple a liquefied natural gas carrier to the body.

6. The structure of claim 1, wherein the body comprises an upper surface, wherein the structure further comprises docking equipment disposed on the upper surface, and wherein the docking equipment is configured to couple a liquefied natural gas carrier to the body.

7. The structure of claim 1, further comprising liquefied natural gas transfer equipment, wherein the liquefied natural gas transfer equipment is configured to transfer liquefied natural gas from a liquefied natural gas carrier to the liquefied natural gas storage tank.

8. The structure of claim 1, further comprising a docking platform positioned in the body of water proximate to the body, wherein the docking platform comprises docking equipment, and wherein the docking platform is positioned in the body of water such that a liquefied natural gas carrier can dock with the body in different orientations.

9. The structure of claim 1, further comprising a fender.

10. The structure of claim 1, wherein at least a portion of the body is composed of a lightweight concrete.

11. The structure of claim 1, wherein the structure is positioned in the body of water such that the longitudinal axis of the structure is substantially aligned with the predominant current direction.

12. The structure of claim 1, wherein the structure has a storage capacity of greater than about 50,000 cubic meters of liquefied natural gas.

13. The structure of claim 1, wherein the body has a length that is at least equal to a length required to provide sufficient berthing alongside the body for a liquefied natural gas carrier having a liquefied natural gas capacity of greater than about 100,000 cubic meters.

14. The structure of claim 1, wherein the structure is configured to provide natural gas at a peak capacity of greater than about 1 billion cubic feet per day.

15. The structure of claim 1, further comprising vaporization equipment wherein the vaporization equipment comprises an open-rack vaporizer.

16. The structure of claim 1, further comprising vaporization equipment wherein the vaporization equipment comprises a submerged combustion vaporizer.

17. The structure of claim 1, further comprising vaporization equipment and an export metering system wherein the export metering system is configured to monitor the flow of produced natural gas from the structure.

18. The structure of claim 1, further comprising a projection extending from the bottom surface of the body.

19. The structure of claim 1, further comprising a boil-off gas compressor, wherein the boil-off gas compressor is configured to provide a source of compressed natural gas to the structure.

20. The structure of claim 1, further comprising a recondenser.

21. The structure of claim 1, further comprising a wave deflector.

22. The structure of claim 21, wherein the wave deflector comprises a curved barrier extending outward from a side of the body.

23. The structure of claim 1, further comprising scour protection at least partially circumscribing the structure.

24. The structure of claim 1, further comprising a ballast storage area.

25. The structure of claim 1, further comprising a ballast storage area containing liquid.

26. The structure of claim 24, wherein the ballast storage area is adjacent to the liquefied natural gas storage tank.

27. The structure of claim 24, wherein the ballast storage area is adjacent to the liquefied natural gas storage tank, and wherein the ballast storage area is configured to inhibit water leaking into the ballast storage area from contacting a wall of a liquefied natural gas storage tank.

28. The structure of claim 24, wherein the ballast storage area is positioned under the liquefied natural gas storage tank.

29. The structure of claim 1, wherein the liquefied natural gas storage tank comprises a membrane tank.

30. The structure of claim 1, wherein the liquefied natural gas storage tank comprises a double containment tank.

31. The structure of claim 1, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

32. The structure of claim 31, wherein the outer wall comprises concrete, wherein the insulating structure comprises polyurethane foam, wherein the secondary barrier comprises a polyester glass cloth composite, and wherein the primary barrier comprises stainless steel.

33. The structure of claim 31, wherein the primary barrier comprises a double network of orthogonal corrugations of stainless steel, and wherein the orthogonal corrugations are configured to be capable of thermal expansion and contraction.

34. The structure of claim 31, further comprising a purge system positioned between the primary barrier and the secondary barrier.

35. The structure of claim 31, further comprising a heating system coupled to the outer wall, wherein the heating system is configured to maintain a temperature of the outer wall at or above about 5° C.

36. The structure of claim 1, further comprising a liquefied natural gas pump disposed in the liquefied natural gas storage tank.

37. The structure of claim 1, further comprising a platform.

38. The structure of claim 1, wherein the body further comprises a first upper surface and a second upper surface wherein the first upper surface has an elevation that is different from the elevation of the second upper surface.

39. The structure of claim 1, further comprising a fender.

40. The structure of claim 39, wherein the fender is positioned about a perimeter of the body.

41. The structure of claim 1, further comprising liquefied natural gas transfer equipment wherein the liquefied natural gas transfer equipment comprises a swivel joint unloading arm.

42. The structure of claim 1, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

43. The structure of claim 1, further comprising liquefied natural gas transfer equipment wherein the liquefied natural gas transfer equipment comprises at least four unloading arms, wherein at least one of the unloading arms is configurable to transfer liquefied natural gas from a liquefied natural gas carrier to the liquefied natural gas storage tank.

44. The structure of claim 1, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

45. The structure of claim 1, further comprising liquefied natural gas transfer equipment wherein the liquefied natural gas transfer equipment comprises an unloading arm, wherein the unloading arm is purged with nitrogen after unloading liquefied natural gas from a carrier.

46. The structure of claim 1, further comprising:
vaporization equipment coupled to the body, wherein the vaporization equipment is configured to vaporize liquefied natural gas to natural gas; and further comprising a water intake system, wherein the water intake system is configured to draw water from the body of water and supply water to the vaporization equipment.

47. The structure of claim 46, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

48. The structure of claim 46, wherein the water intake system comprises:
a water inlet;
a water receiving chamber, wherein the water receiving chamber is configured to receive water from the water inlet;
a baffle, wherein the baffle reduces an effect of waves on the inlet of water into the water receiving chamber; and
a pump, wherein the pump receives water from the water receiving chamber.

49. The structure of claim 46, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

50. The structure of claim 46, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

51. A liquefied natural gas storage structure positioned in a body of water comprising:
a body comprising an upper surface and a bottom surface;
a liquefied natural gas storage tank contained within the body;
wherein at least a portion of the bottom surface of the body rests upon a portion of a bottom of the body of water.

52. The structure of claim 51, further comprising docking equipment, wherein the docking equipment is configured to couple a liquefied natural gas carrier to the body.

53. The structure of claim 51, further comprising liquefied natural gas transfer equipment, wherein the liquefied natural gas transfer equipment is configured to transfer liquefied natural gas from a liquefied natural gas carrier to the liquefied natural gas storage tank.

54. The structure of claim 51, further comprising vaporization equipment disposed on the upper surface, wherein the vaporization equipment is configured to vaporize liquefied natural gas to natural gas.

55. The structure of claim 51, wherein the structure further comprises docking equipment disposed on the upper surface, wherein the docking equipment is configured to couple a liquefied natural gas carrier to the body.

56. The structure of claim 51, further comprising a projection extending from the bottom surface of the body.

57. The structure of claim 51, further comprising a projection extending from the bottom surface of the body, wherein at least a portion of the projection rests upon a portion of the bottom of the body of water.

58. The structure of claim 51, further comprising a platform.

59. The structure of claim 51, further comprising a platform positioned on the upper surface of the body, wherein equipment is disposed on the platform, and wherein the platform is at a height such that equipment disposed on the platform is substantially protected from water running over the body.

60. The structure of claim 51, wherein at least a portion of the body is composed of a lightweight concrete.

61. The structure of claim 51, wherein the structure is positioned in the body of water such that the longitudinal axis of the structure is substantially aligned with the predominant current direction.

62. The structure of claim 51, wherein the body comprises a first unit and a second unit, wherein the first and second units are coupled to each other.

63. The structure of claim 51, wherein the body has a length that is at least equal to a length required to provide sufficient berthing alongside the body for a liquefied natural gas carrier having a liquefied natural gas capacity of greater than about 100,000 cubic meters.

64. The structure of claim 51, wherein the structure has a storage capacity of greater than about 50,000 cubic meters of liquefied natural gas.

65. The structure of claim 51, further comprising vaporization equipment coupled to the upper surface of the body, wherein the vaporization equipment comprises an open-rack vaporizer.

66. The structure of claim 51, further comprising vaporization equipment coupled to the upper surface of the body, wherein the vaporization equipment comprises a submerged combustion vaporizer.

67. The structure of claim 51, further comprising vaporization equipment coupled to the upper surface of the body and an export metering system coupled to the vaporization equipment.

68. The structure of claim 51, further comprising:
vaporization equipment coupled to the upper surface of the body, wherein the vaporization equipment is configured to vaporize liquefied natural gas to natural gas; and
a natural gas transfer pipeline.

69. The structure of claim 51, further comprising a boil-off gas compressor, wherein the boil-off gas compressor is configured to provide a source of compressed natural gas to the structure.

70. The structure of claim 51, further comprising a recondenser.

71. The structure of claim 51, further comprising a wave deflector.

72. The structure of claim 71, wherein the wave deflector comprises a curved barrier extending outward from a side of the body.

73. The structure of claim 51, further comprising scour protection at least partially circumscribing the structure.

74. The structure of claim 51, further comprising a ballast storage area.

75. The structure of claim 51, further comprising a ballast storage area containing liquid.

76. The structure of claim 75, wherein the ballast storage area is adjacent to the liquefied natural gas storage tank.

77. The structure of claim 75, wherein the ballast storage area is adjacent to the liquefied natural gas storage tank, and wherein the ballast storage area is configured to inhibit water leaking into the ballast storage area from contacting a wall of the liquefied natural gas storage tank.

78. The structure of claim 75, wherein the ballast storage area is positioned under the liquefied natural gas storage tank.

79. The structure of claim 51, wherein the liquefied natural gas storage tank comprises a membrane tank.

80. The structure of claim 51, wherein the liquefied natural gas storage tank comprises a double containment tank.

81. The structure of claim 51, wherein one or more liquefied natural gas storage tanks comprise:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

82. The structure of claim 81, wherein the outer wall comprises concrete, wherein the insulating structure comprises polyurethane foam, wherein the secondary barrier comprises a polyester glass cloth composite, and wherein the primary barrier comprises stainless steel.

83. The structure of claim 81, wherein the primary barrier comprises a double network of orthogonal corrugations of stainless steel, and wherein the orthogonal corrugations are configured to be capable of thermal expansion and contraction.

84. The structure of claim 81, further comprising a purge system positioned between the primary barrier and the secondary barrier.

85. The structure of claim 81, further comprising a heating system coupled to the outer wall, wherein the heating system is configured to maintain a temperature of the outer wall at or above about 5° C.

86. The structure of claim 51, further comprising a liquefied natural gas pump disposed in the liquefied natural gas storage tank.

87. The structure of claim 51, further comprising a platform.

88. The structure of claim 51, further comprising docking equipment wherein the docking equipment is positioned on the body such that an angle of mooring lines extending from the docking equipment to a liquefied natural gas carrier coupled to the body is less than about 30 degrees.

89. The structure of claim 51, further comprising a fender.

90. The structure of claim 89, wherein the fender is positioned about a perimeter of the body.

91. The structure of claim 51, further comprising liquefied natural gas transfer equipment wherein the liquefied natural gas transfer equipment comprises a swivel joint unloading arm.

92. The structure of claim 51, further comprising liquefied natural gas transfer equipment wherein the liquefied natural gas transfer equipment comprises an unloading arm, wherein the unloading arm can be positioned in a substantially horizontal position during storage of the unloading arm.

93. The structure of claim 51, further comprising liquefied natural gas transfer equipment wherein the liquefied natural gas transfer equipment comprises at least four unloading arms, and wherein at least one unloading arm is configurable to transfer liquefied natural gas from a liquefied natural gas carrier to the liquefied natural gas storage tank.

94. The structure of claim 51, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

95. The structure of claim 51, further comprising liquefied natural gas transfer equipment wherein the liquefied natural gas transfer equipment comprises an unloading arm, wherein the unloading arm is purged with nitrogen after unloading liquid natural gas from a carrier.

96. The structure of claim 51, further comprising:
vaporization equipment coupled to the upper surface of the body, wherein the vaporization equipment is configured to vaporize liquefied natural gas to natural gas; and
a water intake system, wherein the water intake system is configured to draw water from the body of water and supply water to the vaporization equipment.

97. The structure of claim 96, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

98. The structure of claim 96, wherein the water intake system comprises:
a water inlet;
a water receiving chamber, wherein the water receiving chamber is configured to receive water from the water inlet;
a baffle, wherein the baffle reduces an effect of waves on the inlet of water into the water receiving chamber; and
a pump, wherein the pump receives water from the water receiving chamber.

99. The structure of claim 96, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

100. The structure of claim 96, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

101. A water intake system for a structure positioned in a body of water comprising:
a water inlet, wherein the water inlet comprises a water inlet conduit, and wherein the water inlet conduit comprises a water receiving end;
wherein the water receiving end of the water inlet conduit is positioned at a distance from the structure such that waves reflecting off of the structure do not substantially affect the flow of water into the water receiving end.

102. The water intake system of claim 101, further comprising a water receiving chamber, wherein the water receiving chamber is configured to receive water from the water inlet, and further comprising a pump, wherein the pump receives water from the water receiving chamber.

103. The water intake system of claim 101, wherein the water receiving end of the water inlet conduit is positioned at a distance of 0.25 times the wavelength of water contacting the structure, and wherein the water receiving end of the water inlet conduit is positioned above the bottom of the body of water such that sediment at the bottom of the body of water is inhibited from entering the water receiving end.

104. The water intake system of claim 101, wherein the water receiving end of the water inlet conduit is positioned at a distance of greater than about 5 meters from the bottom of the body of water.

105. The water intake system of claim 101, wherein the water receiving end is positioned within a water intake cage, and wherein the water intake cage comprises an intake header supported above the bottom of the body of water by a support structure.

106. The water intake system of claim 105, further comprising scour protection at least partially circumscribing the water intake cage.

107. The water intake system of claim 105, wherein the water intake cage comprises a grating coupled to the intake header, wherein the grating is configured to inhibit debris from entering the intake header.

108. The water intake system of claim 105, wherein the water intake cage comprises a water filter disposed within the intake header, wherein the water filter is configured to inhibit debris from entering the inlet conduit.

109. The water intake system of claim 108, wherein the water filter comprises a wrapped wire filter.

110. The water intake system of claim 108, wherein the water filter comprises a screen filter.

111. The water intake system of claim 105, further comprising a compressed air source coupled to the water intake cage, wherein the compressed air source is configured to supply compressed air to the water intake cage to clean filters disposed in the water intake cage.

112. The water intake system of claim 105, further comprising a crane coupled to the water intake cage, wherein the crane is configured to remove a filter disposed in the water intake cage for cleaning.

113. The water intake system of claim 101, wherein the velocity of water entering the water inlet conduit is less than or equal to about 0.15 meters per second.

114. The water intake system of claim 101, further comprising a baffle, wherein the baffle reduces an effect of waves on the water entering the water inlet.

115. A water intake system for a structure positioned in a body of water, comprising:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

116. The water intake system of claim 115, wherein the first and second water receiving chamber are positioned within the structure.

117. The water intake system of claim 115, wherein the water inlet is positioned above the bottom of the body of water such that sediment at the bottom of the body of water is inhibited from entering the water receiving end.

118. The water intake system of claim 115, wherein the water inlet is positioned at a distance of greater than about 5 meters from the bottom of the body of water.

119. The water intake system of claim 115, wherein the water inlet comprises a grating, and further comprises an intake header supported above the bottom of the body of water by a support structure, wherein the grating is configured to inhibit debris from entering the intake header.

120. The water intake system of claim 115, wherein the filter comprises a screen filter.

121. The water intake system of claim 115, wherein the filter is movable into a filtering position and a cleaning position.

122. The water intake system of claim 115, wherein the velocity of water entering the water inlet conduit is less than or equal to about 0.15 meters per second.

123. The water intake system of claim 115, further comprising a baffle, wherein the baffle reduces an effect of waves on the water entering the second water receiving chamber.

124. The water intake system of claim 115, wherein the first and second water receiving chambers are positioned within the structure.

125. A vaporizing system for a liquefied natural gas storage structure positioned in a body of water comprising a heat exchanger and a pump, wherein the heat exchanger receives water from the pump and wherein the heat exchanger is configured to vaporize at least a portion of liquefied natural gas passing through the heat exchanger using water received from the pump.

126. The vaporizing system of claim 125, wherein the pump receives water from a water receiving chamber.

127. The vaporizing system of claim 126, wherein the water receiving chamber is configured to receive water from the water inlet, wherein the water inlet comprises a water inlet conduit, wherein the water inlet conduit comprises a water receiving end, the vaporizing system further comprising a water outlet, wherein the water outlet discharges water received from the heat exchanger into the body of water.

128. The vaporizing system of claim 127, wherein the water receiving end of the water inlet conduit is positioned at a distance of more than about 0.25 times the wavelength of water contacting the structure.

129. The vaporizing system of claim 127, further comprising a water intake cage, wherein the water intake cage comprises an intake header, wherein the water receiving end of the water inlet conduit is positioned in the intake header, wherein the water intake cage comprises a filter disposed within the intake header, wherein the filter is configured to inhibit debris from entering the water inlet conduit.

130. The vaporizing system of claim 129, further comprising scour protection at least partially circumscribing the water intake cage.

131. The vaporizing system of claim 129, wherein the water intake cage comprises a grating coupled to the intake header, wherein the grating is configured to inhibit debris from entering the intake header.

132. The vaporizing system of claim 129, wherein the water intake cage comprises a filter disposed within the intake header, wherein the filter is configured to inhibit debris from entering the water inlet conduit.

133. The vaporizing system of claim 132, wherein the water filter comprises a wrapped wire filter.

134. The vaporizing system of claim 132, wherein the water filter comprises a screen filter.

135. The vaporizing system of claim 129, further comprising a compressed air source, wherein the compressed air source is configured to supply compressed air to the water intake cage to clean filters disposed in the water intake cage.

136. The vaporizing system of claim 129, further comprising a crane, wherein the crane is configured to remove the filter disposed in the water intake cage for cleaning.

137. The vaporizing system of claim 127, wherein the velocity of water entering the water inlet conduit is less than or equal to about 0.15 meters per second.

138. The vaporizing system of claim 127, further comprising a baffle, wherein the baffle reduces an effect of waves on the water entering the water inlet.

139. The vaporizing system of claim 125, further comprising an export metering system disposed on the structure, wherein the export metering system is configured to monitor the flow of produced natural gas from the structure.

140. The vaporizing system of claim 127, wherein the water outlet comprises a water outlet conduit, wherein an end of the water outlet conduit is positioned at a distance from the water intake system such that water exiting the water outlet conduit does not substantially affect the temperature of water entering the water intake system.

141. A vaporizing system for a liquefied natural gas storage structure positioned in a body of water comprising a heat exchanger and a pump, wherein the heat exchanger receives water from the pump and wherein the heat exchanger is configured to vaporize at least a portion of liquefied natural gas passing through the heat exchanger using water received from the pump.

142. The vaporizing system of claim 141, further comprising a second water receiving chamber, wherein the pump receives water from the second water receiving chamber.

143. The vaporizing system of claim 142, further comprising a first water receiving chamber, wherein the second water receiving chamber is configured to receive water from the first water receiving chamber, and further comprising a water inlet, wherein the first water receiving chamber is configured to receive water from the water inlet.

144. The vaporizing system of claim 143, wherein a filter is positioned between the first and second water receiving chambers, wherein the filter is configured to filter water passing from the first water receiving chamber to the second water receiving chamber.

145. The vaporizing system of claim 144, further comprising a water outlet, wherein the water outlet discharges water received from the heat exchanger into the body of water.

146. The vaporizing system of claim 144, wherein the filter comprises a screen filter.

147. The vaporizing system of claim 144, wherein the filter is movable into a filtering position and a cleaning position.

148. The vaporizing system of claim 143, wherein the water inlet comprises a water inlet conduit wherein the velocity of water entering the water inlet conduit is less than or equal to about 0.15 meters per second.

149. The vaporizing system of claim 142, further comprising a baffle, wherein the baffle reduces an effect of waves on the water entering the second water receiving chamber.

150. The vaporizing system of claim 141, wherein the heat exchanger comprises an open-rack vaporizer.

151. The vaporizing system of claim 141, wherein the heat exchanger comprises a submerged combustion vaporizer.

152. The vaporizing system of claim 141, further comprising an export metering system, wherein the export metering system is configured to monitor the flow of produced natural gas from the structure.

153. The vaporizing system of claim 145, wherein the water outlet comprises a water outlet conduit, wherein an end of the water outlet conduit is positioned at a distance from the water intake system such that water exiting the water outlet conduit does not substantially affect the temperature of water entering the water intake system.

154. A liquefied natural gas storage structure positioned in a body of water comprising:
a body;
a liquefied natural gas storage tank contained within the body; and
a wave deflector;
wherein at least a portion of a bottom surface of the body rests upon a portion of a bottom of the body of water.

155. The structure of claim 154, wherein the wave deflector is coupled to at least a portion of the body.

156. The structure of claim 154, further comprising liquefied natural gas transfer equipment disposed on the body, wherein the liquefied natural gas transfer equipment is configured to transfer liquefied natural gas from a liquefied natural gas carrier to the liquefied natural gas storage tank.

157. The structure of claim 154, further comprising vaporization equipment, wherein the vaporization equipment is configured to vaporize liquefied natural gas to natural gas.

158. The structure of claim 154, further comprising a platform.

159. The structure of claim 154, further comprising a projection extending from the bottom surface of the body.

160. The structure of claim 154, wherein at least a portion of the projection is at least partially embedded in the bottom of the body of water.

161. The structure of claim 154, further comprising a platform disposed on the body.

162. The structure of claim 154, further comprising a platform, and wherein the platform is at a height such that equipment disposed on the platform is substantially protected from water running over the body.

163. The structure of claim 154, wherein at least a portion of the body is composed of a lightweight concrete.

164. The structure of claim 154, wherein the structure is positioned in the body of water such that the longitudinal axis of the structure is substantially aligned with the predominant current direction.

165. The structure of claim 154, wherein the body comprises a first unit and a second unit, and wherein the first and second units are coupled to each other.

166. The structure of claim 154, wherein the body has a length that is at least equal to a length required to provide sufficient berthing alongside the body for a liquefied natural gas carrier having a liquefied natural gas capacity of greater than about 100,000 cubic meters.

167. The structure of claim 154, further comprising vaporization equipment coupled to an upper surface of the body, wherein the vaporization equipment is configured to vaporize liquefied natural gas to natural gas.

168. The structure of claim 154, further comprising vaporization equipment, wherein the vaporization equipment comprises an open-rack vaporizer.

169. The structure of claim 154, further comprising vaporization equipment, wherein the vaporization equipment comprises a submerged combustion vaporizer.

170. The structure of claim 154, further comprising vaporization equipment and an export metering system coupled to the vaporization equipment, wherein the export metering system is configured to monitor the flow of produced natural gas from the structure.

171. The structure of claim 154, further comprising:
vaporization equipment, wherein the vaporization equipment is configured to vaporize liquefied natural gas to natural gas, and
a natural gas transfer pipeline.

172. The structure of claim 154, further comprising a boil-off gas compressor, wherein the boil-off gas compressor is configured to provide a source of compressed natural gas to the structure.

173. The structure of claim 154, further comprising a recondenser.

174. The structure of claim 155, wherein the wave deflector comprises a curved barrier extending outward from a side of the body.

175. The structure of claim 154, further comprising scour protection at least partially circumscribing the structure.

176. The structure of claim 154, further comprising a ballast storage area.

177. The structure of claim 154, further comprising a ballast storage area containing liquid.

178. The structure of claim 176, wherein the ballast storage area is adjacent to the liquefied natural gas storage tank.

179. The structure of claim 176, wherein the ballast storage area is adjacent to the liquefied natural gas storage tank, and wherein the ballast storage area is configured to inhibit water leaking into the ballast storage area from contacting a wall of a liquefied natural gas storage tank.

180. The structure of claim 176, wherein the ballast storage area is positioned under the liquefied natural gas storage tank.

181. The structure of claim 154, wherein the liquefied natural gas storage tank comprises a membrane tank.

182. The structure of claim 154, wherein the liquefied natural gas storage tank comprises a double containment tank.

183. The structure of claim 154, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

184. The structure of claim 183, wherein the outer wall comprises concrete, wherein the insulating structure comprises polyurethane foam, wherein the secondary barrier comprises a polyester glass cloth composite, and wherein the primary barrier comprises stainless steel.

185. The structure of claim 183, wherein the primary barrier comprises a double network of orthogonal corrugations of stainless steel, and wherein the orthogonal corrugations are configured to be capable of thermal expansion and contraction.

186. The structure of claim 183, further comprising a purge system positioned between the primary barrier and the secondary barrier.

187. The structure of claim 183, further comprising a heating system coupled to the outer wall, wherein the heating system is configured to maintain a temperature of the outer wall at or above about 5° C.

188. The structure of claim 154, further comprising a liquefied natural gas pump disposed in the liquefied natural gas storage tank.

189. The structure of claim 154, further comprising liquefied natural gas transfer equipment wherein the liquefied natural gas transfer equipment comprises a swivel joint unloading arm.

190. The structure of claim 154, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

191. The structure of claim 154, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

192. The structure of claim 154, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

193. The structure of claim 154, further comprising liquefied natural gas transfer equipment wherein the liquefied natural gas transfer equipment comprises an unloading arm, wherein the unloading arm is purged with nitrogen after unloading liquid natural gas from a carrier.

194. The structure of claim 154, further comprising vaporization equipment, wherein the vaporization equipment is configured to vaporize liquefied natural gas to natural gas; and
a water intake system, wherein the water intake system is configured to draw water from the body of water and supply water to the vaporization equipment.

195. The structure of claim 194, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

196. The structure of claim 194, wherein the water intake system comprises:
a water inlet;
a water receiving chamber, wherein the water receiving chamber is configured to receive water from the water inlet;
a baffle, wherein the baffle reduces an effect of waves on the inlet of water into the water receiving chamber; and
a pump, wherein the pump receives water from the water receiving chamber.

197. The structure of claim 194, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

198. The structure of claim 194, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

199. A liquefied natural gas storage structure positioned in a body of water comprising:
a body;
a liquefied natural gas storage tank contained within the body; and
a platform;
wherein at least a portion of a bottom surface of the body rests upon a portion of a bottom of the body of water.

200. The structure of claim 199, wherein the platform is positioned on the body.

201. The structure of claim 199, further comprising liquefied natural gas transfer equipment, wherein the liquefied natural gas transfer equipment is configured to transfer liquefied natural gas from a liquefied natural gas carrier to the liquefied natural gas storage tank.

202. The structure of claim 199, further comprising vaporization equipment, wherein the vaporization equipment is configured to vaporize liquefied natural gas to natural gas.

203. The structure of claim 199, further comprising a projection extending from the bottom surface of the body.

204. The structure of claim 199, further comprising a projection extending from the bottom surface of the body, wherein at least a portion of the projection is at least partially embedded in the bottom of the body of water.

205. The structure of claim 199, further comprising a projection extending from the bottom surface of the body, wherein at least a portion of the projection is at least partially embedded in the bottom of the body of water, and wherein the projection inhibits lateral movement of the structure.

206. The structure of claim 199, wherein equipment is disposed on the platform, and wherein the platform is at a height such that equipment disposed on the platform is substantially protected from water running over the body.

207. The structure of claim 199, wherein at least a portion of the body is composed of a lightweight concrete.

208. The structure of claim 199, wherein the structure is positioned in the body of water such that the longitudinal axis of the structure is substantially aligned with the predominant current direction.

209. The structure of claim 199, wherein the body comprises a first unit and a second unit, and wherein the first and second units are coupled to each other.

210. The structure of claim 199, wherein the body has a length that is at least equal to a length required to provide sufficient berthing alongside the body for a liquefied natural gas carrier having a liquefied natural gas capacity of greater than about 100,000 cubic meters.

211. The structure of claim 199, further comprising vaporization equipment coupled to an upper surface of the body, wherein the vaporization equipment is configured to vaporize liquefied natural gas to natural gas.

212. The structure of claim 199, further comprising vaporization equipment, wherein the vaporization equipment comprises an open-rack vaporizer.

213. The structure of claim 199, further comprising vaporization equipment, wherein the vaporization equipment comprises a submerged combustion vaporizer.

214. The structure of claim 199, further comprising vaporization equipment and an export metering system coupled to the vaporization equipment, wherein the export metering system is configured to monitor the flow of produced natural gas from the structure.

215. The structure of claim 199, further comprising:
vaporization equipment, wherein the vaporization equipment is configured to vaporize liquefied natural gas to natural gas, and
a natural gas transfer pipeline.

216. The structure of claim 199, further comprising a boil-off gas compressor, wherein the boil-off gas compressor is configured to provide a source of compressed natural gas to the structure.

217. The structure of claim 199, further comprising a recondenser.

218. The structure of claim 199, further comprising scour protection at least partially circumscribing the structure.

219. The structure of claim 199, further comprising a ballast storage area.

220. The structure of claim 199, further comprising a ballast storage area containing liquid.

221. The structure of claim 219, wherein the ballast storage area is adjacent to the liquefied natural gas storage tank.

222. The structure of claim 219, wherein the ballast storage area is adjacent to the liquefied natural gas storage tank, and wherein the ballast storage area is configured to inhibit water leaking into the ballast storage area from contacting a wall of a liquefied natural gas storage tank.

223. The structure of claim 219, wherein the ballast storage area is positioned under the liquefied natural gas storage tank.

224. The structure of claim 199, wherein the liquefied natural gas storage tank comprises a membrane tank.

225. The structure of claim 199, wherein the liquefied natural gas storage tank comprises a double containment tank.

226. The structure of claim 199, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

227. The structure of claim 226, wherein the outer wall comprises concrete, wherein the insulating structure comprises polyurethane foam, wherein the secondary barrier comprises a polyester glass cloth composite, and wherein the primary barrier comprises stainless steel.

228. The structure of claim 226, wherein the primary barrier comprises a double network of orthogonal corrugations of stainless steel, and wherein the orthogonal corrugations are configured to be capable of thermal expansion and contraction.

229. The structure of claim 226, further comprising a purge system positioned between the primary barrier and the secondary barrier.

230. The structure of claim 226, further comprising a heating system coupled to the outer wall, wherein the heating system is configured to maintain a temperature of the outer wall at or above about 5° C.

231. The structure of claim 199, further comprising a liquefied natural gas pump disposed in the liquefied natural gas storage tank.

232. The structure of claim 199, further comprising liquefied natural gas transfer equipment wherein the liquefied natural gas transfer equipment comprises a swivel joint unloading arm.

233. The structure of claim 199, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

234. The structure of claim 199, further comprising liquefied natural gas transfer equipment wherein the liquefied natural gas transfer equipment comprises at least four unloading arms, and wherein at least one unloading arm is configurable to transfer liquefied natural gas from a liquefied natural gas carrier to the liquefied natural gas storage tank.

235. The structure of claim 199, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

236. The structure of claim 199, further comprising liquefied natural gas transfer equipment wherein the liquefied natural gas transfer equipment comprises an unloading arm, wherein the unloading arm is purged with nitrogen after unloading liquid natural gas from a carrier.

237. The structure of claim 199, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

238. The structure of claim 237, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially effect the flow of water into the water inlet.

239. The structure of claim 237, wherein the water intake system comprises:
a water inlet;
a water receiving chamber, wherein the water receiving chamber is configured to receive water from the water inlet;
a baffle, wherein the baffle reduces an effect of waves on the inlet of water into the water receiving chamber; and
a pump, wherein the pump receives water from the water receiving chamber.

240. The structure of claim 237, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

241. The structure of claim 237, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

242. A liquefied natural gas storage structure positioned in a body of water comprising:
a body;
a liquefied natural gas storage tank contained within the body; and
an auxiliary structure;
wherein at least a portion of a bottom surface of the body rests upon a portion of a bottom of the body of water.

243. The structure of claim 242, wherein the auxiliary structure comprises living quarters.

244. The structure of claim 243, wherein at least some of the living quarters are reinforced to substantially withstand an emergency situation.

245. The structure of claim 242, wherein the structure has a storage capacity of greater than about 50,000 cubic meters of liquefied natural gas.

246. The structure of claim 242, wherein the structure is configured to produce natural gas at a peak capacity of greater than about 1 billion cubic feet per day.

247. The structure of claim 242, wherein the structure has a storage capacity of greater than about 50,000 cubic meters of liquefied natural gas; and wherein the structure is configured to produce natural gas at a peak capacity of greater than about 1 billion cubic feet per day.

248. The structure of claim 242, further comprising liquefied natural gas transfer equipment, wherein the liquefied natural gas transfer equipment is configured to transfer liquefied natural gas from a liquefied natural gas carrier to the liquefied natural gas storage tank.

249. The structure of claim 242, further comprising vaporization equipment, wherein the vaporization equipment is configured to vaporize liquefied natural gas to natural gas.

250. The structure of claim 242, further comprising a projection extending from the bottom surface of the body.

251. The structure of claim 242, further comprising a platform.

252. The structure of claim 242, further comprising a platform, wherein the platform is at a height such that equipment disposed on the platform is substantially protected from water running over the body.

253. The structure of claim 242, wherein at least a portion of the body is composed of a lightweight concrete.

254. The structure of claim 242, wherein the structure is positioned in the body of water such that the longitudinal axis of the structure is substantially aligned with the predominant current direction.

255. The structure of claim 242, wherein the body comprises a first unit and a second unit, and wherein the first and second units are coupled to each other.

256. The structure of claim 242, wherein the body has a length that is at least equal to a length required to provide sufficient berthing alongside the body for a liquefied natural gas carrier having a liquefied natural gas capacity of greater than about 100,000 cubic meters.

257. The structure of claim 242, further comprising vaporization equipment disposed on an upper surface of the body, wherein the vaporization equipment is configured to vaporize liquefied natural gas to natural gas.

258. The structure of claim 242, further comprising vaporization equipment, wherein the vaporization equipment comprises an open-rack vaporizer.

259. The structure of claim 242, further comprising vaporization equipment, wherein the vaporization equipment comprises a submerged combustion vaporizer.

260. The structure of claim 242, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

261. The structure of claim 242, further comprising:
vaporization equipment, wherein the vaporization equipment is configured to vaporize liquefied natural gas to natural gas, and
a natural gas transfer pipeline.

262. The structure of claim 242, further comprising a boil-off gas compressor, wherein the boil-off gas compressor is configured to provide a source of compressed natural gas to the structure.

263. The structure of claim 242, further comprising a recondenser.

264. The structure of claim 242, further comprising a wave deflector.

265. The structure of claim 264, wherein the wave deflector comprises a curved barrier extending outward from a side of the body.

266. The structure of claim 242, further comprising scour protection at least partially circumscribing the structure.

267. The structure of claim 242, further comprising a ballast storage area.

268. The structure of claim 242, further comprising a ballast storage area containing liquid.

269. The structure of claim 267, wherein the ballast storage area is adjacent to the liquefied natural gas storage tank.

270. The structure of claim 267, wherein the ballast storage area is adjacent to the liquefied natural gas storage tank, and wherein the ballast storage area is configured to inhibit water leaking into the ballast storage area from contacting a wall of a liquefied natural gas storage tank.

271. The structure of claim 267, wherein the ballast storage area is positioned under the liquefied natural gas storage tank.

272. The structure of claim 242, wherein the liquefied natural gas storage tanks comprises a membrane tank.

273. The structure of claim 242, wherein the liquefied natural gas storage tank comprises a double containment tank.

274. The structure of claim 242, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

275. The structure of claim 274, wherein the outer wall comprises concrete, wherein the insulating structure comprises polyurethane foam, wherein the secondary barrier comprises a polyester glass cloth composite, and wherein the primary barrier comprises stainless steel.

276. The structure of claim 274, wherein the primary barrier comprises a double network of orthogonal corrugations of stainless steel, and wherein the orthogonal corrugations are configured to be capable of thermal expansion and contraction.

277. The structure of claim 274, further comprising a purge system positioned between the primary barrier and the secondary barrier.

278. The structure of claim 274, further comprising a heating system coupled to the outer wall, wherein the heating system is configured to maintain a temperature of the outer wall at or above about 5° C.

279. The structure of claim 242, further comprising a liquefied natural gas pump disposed in the liquefied natural gas storage tank.

280. The structure of claim 242, further comprising a docking platform positioned in the body of water proximate to the body, wherein the docking platform comprises docking equipment.

281. The structure of claim 242, wherein the body comprises a first upper surface and a second upper surface, the first upper surface having an elevation that is different from the elevation of the second upper surface, wherein the height of the second upper surface above the surface of the body of water is such that an angle of mooring lines extending from docking equipment disposed on the second upper surface to a liquefied natural gas carrier coupled to the body is less than about 30 degrees.

282. The structure of claim 242, further comprising a fender.

283. The structure of claim 282, wherein the fender is positioned about a perimeter of the body.

284. The structure of claim 242, further comprising liquefied natural gas transfer equipment wherein the liquefied natural gas transfer equipment comprises a swivel joint unloading arm.

285. The structure of claim 242, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

286. The structure of claim 242, further comprising liquefied natural gas transfer equipment wherein the liquefied natural gas transfer equipment comprises at least four unloading arms, and wherein at least one unloading arm is configurable to transfer liquefied natural gas from a liquefied natural gas carrier to the liquefied natural gas storage tank.

287. The structure of claim 242, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

288. The structure of claim 242, further comprising liquefied natural gas transfer equipment wherein the liquefied natural gas transfer equipment comprises an unloading arm, wherein the unloading arm is purged with nitrogen after unloading liquefied natural gas from a carrier.

289. The structure of claim 242, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

290. The structure of claim 289, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

291. The structure of claim 289, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

292. The structure of claim 289, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

293. The structure of claim 289, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

294. A liquefied natural gas storage structure positioned in a body of water comprising:
a body;
a liquefied natural gas storage tank contained within the body;
a flare tower;
wherein at least a portion of a bottom surface of the body rests upon a portion of a bottom of the body of water.

295. The structure of claim 294, wherein the flare tower comprises a self-igniting flare tower.

296. The structure of claim 294, further comprising a vent.

297. The structure of claim 294, wherein the flare tower is configurable to divert hydrocarbon emission from the flare tower to a vent.

298. The structure of claim 294, wherein the structure has a storage capacity of greater than about 50,000 cubic meters of liquefied natural gas.

299. The structure of claim 294, wherein the structure is configured to produce natural gas at a peak capacity of greater than about 1 billion cubic feet per day.

300. The structure of claim 294, further comprising liquefied natural gas transfer equipment, wherein the liquefied natural gas transfer equipment is configured to transfer liquefied natural gas from a liquefied natural gas carrier to the liquefied natural gas storage tank.

301. The structure of claim 294, further comprising vaporization equipment, wherein the vaporization equipment is configured to vaporize liquefied natural gas to natural gas.

302. The structure of claim 294, further comprising a projection extending from the bottom surface of the body.

303. The structure of claim 294, further comprising a projection extending from the bottom surface of the body, wherein at least a portion of the projection rests upon a portion of the bottom of the body of water.

304. The structure of claim 294, further comprising a platform.

305. The structure of claim 294, further comprising a platform, wherein the platform is at a height such that equipment disposed on the platform is substantially protected from water running over the body.

306. The structure of claim 294, wherein at least a portion of the body is composed of a lightweight concrete.

307. The structure of claim 294, wherein the structure is positioned in the body of water such that the longitudinal axis of the structure is substantially aligned with the predominant current direction.

308. The structure of claim 294, wherein the body comprises a first unit and a second unit, and wherein the first and second units are coupled to each other.

309. The structure of claim 294, wherein the body has a length that is at least equal to a length required to provide sufficient berthing alongside the body for a liquefied natural gas carrier having a liquefied natural gas capacity of greater than about 100,000 cubic meters.

310. The structure of claim 294, further comprising vaporization equipment disposed on an upper surface of the body, wherein the vaporization equipment is configured to vaporize liquefied natural gas to natural gas.

311. The structure of claim 294, further comprising vaporization equipment, wherein the vaporization equipment comprises an open-rack vaporizer.

312. The structure of claim 294, further comprising vaporization equipment, wherein the vaporization equipment comprises a submerged combustion vaporizer.

313. The structure of claim 294, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

314. The structure of claim 294, further comprising:
vaporization equipment, wherein the vaporization equipment is configured to vaporize liquefied natural gas to natural gas, and
a natural gas transfer pipeline.

315. The structure of claim 294, further comprising a boil-off gas compressor, wherein the boil-off gas compressor is configured to provide a source of compressed natural gas to the structure.

316. The structure of claim 294, further comprising a recondenser.

317. The structure of claim 294, further comprising a wave deflector.

318. The structure of claim 317, wherein the wave deflector comprises a curved barrier extending outward from a side of the body.

319. The structure of claim 294, further comprising scour protection at least partially circumscribing the structure.

320. The structure of claim 294, further comprising a ballast storage area.

321. The structure of claim 294, further comprising a ballast storage area containing liquid.

322. The structure of claim 320, wherein the ballast storage area is adjacent to the liquefied natural gas storage tank.

323. The structure of claim 320, wherein the ballast storage area is adjacent to the liquefied natural gas storage tank, and wherein the ballast storage area is configured to inhibit water leaking into the ballast storage area from contacting a wall of the liquefied natural gas storage tank.

324. The structure of claim 320, wherein the ballast storage areas is positioned under the liquefied natural gas storage tank.

325. The structure of claim 294, wherein the liquefied natural gas storage tank comprises a membrane tank.

326. The structure of claim 294, wherein the liquefied natural gas storage tank comprises a double containment tank.

327. The structure of claim 294, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

328. The structure of claim 327, wherein the outer wall comprises concrete, wherein the insulating structure comprises polyurethane foam, wherein the secondary barrier comprises a polyester glass cloth composite, and wherein the primary barrier comprises stainless steel.

329. The structure of claim 327, wherein the primary barrier comprises a double network of orthogonal corrugations of stainless steel, and wherein the orthogonal corrugations are configured to be capable of thermal expansion and contraction.

330. The structure of claim 327, further comprising a purge system positioned between the primary barrier and the secondary barrier.

331. The structure of claim 327, further comprising a heating system coupled to the outer wall, wherein the heating system is configured to maintain a temperature of the outer wall at or above about 5° C.

332. The structure of claim 294, further comprising a liquefied natural gas pump disposed in the liquefied natural gas storage tank.

333. The structure of claim 294, further comprising a docking platform positioned in the body of water proximate to the body, wherein the docking platform comprises docking equipment, and wherein the docking platform is positioned in the body of water such that a liquefied natural gas carrier can dock with the body in different orientations.

334. The structure of claim 294, wherein the body comprises a first upper surface and a second upper surface, the first upper surface having an elevation that is different from the elevation of the second upper surface, wherein the height of the second upper surface above the surface of the body of water is such that an angle of mooring lines extending from docking equipment disposed on the second upper surface to a liquefied natural gas carrier coupled to the body is less than about 30 degrees.

335. The structure of claim 294, further comprising a fender.

336. The structure of claim 335, wherein the fender is positioned about a perimeter of the body.

337. The structure of claim 294, further comprising liquefied natural gas transfer equipment wherein the liquefied natural gas transfer equipment comprises a swivel joint unloading arm.

338. The structure of claim 294, further comprising liquefied natural gas transfer equipment wherein the liquefied natural gas transfer equipment comprises an unloading arm, and wherein the unloading arm can be positioned in a substantially horizontal position during storage of the unloading arm.

339. The structure of claim 294, further comprising liquefied natural gas transfer equipment wherein the liquefied natural gas transfer equipment comprises at least four unloading arms, and wherein at least one unloading arm is configurable to transfer liquefied natural gas from a liquefied natural gas carrier to the liquefied natural gas storage tank.

340. The structure of claim 294, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

341. The structure of claim 294, further comprising liquefied natural gas transfer equipment wherein the liquefied natural gas transfer equipment comprises an unloading arm, wherein the unloading arm is purged with nitrogen after unloading liquid natural gas from a carrier.

342. The structure of claim 294, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

343. The structure of claim 342, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

344. The structure of claim 342, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

345. The structure of claim 342, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

346. The structure of claim 342, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

347. A liquefied natural gas storage structure positioned in a body of water comprising:
a body;
a liquefied natural gas storage tank contained within the body;
an export metering system;
wherein at least a portion of a bottom surface of the body rests upon a portion of a bottom of the body of water.

348. The structure of claim 347, wherein the structure has a storage capacity of greater than about 50,000 cubic meters of liquefied natural gas.

349. The structure of claim 347, wherein the structure is configured to produce natural gas at a peak capacity of greater than about 1 billion cubic feet per day.

350. The structure of claim 347, further comprising liquefied natural gas transfer equipment, wherein the liquefied natural gas transfer equipment is configured to transfer liquefied natural gas from a liquefied natural gas carrier to the liquefied natural gas storage tank.

351. The structure of claim 347, further comprising vaporization equipment, wherein the vaporization equipment is configured to vaporize liquefied natural gas to natural gas.

352. The structure of claim 347, further comprising a projection extending from the bottom surface of the body.

353. The structure of claim 347, further comprising a projection extending from the bottom surface of the body, wherein at least a portion of the projection rests upon a portion of the bottom of the body of water.

354. The structure of claim 347, further comprising a platform.

355. The structure of claim 347, further comprising a platform, wherein the platform is at a height such that equipment disposed on the platform is substantially protected from water running over the body.

356. The structure of claim 347, wherein at least a portion of the body is composed of a lightweight concrete.

357. The structure of claim 347, wherein the structure is positioned in the body of water such that the longitudinal axis of the structure is substantially aligned with the predominant current direction.

358. The structure of claim 347, wherein the body comprises a first unit and a second unit, and wherein the first and second units are coupled to each other.

359. The structure of claim 347, wherein the body has a length that is at least equal to a length required to provide sufficient berthing alongside the body for a liquefied natural gas carrier having a liquefied natural gas capacity of greater than about 100,000 cubic meters.

360. The structure of claim 347, further comprising vaporization equipment disposed on an upper surface of the body, wherein the vaporization equipment is configured to vaporize liquefied natural gas to natural gas.

361. The structure of claim 347, further comprising vaporization equipment, wherein the vaporization equipment comprises an open-rack vaporizer.

362. The structure of claim 347, further comprising vaporization equipment, wherein the vaporization equipment comprises a submerged combustion vaporizer.

363. The structure of claim 347, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

364. The structure of claim 347, further comprising:
vaporization equipment, wherein the vaporization equipment is configured to vaporize liquefied natural gas to natural gas, and
a natural gas pipeline.

365. The structure of claim 347, further comprising a boil-off gas compressor, wherein the boil-off gas compressor is configured to provide a source of compressed natural gas to the structure.

366. The structure of claim 347, further comprising a recondenser.

367. The structure of claim 347, further comprising a wave deflector.

368. The structure of claim 367, wherein the wave deflector comprises a curved barrier extending outward from a side of the body.

369. The structure of claim 347, further comprising scour protection at least partially circumscribing the structure.

370. The structure of claim 347, further comprising a ballast storage area.

371. The structure of claim 347, further comprising a ballast storage area containing liquid.

372. The structure of claim 370, wherein the ballast storage area is adjacent to the liquefied natural gas storage tank.

373. The structure of claim 370, wherein the ballast storage area is adjacent to the liquefied natural gas storage tank, and wherein the ballast storage area is configured to inhibit water leaking into the ballast storage area from contacting a wall of the liquefied natural gas storage tank.

374. The structure of claim 370, wherein the ballast storage area is positioned under the liquefied natural gas storage tank.

375. The structure of claim 347, wherein the liquefied natural gas storage tank comprises a membrane tank.

376. The structure of claim 347, wherein the liquefied natural gas storage tank comprises a double containment tank.

377. The structure of claim 347, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

378. The structure of claim 377, wherein the outer wall comprises concrete, wherein the insulating structure comprises polyurethane foam, wherein the secondary barrier comprises a polyester glass cloth composite, and wherein the primary barrier comprises stainless steel.

379. The structure of claim 377, wherein the primary barrier comprises a double network of orthogonal corrugations of stainless steel, and wherein the orthogonal corrugations are configured to be capable of thermal expansion and contraction.

380. The structure of claim 377, further comprising a purge system positioned between the primary barrier and the secondary barrier.

381. The structure of claim 377, further comprising a heating system coupled to the outer wall, wherein the heating system is configured to maintain a temperature of the outer wall at or above about 5° C.

382. The structure of claim 347, further comprising a liquefied natural gas pump disposed in the liquefied natural gas storage tank.

383. The structure of claim 347, further comprising a docking platform positioned in the body of water proximate to the body, wherein the docking platform comprises docking equipment, and wherein the docking platform is positioned in the body of water such that a liquefied natural gas carrier can dock with the body in different orientations.

384. The structure of claim 347, wherein the body comprises a first upper surface and a second upper surface, the first upper surface having an elevation that is different from the elevation of the second upper surface, wherein the height of the second upper surface above the surface of the body of water is such that an angle of mooring lines extending from docking equipment disposed on the second upper surface to a liquefied natural gas carrier coupled to the body is less than about 30 degrees.

385. The structure of claim 347, further comprising a fender.

386. The structure of claim 385, wherein the fender is positioned about a perimeter of the body.

387. The structure of claim 347, further comprising liquefied natural gas transfer equipment wherein the liquefied natural gas transfer equipment comprises a swivel joint unloading arm.

388. The structure of claim 347, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

389. The structure of claim 347, further comprising liquefied natural gas transfer equipment wherein the liquefied natural gas transfer equipment comprises at least four unloading arms, and wherein at least one unloading arm is configurable to transfer liquefied natural gas from a liquefied natural gas carrier to the liquefied natural gas storage tank.

390. The structure of claim 347, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

391. The structure of claim 347, further comprising liquefied natural gas transfer equipment wherein the liquefied natural gas transfer equipment comprises an unloading arm, wherein the unloading arm is purged with nitrogen after unloading liquefied natural gas from a carrier.

392. The structure of claim 347, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

393. The structure of claim 392, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

394. The structure of claim 392, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

395. The structure of claim 392, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

396. The structure of claim 392, further comprising a water outlet system, wherein the water outlet system is configured to conduct water from the vaporizer equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

397. A liquefied natural gas storage structure positioned in a body of water comprising:
a body;
a liquefied natural gas storage tank contained within the body;
living quarters;
a flare tower;
an export metering system; and
docking equipment, wherein the docking equipment is configured to couple a liquefied natural gas carrier to the body;
wherein at least a portion of a bottom surface of the body rests upon a portion of a bottom of the body of water.

398. A liquefied natural gas storage structure positioned in a body of water comprising:
a body;
a liquefied natural gas storage tank contained within the body;
vaporization equipment, wherein the vaporization equipment is configured to vaporize liquefied natural gas to natural gas, wherein at least a portion of a bottom surface of the body rests upon a portion of a bottom of the body of water; and
wherein the structure is configured to produce natural gas at a peak capacity of greater than about 1 billion cubic feet per day.

399. The structure of claim 398, wherein the liquefied natural gas storage structure is configured to offload liquefied natural gas from carriers having a storage capacity of greater than 100,000 cubic meters.

400. The structure of claim 398, further comprising liquefied natural gas transfer equipment, wherein the liquefied natural gas transfer equipment is configured to transfer liquefied natural gas from a liquefied natural gas carrier to the liquefied natural gas storage tank.

401. The structure of claim 398, further comprising a projection extending from the bottom surface of the body.

402. The structure of claim 398, further comprising a projection extending from the bottom surface of the body, wherein at least a portion of the projection rests upon a portion of the bottom of the body of water.

403. The structure of claim 398, wherein at least a portion of the body is composed of a lightweight concrete.

404. The structure of claim 398, wherein the structure is positioned in the body of water such that the longitudinal axis of the structure is substantially aligned with the predominant current direction.

405. The structure of claim 398, wherein the body comprises a first unit and a second unit, and wherein the first and second units are coupled to each other.

406. The structure of claim 398, wherein the body has a length that is at least equal to a length required to provide sufficient berthing alongside the body for a liquefied natural gas carrier having a liquefied natural gas capacity of greater than about 100,000 cubic meters.

407. The structure of claim 398, further comprising vaporization equipment, wherein the vaporization equipment comprises an open-rack vaporizer.

408. The structure of claim 398, further comprising vaporization equipment, wherein the vaporization equipment comprises a submerged combustion vaporizer.

409. The structure of claim 398, further comprising vaporization equipment and an export metering system coupled to the vaporization equipment, wherein the export metering system is configured to monitor the flow of produced natural gas from the structure.

410. The structure of claim 398, further comprising a natural gas pipeline.

411. The structure of claim 398, further comprising a boil-off gas compressor, wherein the boil-off gas compressor is configured to provide a source of compressed natural gas to the structure.

412. The structure of claim 398, further comprising a recondenser.

413. The structure of claim 398, further comprising scour protection at least partially circumscribing the structure.

414. The structure of claim 398, further comprising a ballast storage area.

415. The structure of claim 398, further comprising a ballast storage area containing liquid.

416. The structure of claim 414, wherein the ballast storage area is adjacent to the liquefied natural gas storage tank.

417. The structure of claim 414, wherein the ballast storage area is adjacent to the liquefied natural gas storage tank, and wherein the ballast storage area is configured to inhibit water leaking into the ballast storage area from contacting a wall of a liquefied natural gas storage tank.

418. The structure of claim 414, wherein the ballast storage area is positioned under the liquefied natural gas storage tank.

419. The structure of claim 398, wherein the liquefied natural gas storage tank comprises a membrane tank.

420. The structure of claim 398, wherein the liquefied natural gas storage tank comprises a double containment tank.

421. The structure of claim 398, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas

422. The structure of claim 421, wherein the outer wall comprises concrete, wherein the insulating structure comprises polyurethane foam, wherein the secondary barrier comprises a polyester glass cloth composite, and wherein the primary barrier comprises stainless steel.

423. The structure of claim 421, wherein the primary barrier comprises a double network of orthogonal corrugations of stainless steel, and wherein the orthogonal corrugations are configured to be capable of thermal expansion and contraction.

424. The structure of claim 421, further comprising a purge system positioned between the primary barrier and the secondary barrier.

425. The structure of claim 421, further comprising a heating system coupled to the outer wall, wherein the heating system is configured to maintain a temperature of the outer wall at or above about 5° C.

426. The structure of claim 421, further comprising a liquefied natural gas pump disposed in the liquefied natural gas storage tank.

427. The structure of claim 398, further comprising liquefied natural gas transfer equipment wherein the liquefied natural gas transfer equipment comprises a swivel joint unloading arm.

428. The structure of claim 398, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

429. The structure of claim 398, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

430. The structure of claim 398, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

431. The structure of claim 398, further comprising liquefied natural gas transfer equipment wherein the liquefied natural gas transfer equipment comprises an unloading arm, wherein the unloading arm is purged with nitrogen after unloading liquid natural gas from a carrier.

432. The structure of claim 398, further comprising vaporization equipment, and further comprising a water intake system, wherein the water intake system is configured to draw water from the body of water and supply water to the vaporization equipment.

433. The structure of claim 432, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

434. The structure of claim 432, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

435. The structure of claim 432, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

436. The structure of claim 432, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

437. A liquefied natural gas storage structure positioned in a body of water comprising:
a body;
a liquefied natural gas storage tank contained within the body;
wherein at least a portion of a bottom surface of the body rests upon a portion of a bottom of the body of water; and
wherein the structure has a storage capacity which is based on the liquefied natural gas capacity of a liquefied natural gas carrier, the desired peak capacity of the structure for converting liquefied natural gas to natural gas, and the rate at which liquefied natural gas from a liquefied natural gas carrier is transferred to a liquefied natural gas storage tank, and the cost associated with operating the structure.

438. The structure of claim 437, further comprising liquefied natural gas transfer equipment, wherein the liquefied natural gas transfer equipment is configured to transfer liquefied natural gas from a liquefied natural gas carrier to the liquefied natural gas storage tank.

439. The structure of claim 437, further comprising a projection extending from the bottom surface of the body.

440. The structure of claim 437, further comprising a projection extending from the bottom surface of the body, wherein at least a portion of the projection rests upon a portion of the bottom of the body of water.

441. The structure of claim 437, wherein at least a portion of the body is composed of a lightweight concrete.

442. The structure of claim 437, wherein the structure is positioned in the body of water such that the longitudinal axis of the structure is substantially aligned with the predominant current direction.

443. The structure of claim 437, wherein the body comprises a first unit and a second unit, and wherein the first and second units are coupled to each other.

444. The structure of claim 437, wherein the body has a length that is at least equal to a length required to provide sufficient berthing alongside the body for a liquefied natural gas carrier having a liquefied natural gas capacity of greater than about 100,000 cubic meters.

445. The structure of claim 437, further comprising vaporization equipment, wherein the vaporization equipment is configured to vaporize liquefied natural gas to natural gas.

446. The structure of claim 437, further comprising vaporization equipment, wherein the vaporization equipment comprises an open-rack vaporizer.

447. The structure of claim 437, further comprising vaporization equipment, wherein the vaporization equipment comprises a submerged combustion vaporizer.

448. The structure of claim 437, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

449. The structure of claim 437, further comprising:
vaporization equipment, wherein the vaporization equipment is configured to vaporize liquefied natural gas to natural gas, and
a natural gas pipeline.

450. The structure of claim 437, further comprising a boil-off gas compressor, wherein the boil-off gas compressor is configured to provide a source of compressed natural gas to the structure.

451. The structure of claim 437, further comprising a recondenser.

452. The structure of claim 437, further comprising scour protection at least partially circumscribing the structure.

453. The structure of claim 437, further comprising a ballast storage area.

454. The structure of claim 437, further comprising a ballast storage area containing liquid.

455. The structure of claim 453, wherein the ballast storage area is adjacent to the liquefied natural gas storage tank.

456. The structure of claim 453, wherein the ballast storage area is adjacent to the liquefied natural gas storage tank, and wherein the ballast storage area is configured to inhibit water leaking into the ballast storage area from contacting a wall of the liquefied natural gas storage tank.

457. The structure of claim 453, wherein the ballast storage area is positioned under the liquefied natural gas storage tank.

458. The structure of claim 437, wherein the liquefied natural gas storage tank comprises a membrane tank.

459. The structure of claim 437, wherein the liquefied natural gas storage tank comprises a double containment tank.

460. The structure of claim 437, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

461. The structure of claim 460, wherein the outer wall comprises concrete, wherein the insulating structure comprises polyurethane foam, wherein the secondary barrier comprises a polyester glass cloth composite, and wherein the primary barrier comprises stainless steel.

462. The structure of claim 460, wherein the primary barrier comprises a double network of orthogonal corrugations of stainless steel, and wherein the orthogonal corrugations are configured to be capable of thermal expansion and contraction.

463. The structure of claim 460, further comprising a purge system positioned between the primary barrier and the secondary barrier.

464. The structure of claim 460, further comprising a heating system coupled to the outer wall, wherein the heating system is configured to maintain a temperature of the outer wall at or above about 5° C.

465. The structure of claim 437, further comprising a liquefied natural gas pump disposed in the liquefied natural gas storage tank.

466. The structure of claim 437, further comprising liquefied natural gas transfer equipment, wherein the liquefied natural gas transfer equipment comprises a swivel joint unloading arm.

467. The structure of claim 437, further comprising liquefied natural gas transfer equipment, wherein the liquefied natural gas transfer equipment comprises an unloading arm, and wherein at least a portion of the unloading arm can be positioned in a substantially horizontal position during storage of the unloading arm.

468. The structure of claim 437, further comprising liquefied natural gas transfer equipment, wherein the liquefied natural gas transfer equipment comprises at least four unloading arms, and wherein at least one unloading arm is configurable to transfer liquefied natural gas from a liquefied natural gas carrier to the liquefied natural gas storage tank.

469. The structure of claim 437, further comprising liquefied natural gas transfer equipment, wherein the liquefied natural gas transfer equipment comprises an unloading arm, wherein the unloading arm is coupled to the liquefied natural gas storage tank with a conduit, wherein the conduit is arranged in a continuously sloping layout.

470. The structure of claim 437, further comprising liquefied natural gas transfer equipment, wherein the liquefied natural gas transfer equipment comprises an unloading arm, wherein the unloading arm is purged with nitrogen after unloading liquid natural gas from a carrier.

471. The structure of claim 437, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

472. The structure of claim 471, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

473. The structure of claim 471, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

474. The structure of claim 471, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

475. The structure of claim 471, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

476. A liquefied natural gas storage structure positioned in a body of water comprising:
a body;
a liquefied natural gas storage tank contained within the body; and
a projection extending from a bottom surface of the body,
wherein at least a portion of a bottom surface of the body rests upon a portion of the bottom of the body of water.

477. The structure of claim 476, wherein the structure has a storage capacity of greater than about 50,000 cubic meters of liquefied natural gas.

478. The structure of claim 476, wherein at least a portion of the projection rests upon a portion of the bottom of the body of water.

479. The structure of claim 476, further comprising liquefied natural gas transfer equipment, wherein the liquefied natural gas transfer equipment is configured to transfer liquefied natural gas from a liquefied natural gas carrier to the liquefied natural gas storage tank.

480. The structure of claim 476, further comprising a plurality of projections wherein at least some of the projections are arranged in a grid pattern.

481. The structure of claim 478, wherein at least a portion of the projection is at least partially embedded in the bottom of the body of water.

482. The structure of claim 476, wherein at least a portion of the body is composed of a lightweight concrete.

483. The structure of claim 476, wherein the structure is positioned in the body of water such that the longitudinal axis of the structure is substantially aligned with the predominant current direction.

484. The structure of claim 476, wherein the body comprises a first unit and a second unit, and wherein the first and second units are coupled to each other.

485. The structure of claim 476, wherein the body has a length that is at least equal to a length required to provide sufficient berthing alongside the body for a liquefied natural gas carrier having a liquefied natural gas capacity of greater than about 100,000 cubic meters.

486. The structure of claim 476, further comprising vaporization equipment, wherein the vaporization equipment is configured to vaporize liquefied natural gas to natural gas.

487. The structure of claim 476, further comprising vaporization equipment, wherein the vaporization equipment comprises an open-rack vaporizer.

488. The structure of claim 476, further comprising vaporization equipment, wherein the vaporization equipment comprises a submerged combustion vaporizer.

489. The structure of claim 476, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

490. The structure of claim 476, further comprising:
vaporization equipment, wherein the vaporization equipment is configured to vaporize liquefied natural gas to natural gas, and
a natural gas transfer pipeline.

491. The structure of claim 476, further comprising a boil-off gas compressor, wherein the boil-off gas compressor is configured to provide a source of compressed natural gas to the structure.

492. The structure of claim 476, further comprising a recondenser.

493. The structure of claim 476, further comprising scour protection at least partially circumscribing the structure.

494. The structure of claim 476, further comprising a ballast storage area.

495. The structure of claim 476, further comprising a ballast storage area containing liquid.

496. The structure of claim 494, wherein the ballast storage area is adjacent to the liquefied natural gas storage tank.

497. The structure of claim 494, wherein the ballast storage area is adjacent to the liquefied natural gas storage tank, and wherein the ballast storage area is configured to inhibit water leaking into the ballast storage area from contacting a wall of a liquefied natural gas storage tank.

498. The structure of claim 494, wherein the ballast storage area is positioned under the liquefied natural gas storage tank.

499. The structure of claim 476, wherein the liquefied natural gas storage tank comprises a membrane tank.

500. The structure of claim 476, wherein the liquefied natural gas storage tank comprises a double containment tank.

501. The structure of claim 476, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

502. The structure of claim 501, wherein the outer wall comprises concrete, wherein the insulating structure comprises polyurethane foam, wherein the secondary barrier comprises a polyester glass cloth composite, and wherein the primary barrier comprises stainless steel.

503. The structure of claim 501, wherein the primary barrier comprises a double network of orthogonal corrugations of stainless steel, and wherein the orthogonal corrugations are configured to be capable of thermal expansion and contraction.

504. The structure of claim 501, further comprising a purge system positioned between the primary barrier and the secondary barrier.

505. The structure of claim 501, further comprising a heating system coupled to the outer wall, wherein the heating system is configured to maintain a temperature of the outer wall at or above about 5° C.

506. The structure of claim 476, further comprising a liquefied natural gas pump disposed in the liquefied natural gas storage tank.

507. The structure of claim 476, further comprising liquefied natural gas transfer equipment wherein the liquefied natural gas transfer equipment comprises a swivel joint unloading arm.

508. The structure of claim 476, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

509. The structure of claim 476, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

510. The structure of claim 476, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

511. The structure of claim 476, further comprising liquefied natural gas transfer equipment wherein the liquefied natural gas transfer equipment comprises an unloading arm, wherein the unloading arm is purged with nitrogen after unloading liquefied natural gas from a carrier.

512. The structure of claim 476, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

513. The structure of claim 512, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

514. The structure of claim 512, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

515. The structure of claim 512, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

516. The structure of claim 512, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

517. A liquefied natural gas storage structure positioned in a body of water comprising:
a body;
a liquefied natural gas storage tank contained within the body; and
a plurality of projections extending from a bottom surface of the body,
wherein at least a portion of the projections extending from the bottom surface of the body rests upon a portion of the bottom of the body of water, and wherein the projections are oriented such that a compartments is formed on the bottom of the body.

518. The structure of claim 517, wherein at least a portion of the compartment is configured to entrap air.

519. The structure of claim 518, wherein entrapping air in at least a portion of the compartment increases the buoyancy of the body.

520. The structure of claim 517, wherein the structure is configured to produce natural gas at a peak capacity of greater than about 1 billion cubic feet per day.

521. The structure of claim 517, wherein at least a portion of the projections are arranged in a grid pattern.

522. The structure of claim 517, wherein at least a portion of the projections are at least partially embedded in the bottom of the body of water.

523. The structure of claim 517, wherein at least a portion of the body is composed of a structural-grade lightweight concrete.

524. The structure of claim 517, wherein the structure is positioned in the body of water such that the longitudinal axis of the structure is substantially aligned with the predominant current direction.

525. The structure of claim 517, wherein the body comprises a first unit and a second unit, and wherein the first and second units are coupled to each other.

526. The structure of claim 517, wherein the body has a length that is at least equal to a length required to provide sufficient berthing alongside the body for a liquefied natural gas carrier having a liquefied natural gas capacity of greater than about 100,000 cubic meters.

527. The structure of claim 517, further comprising liquefied natural gas transfer equipment, wherein the liquefied natural gas transfer equipment is configured to transfer liquefied natural gas from a liquefied natural gas carrier to the liquefied natural gas storage tank.

528. The structure of claim 517, further comprising vaporization equipment, wherein the vaporization equipment comprises an open-rack vaporizer.

529. The structure of claim 517, further comprising vaporization equipment, wherein the vaporization equipment comprises a submerged combustion vaporizer.

530. The structure of claim 517, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

531. The structure of claim 517, further comprising:
vaporization equipment, wherein the vaporization equipment is configured to vaporize liquefied natural gas to natural gas, and
a natural gas pipeline.

532. The structure of claim 517, further comprising a boil-off gas compressor, wherein the boil-off gas compressor is configured to provide a source of compressed natural gas to the structure.

533. The structure of claim 517, further comprising a recondenser.

534. The structure of claim 517, further comprising scour protection at least partially circumscribing the structure.

535. The structure of claim 517, further comprising a ballast storage area.

536. The structure of claim 517, further comprising a ballast storage area containing liquid.

537. The structure of claim 535, wherein the ballast storage area is adjacent to the liquefied natural gas storage tank.

538. The structure of claim 535, wherein the ballast storage area is adjacent to the liquefied natural gas storage tank, and wherein the ballast storage area is configured to inhibit water leaking into the ballast storage area from contacting a wall of the liquefied natural gas storage tank.

539. The structure of claim 535, wherein the ballast storage area is positioned under the liquefied natural gas storage tank.

540. The structure of claim 517, wherein the liquefied natural gas storage tank comprises a membrane tank.

541. The structure of claim 517, wherein the liquefied natural gas storage tank comprises a double containment tank.

542. The structure of claim 517, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

543. The structure of claim 542, wherein the outer wall comprises concrete, wherein the insulating structure comprises polyurethane foam, wherein the secondary barrier comprises a polyester glass cloth composite, and wherein the primary barrier comprises stainless steel.

544. The structure of claim 542, wherein the primary barrier comprises a double network of orthogonal corrugations of stainless steel, and wherein the orthogonal corrugations are configured to be capable of thermal expansion and contraction.

545. The structure of claim 542, further comprising a purge system positioned between the primary barrier and the secondary barrier.

546. The structure of claim 542, further comprising a heating system coupled to the outer wall, wherein the heating system is configured to maintain a temperature of the outer wall at or above about 5° C.

547. The structure of claim 517, further comprising a liquefied natural gas pump disposed in the liquefied natural gas storage tank.

548. The structure of claim 517, further comprising liquefied natural gas transfer equipment wherein the liquefied natural gas transfer equipment comprises a swivel joint unloading arm.

549. The structure of claim 517, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

550. The structure of claim 517, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

551. The structure of claim 517, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

552. The structure of claim 517, further comprising liquefied natural gas transfer equipment wherein the liquefied natural gas transfer equipment comprises an unloading arm, wherein the unloading arm is purged with nitrogen after unloading liquid natural gas from a carrier.

553. The structure of claim 517, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

554. The structure of claim 553, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

555. The structure of claim 553, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

556. The structure of claim 553, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

557. The structure of claim 553, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

558. A liquefied natural gas storage structure positioned in a body of water comprising:
a body, wherein at least a portion of the body is composed of a lightweight concrete;
a liquefied natural gas storage tank contained within the body; and
wherein at least a portion of a bottom surface of the body rests upon a portion of a bottom of the body of water.

559. The structure of claim 558, wherein the structure has a storage capacity of greater than about 50,000 cubic meters of liquefied natural gas.

560. The structure of claim 558, wherein the structure is configured to produce natural gas at a peak capacity of greater than about 1 billion cubic feet per day.

561. The structure of claim 558, further comprising liquefied natural gas transfer equipment, wherein the liquefied natural gas transfer equipment is configured to transfer liquefied natural gas from a liquefied natural gas carrier to the liquefied natural gas storage tank.

562. The structure of claim 558, wherein the structure is positioned in the body of water such that the longitudinal axis of the structure is substantially aligned with the predominant current direction.

563. The structure of claim 558, wherein the body comprises a first unit and a second unit, and wherein the first and second units are coupled to each other.

564. The structure of claim 558, wherein the body has a length that is at least equal to a length required to provide sufficient berthing alongside the body for a liquefied natural gas carrier having a liquefied natural gas capacity of greater than about 100,000 cubic meters.

565. The structure of claim 558, further comprising vaporization equipment, wherein the vaporization equipment is configured to vaporize liquefied natural gas to natural gas.

566. The structure of claim 558, further comprising vaporization equipment, wherein the vaporization equipment comprises an open-rack vaporizer.

567. The structure of claim 558, further comprising vaporization equipment, wherein the vaporization equipment comprises a submerged combustion vaporizer.

568. The structure of claim 558, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

569. The structure of claim 558, further comprising:
vaporization equipment, wherein the vaporization equipment is configured to vaporize liquefied natural gas to natural gas, and
a natural gas pipeline.

570. The structure of claim 558, further comprising a boil-off gas compressor, wherein the boil-off gas compressor is configured to provide a source of compressed natural gas to the structure.

571. The structure of claim 558, further comprising a recondenser.

572. The structure of claim 558, further comprising scour protection at least partially circumscribing the structure.

573. The structure of claim 558, further comprising a ballast storage area.

574. The structure of claim 558, further comprising a ballast storage area containing liquid.

575. The structure of claim 573, wherein the ballast storage area is adjacent to the liquefied natural gas storage tank.

576. The structure of claim 573, wherein the ballast storage area is adjacent to the liquefied natural gas storage tank, and wherein the ballast storage area is configured to inhibit water leaking into the ballast storage area from contacting a wall of the liquefied natural gas storage tank.

577. The structure of claim 573, wherein the ballast storage area is positioned under the liquefied natural gas storage tank.

578. The structure of claim 558, wherein the liquefied natural gas storage tank comprises a membrane tank.

579. The structure of claim 558, wherein the liquefied natural gas storage tank comprises a double containment tank.

580. The structure of claim 558, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

581. The structure of claim 580, wherein the outer wall comprises concrete, wherein the insulating structure comprises polyurethane foam, wherein the secondary barrier comprises a polyester glass cloth composite, and wherein the primary barrier comprises stainless steel.

582. The structure of claim 580, wherein the primary barrier comprises a double network of orthogonal corrugations of stainless steel, and wherein the orthogonal corrugations are configured to be capable of thermal expansion and contraction.

583. The structure of claim 580, further comprising a purge system positioned between the primary barrier and the secondary barrier.

584. The structure of claim 580, further comprising a heating system coupled to the outer wall, wherein the heating system is configured to maintain a temperature of the outer wall at or above about 5° C.

585. The structure of claim 558, further comprising a liquefied natural gas pump disposed in the liquefied natural gas storage tank.

586. The structure of claim 558, further comprising liquefied natural gas transfer equipment wherein the liquefied natural gas transfer equipment comprises a swivel joint unloading arm.

587. The structure of claim 558, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

588. The structure of claim 558, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

589. The structure of claim 558, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

590. The structure of claim 558, further comprising liquefied natural gas transfer equipment wherein the liquefied natural gas transfer equipment comprises an unloading arm, wherein the unloading arm is purged with nitrogen after unloading liquid natural gas from a carrier.

591. The structure of claim 558, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

592. The structure of claim 591, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

593. The structure of claim 591, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

594. The structure of claim 591, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

595. The structure of claim 591, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

596. A liquefied natural gas storage structure positioned in a body of water comprising:
a body;
a liquefied natural gas storage tank contained within the body; and
a ballast storage area;
wherein at least a portion of a bottom surface of the body rests upon a portion of a bottom of the body of water.

597. The structure of claim 596, wherein the ballast storage area contains liquid.

598. The structure of claim 596, wherein the ballast storage area contains solid.

599. The structure of claim 596, wherein the ballast storage area is adjacent to the liquefied natural gas storage tank.

600. The structure of claim 596, wherein the ballast storage area is adjacent to the liquefied natural gas storage tank and is configured to maintain a level of liquid ballast such that the liquid ballast is inhibited from contacting a wall of the liquefied natural gas storage tank.

601. The structure of claim 596, wherein the ballast storage area contains solid and is adjacent to a wall of the liquefied natural gas storage tank.

602. The structure of claim 596, wherein the ballast storage area contains solid and is adjacent to a wall of the liquefied natural gas storage tank and is configured to inhibit water leaking into the ballast storage area from contacting a wall of the liquefied natural gas storage tank.

603. The structure of claim 596, wherein the structure has a storage capacity of greater than about 50,000 cubic meters of liquefied natural gas.

604. The structure of claim 596, wherein the structure is configured to produce natural gas at a peak capacity of greater than about 1 billion cubic feet per day.

605. The structure of claim 596, further comprising liquefied natural gas transfer equipment, wherein the liquefied natural gas transfer equipment is configured to transfer liquefied natural gas from a liquefied natural gas carrier to the liquefied natural gas storage tank.

606. The structure of claim 596, wherein the structure is positioned in the body of water such that the longitudinal axis of the structure is substantially aligned with the predominant current direction.

607. The structure of claim 596, wherein the body comprises a first unit and a second unit, and wherein the first and second units are coupled to each other.

608. The structure of claim 596, wherein the body has a length that is at least equal to a length required to provide sufficient berthing alongside the body for a liquefied natural gas carrier having a liquefied natural gas capacity of greater than about 100,000 cubic meters.

609. The structure of claim 596, further comprising vaporization equipment, wherein the vaporization equipment is configured to vaporize liquefied natural gas to natural gas.

610. The structure of claim 596, further comprising vaporization equipment, wherein the vaporization equipment comprises an open-rack vaporizer.

611. The structure of claim 596, further comprising vaporization equipment, wherein the vaporization equipment comprises a submerged combustion vaporizer.

612. The structure of claim 596, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

613. The structure of claim 596, further comprising:
vaporization equipment, wherein the vaporization equipment is configured to vaporize liquefied natural gas to natural gas, and
a natural gas pipeline.

614. The structure of claim 596, further comprising a boil-off gas compressor, wherein the boil-off gas compressor is configured to provide a source of compressed natural gas to the structure.

615. The structure of claim 596, further comprising a recondenser.

616. The structure of claim 596, further comprising scour protection at least partially circumscribing the structure.

617. The structure of claim 596, wherein the liquefied natural gas storage tank comprises a membrane tank.

618. The structure of claim 596, wherein the liquefied natural gas storage tank comprises a double containment tank.

619. The structure of claim 596, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

620. The structure of claim 619, wherein the outer wall comprises concrete, wherein the insulating structure comprises polyurethane foam, wherein the secondary barrier comprises a polyester glass cloth composite, and wherein the primary barrier comprises stainless steel.

621. The structure of claim 619, wherein the primary barrier comprises a double network of orthogonal corrugations of stainless steel, and wherein the orthogonal corrugations are configured to be capable of thermal expansion and contraction.

622. The structure of claim 619, further comprising a purge system positioned between the primary barrier and the secondary barrier.

623. The structure of claim 619, further comprising a heating system coupled to the outer wall, wherein the heating system is configured to maintain a temperature of the outer wall at or above about 5° C.

624. The structure of claim 596, further comprising a liquefied natural gas pump disposed in the liquefied natural gas storage tank.

625. The structure of claim 596, further comprising liquefied natural gas transfer equipment wherein the liquefied natural gas transfer equipment comprises a swivel joint unloading arm.

626. The structure of claim 596, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

627. The structure of claim 596, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

628. The structure of claim 596, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

629. The structure of claim 596, further comprising liquefied natural gas transfer equipment wherein the liquefied natural gas transfer equipment comprises an unloading arm, wherein the unloading arm is purged with nitrogen after unloading liquid natural gas from a carrier.

630. The structure of claim 596, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

631. The structure of claim 630, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

632. The structure of claim 630, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

633. The structure of claim 630, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

634. The structure of claim 630, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

635. A method of installing a liquefied natural gas storage structure in a body of water comprising:
towing the structure to a location in the body of water, wherein the structure comprises a liquefied natural gas storage tank; and
filling a ballast storage area of the structure with liquid to increase the weight of the structure such that the structure sinks to the bottom of the body of water.

636. The method of claim 635, further comprising replacing at least a portion of the liquid with a solid.

637. The method of claim 635, wherein the ballast storage area is positioned under the liquefied natural gas storage tank.

638. The method of claim 635, wherein the structure has a storage capacity of greater than about 50,000 cubic meters of liquefied natural gas.

639. The method of claim 635, further comprising liquefied natural gas transfer equipment, wherein the liquefied natural gas transfer equipment is configured to transfer liquefied natural gas from a liquefied natural gas carrier to the liquefied natural gas storage tank.

640. The method of claim 635, wherein the structure is positioned in the body of water such that the longitudinal axis of the structure is substantially aligned with the predominant current direction.

641. The method of claim 635, wherein the structure comprises a first unit and a second unit, and wherein the first and second units are coupled to each other.

642. The method of claim 635, wherein the structure further comprises vaporization equipment, wherein the vaporization equipment is configured to vaporize liquefied natural gas to natural gas.

643. The method of claim 635, further comprising vaporization equipment, wherein the vaporization equipment comprises an open-rack vaporizer.

644. The method of claim 635, wherein the structure further comprises vaporization equipment, wherein the vaporization equipment comprises a submerged combustion vaporizer.

645. The method of claim 635, wherein the structure further comprises vaporization equipment and an export metering system, wherein the vaporization equipment is configured to vaporize liquefied natural gas to natural gas, and wherein the export metering system is configured to monitor the flow of produced natural gas from the structure.

646. The method of claim 635, wherein the structure further comprises vaporization equipment, wherein the vaporization equipment is configured to vaporize liquefied natural gas to natural gas, the method further comprising coupling a natural gas pipeline to the structure.

647. The method of claim 635, wherein the structure further comprises a boil-off gas compressor, wherein the boil-off gas compressor is configured to provide a source of compressed natural gas to the structure.

648. The method of claim 635, wherein the structure further comprises a recondenser.

649. The method of claim 635, wherein the structure further comprises scour protection at least partially circumscribing the structure.

650. The method of claim 635, wherein the liquefied natural gas storage tank comprises a membrane tank.

651. The method of claim 635, wherein the liquefied natural gas storage tank comprises a double containment tank.

652. The method of claim 635, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

653. The method of claim 652, wherein the outer wall comprises concrete, wherein the insulating structure comprises polyurethane foam, wherein the secondary barrier comprises a polyester glass cloth composite, and wherein the primary barrier comprises stainless steel.

654. The method of claim 652, wherein the primary barrier comprises a double network of orthogonal corrugations of stainless steel, and wherein the orthogonal corrugations are configured to be capable of thermal expansion and contraction.

655. The method of claim 652, wherein the structure further comprises a purge system positioned between the primary barrier and the secondary barrier.

656. The method of claim 652, wherein the structure further comprises a heating system coupled to the outer wall, wherein the heating system is configured to maintain a temperature of the outer wall at or above about 5° C.

657. The method of claim 635, wherein the structure further comprises a liquefied natural gas pump disposed in the liquefied natural gas storage tank.

658. The method of claim 635, further comprising transferring liquefied natural gas from a liquefied natural gas carrier to the liquefied natural gas storage tank using liquefied natural gas transfer equipment, wherein the liquefied natural gas transfer equipment comprises a swivel joint unloading arm.

659. The method of claim 635, further comprising transferring liquefied natural gas from a liquefied natural gas carrier to the liquefied natural gas storage tank using liquefied natural gas transfer equipment, wherein the liquefied natural gas transfer equipment comprises an unloading arm, and wherein at least a portion of the unloading arm can be positioned in a substantially horizontal position during storage of the unloading arm.

660. The method of claim 635, further comprising transferring liquefied natural gas from a liquefied natural gas carrier to the liquefied natural gas storage tank using one or more of at least four unloading arms of liquefied natural gas transfer equipment.

661. The method of claim 635, further comprising transferring liquefied natural gas from a liquefied natural gas carrier to the liquefied natural gas storage tank using an unloading arm, wherein the unloading arm is coupled to the liquefied natural gas storage tank with a conduit, wherein the conduit is arranged in a continuously sloping layout.

662. The method of claim 635, further comprising transferring liquefied natural gas from a liquefied natural gas carrier to the liquefied natural gas storage tank using an unloading arm, wherein the unloading arm is purged with nitrogen after unloading liquid natural gas from a carrier.

663. The method of claim 635, wherein the structure further comprises:
vaporizing liquefied natural gas to natural gas using vaporization equipment; and
drawing water from the body of water using a water intake system to supply water to the vaporization equipment.

664. The method of claim 663, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

665. The method of claim 663, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

666. The method of claim 663, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

667. The method of claim 663, wherein the structure further comprises a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

668. A liquefied natural gas storage structure positioned in a body of water comprising:
a body;
a liquefied natural gas storage tank contained within the body;
vaporization equipment, wherein the vaporization equipment is configured to vaporize liquefied natural gas to natural gas; and
a natural gas pipeline;
wherein at least a portion of a bottom surface of the body rests upon a portion of a bottom of the body of water.

669. The structure of claim 668, wherein the natural gas pipeline is coupled to a on-shore natural gas pipeline system.

670. The structure of claim 668, wherein the structure is configured to produce natural gas at a peak capacity of greater than about 1 billion cubic feet per day.

671. The structure of claim 668, further comprising liquefied natural gas transfer equipment, wherein the liquefied natural gas transfer equipment is configured to transfer liquefied natural gas from a liquefied natural gas carrier to the liquefied natural gas storage tank.

672. The structure of claim 668, wherein the structure is positioned in the body of water such that the longitudinal axis of the structure is substantially aligned with the predominant current direction.

673. The structure of claim 668, wherein the body comprises a first unit and a second unit, and wherein the first and second units are coupled to each other.

674. The structure of claim 668, wherein the body has a length that is at least equal to a length required to provide sufficient berthing alongside the body for a liquefied natural gas carrier having a liquefied natural gas capacity of greater than about 100,000 cubic meters.

675. The structure of claim 668, wherein the vaporization equipment comprises an open-rack vaporizer.

676. The structure of claim 668, wherein the vaporization equipment comprises a submerged combustion vaporizer.

677. The structure of claim 668, further comprising a boil-off gas compressor, wherein the boil-off gas compressor is configured to provide a source of compressed natural gas to the structure.

678. The structure of claim 668, further comprising a recondenser.

679. The structure of claim 668, further comprising scour protection at least partially circumscribing the structure.

680. The structure of claim 668, wherein the liquefied natural gas storage tank comprises a membrane tank.

681. The structure of claim 668, wherein the liquefied natural gas storage tank comprises a double containment tank.

682. The structure of claim 668, wherein the liquefied natural gas storage tanks comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

683. The structure of claim 682, wherein the outer wall comprises concrete, wherein the insulating structure comprises polyurethane foam, wherein the secondary barrier comprises a polyester glass cloth composite, and wherein the primary barrier comprises stainless steel.

684. The structure of claim 682, wherein the primary barrier comprises a double network of orthogonal corrugations of stainless steel, and wherein the orthogonal corrugations are configured to be capable of thermal expansion and contraction.

685. The structure of claim 682, further comprising a purge system positioned between the primary barrier and the secondary barrier.

686. The structure of claim 682, further comprising a heating system coupled to the outer wall, wherein the heating system is configured to maintain a temperature of the outer wall at or above about 5° C.

687. The structure of claim 668, further comprising a liquefied natural gas pump disposed in the liquefied natural gas storage tank.

688. The structure of claim 671, further comprising liquefied natural gas transfer equipment wherein the liquefied natural gas transfer equipment comprises a swivel joint unloading arm.

689. The structure of claim 671, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

690. The structure of claim 671, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

691. The structure of claim 671, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

692. The structure of claim 671, further comprising liquefied natural gas transfer equipment wherein the liquefied natural gas transfer equipment comprises an unloading arm, wherein the unloading arm is purged with nitrogen after unloading liquid natural gas from a carrier.

693. The structure of claim 668, further comprising:
a water intake system, wherein the water intake system is configured to draw water from the body of water and supply water to the vaporization equipment.

694. The structure of claim 693, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

695. The structure of claim 693, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

696. The structure of claim 693, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

697. The structure of claim 693, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

698. A method of distributing natural gas from a liquefied natural gas storage structure positioned in a body of water comprising:
delivering liquefied natural gas to the structure, the structure comprising:
a body;
a liquefied natural gas storage tank contained within the body;
liquefied natural gas transfer equipment, wherein the liquefied natural gas transfer equipment is configured to transfer liquefied natural gas from a liquefied natural gas carrier to the liquefied natural gas storage tank;
vaporization equipment, wherein the vaporization equipment is configured to vaporize liquefied natural gas to natural gas;
a natural gas pipeline; and
an export metering system;
wherein at least a portion of a bottom surface of the body rests upon a portion of a bottom of the body of water; and
delivering natural gas through the natural gas pipeline to an on-shore natural gas pipeline system, wherein distribution of the natural gas through the natural gas pipeline is controlled using the export metering system such that the amount of natural gas passing through the natural gas pipeline is controlled based on the price of gas paid by the on-shore natural gas pipeline system.

699. The method of claim 698, further comprising using the vaporization equipment to produce natural gas at a peak capacity of greater than about 1 billion cubic feet per day.

700. The method of claim 698, further comprising varying the amount of natural gas passing through the natural gas pipeline based on changes in the price of natural gas paid by the on-shore natural gas pipeline system.

701. The method of claim 698, wherein the structure has a storage capacity of greater than about 50,000 cubic meters of liquefied natural gas.

702. The method of claim 698, wherein the structure further comprises a projection extending from the bottom surface of the body.

703. The method of claim 698, wherein the structure further comprises a projection extending from the bottom surface of the body, wherein at least a portion of the projection rests upon a portion of the bottom of the body of water.

704. The method of claim 698, wherein the structure further comprises a projection extending from the bottom surface of the body, wherein at least a portion of the projection is at least partially embedded in the bottom of the body of water.

705. The method of claim 698, wherein the structure further comprises a platform.

706. The method of claim 698, wherein the structure further comprises a platform, wherein the platform is at a height such that equipment disposed on the platform is substantially protected from water running over the body.

707. The method of claim 698, wherein at least a portion of the body is composed of a lightweight concrete.

708. The method of claim 698, wherein the structure is positioned in the body of water such that the longitudinal axis of the structure is substantially aligned with the predominant current direction.

709. The method of claim 698, wherein the body comprises a first unit and a second unit, and wherein the first and second units are coupled to each other.

710. The method of claim 698, wherein the body has a length that is at least equal to a length required to provide sufficient berthing alongside the body for a liquefied natural gas carrier having a liquefied natural gas capacity of greater than about 100,000 cubic meters.

711. The method of claim 698, wherein the vaporization equipment comprises an open-rack vaporizer.

712. The method of claim 698, wherein the vaporization equipment comprises a submerged combustion vaporizer.

713. The method of claim 698, wherein the structure further comprises a boil-off gas compressor, wherein the boil-off gas compressor is configured to provide a source of compressed natural gas to the structure.

714. The method of claim 698, wherein the structure further comprises a recondenser.

715. The method of claim 698, wherein the structure further comprises a wave deflector.

716. The method of claim 698, wherein the structure further comprises scour protection at least partially circumscribing the structure.

717. The method of claim 698, wherein the structure further comprises a ballast storage area.

718. The method of claim 698, wherein the structure further comprises a ballast storage area containing liquid.

719. The method of claim 717, wherein the ballast storage area is adjacent to the liquefied natural gas storage tank.

720. The method of claim 718, wherein the ballast storage area is adjacent to the liquefied natural gas storage tank, and wherein the ballast storage area is configured to inhibit water leaking into the ballast storage area from contacting a wall of the liquefied natural gas storage tank.

721. The method of claim 718, wherein the ballast storage area is positioned under the liquefied natural gas storage tank.

722. The method of claim 698, wherein the liquefied natural gas storage tank comprises a membrane tank.

723. The method of claim 698, wherein the liquefied natural gas storage tank comprises a double containment tank.

724. The method of claim 698, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

725. The method of claim 724, wherein the outer wall comprises concrete, wherein the insulating structure comprises polyurethane foam, wherein the secondary barrier comprises a polyester glass cloth composite, and wherein the primary barrier comprises stainless steel.

726. The method of claim 724, wherein the primary barrier comprises a double network of orthogonal corrugations of stainless steel, and wherein the orthogonal corrugations are configured to be capable of thermal expansion and contraction.

727. The method of claim 724, wherein the structure further comprises a purge system positioned between the primary barrier and the secondary barrier.

728. The method of claim 724, wherein the structure further comprises a heating system coupled to the outer wall, wherein the heating system is configured to maintain a temperature of the outer wall at or above about 5° C.

729. The method of claim 698, wherein the structure further comprises a liquefied natural gas pump disposed in the liquefied natural gas storage tank.

730. The method of claim 698, wherein the structure further comprises a docking platform positioned in the body of water proximate to the body, wherein the docking platform comprises docking equipment, and wherein the docking platform is positioned in the body of water such that liquefied natural gas carriers can dock with the body in different orientations.

731. The method of claim 698, wherein the structure further comprises docking equipment, wherein the docking equipment is positioned on the body such that an angle of mooring lines extending from the docking equipment to a liquefied natural gas carrier coupled to the body is less than about 30 degrees.

732. The method of claim 698, wherein the structure further comprises a fender.

733. The method of claim 732, wherein the fender is positioned about a perimeter of the body.

734. The method of claim 698, further comprising liquefied natural gas transfer equipment wherein the liquefied natural gas transfer equipment comprises a swivel joint unloading arm.

735. The method of claim 698, further comprising liquefied natural gas transfer equipment wherein the liquefied natural gas transfer equipment comprises an unloading arm, and wherein at least a portion of the unloading arm can be positioned in a substantially horizontal position during storage of the unloading arm.

736. The method of claim 698, further comprising liquefied natural gas transfer equipment wherein the liquefied natural gas transfer equipment comprises at least four unloading arms, and wherein at least one of the unloading arms is configurable to transfer liquefied natural gas from a liquefied natural gas carrier to the liquefied natural gas storage tank.

737. The method of claim 698, further comprising liquefied natural gas transfer equipment wherein the liquefied natural gas transfer equipment comprises an unloading arm, wherein the unloading arm is coupled to the liquefied natural gas storage tank with a conduit, wherein the conduit is arranged in a continuously sloping layout.

738. The method of claim 698, further comprising liquefied natural gas transfer equipment wherein the liquefied natural gas transfer equipment comprises an unloading arm, wherein delivering liquefied natural gas to the structure comprises transferring liquefied natural gas from a liquefied natural gas carrier to the liquefied natural gas storage tank using an unloading arm, and purging the unloading arm with nitrogen after unloading liquefied natural gas.

739. The method of claim 698, wherein the structure further comprises a water intake system, the method further comprising using the water intake system to draw water from the body of water and supply water to the vaporization equipment.

740. The method of claim 739, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

741. The method of claim 739, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

742. The method of claim 739, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

743. The method of claim 739, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

744. A liquefied natural gas storage structure positioned in a body of water comprising:
a body;
a liquefied natural gas storage tank contained within the body; and
liquefied natural gas transfer equipment, wherein the liquefied natural gas transfer equipment is configured to transfer liquefied natural gas from a liquefied natural gas carrier to the liquefied natural gas storage tank, and wherein the liquefied natural gas transfer equipment comprises an unloading arm, wherein the unloading arm is coupled to the liquefied natural gas storage tank with a conduit, wherein the conduit is arranged in a continuously sloping layout;
wherein at least a portion of a bottom surface of the body rests upon a portion of a bottom of the body of water.

745. The structure of claim 744, wherein the structure has a storage capacity of greater than about 50,000 cubic meters of liquefied natural gas.

746. The structure of claim 744, wherein the structure is configured to produce natural gas at a peak capacity of greater than about 1 billion cubic feet per day.

747. The structure of claim 744, wherein the structure has a storage capacity of greater than about 50,000 cubic meters of liquefied natural gas; and wherein the structure is configured to produce natural gas at a peak capacity of greater than about 1 billion cubic feet per day.

748. The structure of claim 744, wherein the structure is positioned in the body of water such that the longitudinal axis of the structure is substantially aligned with the predominant current direction.

749. The structure of claim 744, wherein the body comprises a first unit and a second unit, and wherein the first and second units are coupled to each other.

750. The structure of claim 744, wherein the body has a length that is at least equal to a length required to provide sufficient berthing alongside the body for a liquefied natural gas carrier having a liquefied natural gas capacity of greater than about 100,000 cubic meters.

751. The structure of claim 744, further comprising vaporization equipment, wherein the vaporization equipment is configured to vaporize liquefied natural gas to natural gas.

752. The structure of claim 744, further comprising vaporization equipment, wherein the vaporization equipment comprises an open-rack vaporizer.

753. The structure of claim 744, further comprising vaporization equipment, wherein the vaporization equipment comprises a submerged combustion vaporizer.

754. The structure of claim 744, further comprising vaporization equipment and an export metering system coupled to the vaporization equipment, wherein the vaporization equipment is configured to vaporize liquefied natural gas to natural gas, and wherein the export metering system is configured to monitor the flow of produced natural gas from the structure.

755. The structure of claim 744, further comprising a boil-off gas compressor, wherein the boil-off gas compressor is configured to provide a source of compressed natural gas to the structure.

756. The structure of claim 744, further comprising a recondenser.

757. The structure of claim 744, further comprising scour protection at least partially circumscribing the structure.

758. The structure of claim 744, wherein the liquefied natural gas storage tank comprises a membrane tank.

759. The structure of claim 744, wherein the liquefied natural gas storage tank comprises a double containment tank.

760. The structure of claim 744, wherein the liquefied natural gas storage tank comprises:
an outer wall;
an insulating structure, wherein the insulating structure is positioned on an inner surface of the outer wall;
a secondary barrier, wherein the secondary barrier is positioned on an inner surface of the insulating structure; and
a primary barrier, wherein the primary barrier is configured to contain liquefied natural gas.

761. The structure of claim 760, wherein the outer wall comprises concrete, wherein the insulating structure comprises polyurethane foam, wherein the secondary barrier comprises a polyester glass cloth composite, and wherein the primary barrier comprises stainless steel.

762. The structure of claim 760, wherein the primary barrier comprises a double network of orthogonal corrugations of stainless steel, and wherein the orthogonal corrugations are configured to be capable of thermal expansion and contraction.

763. The structure of claim 760, further comprising a purge system positioned between the primary barrier and the secondary barrier.

764. The structure of claim 760, further comprising a heating system coupled to the outer wall, wherein the heating system is configured to maintain a temperature of the outer wall at or above about 5° C.

765. The structure of claim 760, further comprising a liquefied natural gas pump disposed in the liquefied natural gas storage tank.

766. The structure of claim 760, wherein the liquefied natural gas transfer equipment comprises a swivel joint unloading arm.

767. The structure of claim 760, wherein the liquefied natural gas transfer equipment comprises an unloading arm, and wherein at least a portion of the unloading arm can be positioned in a substantially horizontal position during storage of the unloading arm.

768. The structure of claim 760, wherein the liquefied natural gas transfer equipment comprises at least four unloading arms, and wherein at least one of the unloading arms is configured to transfer liquefied natural gas from a liquefied natural gas carrier to the liquefied natural gas storage tank.

769. The structure of claim 760, wherein an unloading arm is purged with nitrogen after unloading liquid natural gas from a carrier.

770. The structure of claim 760, further comprising:
vaporization equipment, wherein the vaporization equipment is configured to vaporize liquefied natural gas to natural gas; and
a water intake system, wherein the water intake system is configured to draw water from the body of water and supply water to the vaporization equipment.

771. The structure of claim 770, wherein the water intake system comprises:
a water inlet, wherein the water inlet comprises a water inlet conduit;
a water receiving chamber, wherein the water receiving chamber is configured to receive water from the water inlet;
a pump, wherein the pump receives water from the water receiving chamber; and
wherein an end of the water inlet conduit is positioned at a distance from the structure such that waves reflecting off of the structure do not substantially affect the flow of water into the water inlet.

772. The structure of claim 770, wherein the water intake system comprises:
a water inlet;
a water receiving chamber, wherein the water receiving chamber is configured to receive water from the water inlet;
a baffle; wherein the baffle reduces an effect of waves on the inlet of water into the water receiving chamber; and
a pump, wherein the pump receives water from the water receiving chamber.

773. The structure of claim 770, wherein the water intake system comprises:
a water inlet;
a first water receiving chamber, wherein the first water receiving chamber is configured to receive water from the water inlet;
a second water receiving chamber, wherein the second water receiving chamber is configured to receive water from the first water receiving chamber;
a filter positioned between the first and second water receiving chambers, wherein the filter is configured to filter water passing from the first water receiving chamber to the second water receiving chamber; and
a pump, wherein the pump receives water from the second water receiving chamber.

774. The structure of claim 770, further comprising a water outlet system, wherein the water outlet system is configured to conduct water from the vaporization equipment back to the body of water, wherein the water outlet system comprises a water outlet conduit, and wherein an end of the water outlet conduit is positioned at a distance from the water intake system such that water exiting the water outlet conduit does not substantially affect the temperature of water entering the water intake system.

775. A method of using a liquefied natural gas storage structure in a body of water, comprising:
receiving liquefied natural gas from a liquefied natural gas carrier;
storing the liquefied natural gas in a liquefied natural gas storage tank; and
processing the liquefied natural gas using vaporization equipment.

776. A method according to claim 775 further comprising transferring the natural gas to a natural gas pipeline to provide the natural gas to at least one on-shore location.

777. A method of using a water intake system comprising:
providing water to a water inlet;
passing the water from the water inlet to a water receiving chamber; and
providing the water from the water receiving chamber to a pump.

778. A method of using a vaporizing system comprising:
providing water to a water inlet;
passing the water from the water inlet to a water receiving chamber;
providing the water from the water receiving chamber to a pump;
providing the water from the pump to a heat exchanger;
vaporizing at least a portion of liquefied natural gas contacting the heat exchanger using the water from the pump;
providing the water from the heat exchanger to a water outlet; and
discharging the water from the water outlet to a body of water.

779. A method of removing a liquefied natural gas structure from a body of water, comprising:
removing ballast material from a ballast storage area;
lifting the structure off of a bottom of the body of water; and
towing the structure.
